(19) United States
(12) Patent Application Publication
(10) Pub. No.: US 2018/0174188 A1
(43) Pub. Date: Jun. 21, 2018

(54) SYSTEMS AND METHODS FOR CUSTOMIZING CONTENT OF A BILLBOARD

(71) Applicant: Wal-Mart Stores, Inc., Bentonville, AR (US)

(72) Inventors: Bruce W. Wilkinson, Rogers, AR (US); Greg N. Vukin, Bentonville, AR (US); Todd D. Mattingly, Bentonville, AR (US)

(21) Appl. No.: 15/783,551

(22) Filed: Oct. 13, 2017

Related U.S. Application Data
(60) Provisional application No. 62/527,445, filed on Jun. 30, 2017.
(60) Provisional application No. 62/436,842, filed on Dec. 20, 2016.
(60) Provisional application No. 62/485,045, filed on Apr. 13, 2017.
(60) Provisional application No. 62/525,304, filed on Jun. 27, 2017.
(60) Provisional application No. 62/542,664, filed on Aug. 8, 2017.
(60) Provisional application No. 62/559,128, filed on Sep. 15, 2017.

(51) Int. Cl. G06Q 30/02

(52) U.S. Cl. CPC G06Q 30/0261; G06Q 30/0242; G06Q 30/0255

(57) ABSTRACT

In some embodiments, apparatuses and methods are provided herein useful to customizing content of a billboard. In some embodiments, there is provided a system for customizing content of a billboard including: a partiality vector database; a selector control circuit configured to: receive traveler data information of a plurality of travelers; identify a set of travelers that passes a particular geo-fence location; access the partiality vector database to determine a set of partiality vectors associated with the set of travelers; determine a rank for each of the set of partiality vectors; and select one or more partiality vectors of the set of partiality vectors based on the rank; and a billboard control circuit configured to: receive a notification of the one or more selected partiality vectors; access a billboard content database to determine a content of a plurality of available contents; and provide the content to a billboard interface.

### RELATED APPLICATIONS

This application claims the benefit of U.S. Provisional Application No. 62/527,445, filed Jun. 30, 2017, U.S. Provisional Application No. 62/525,304, filed Jun. 27, 2017, U.S. Provisional Application No. 62/542,664, filed Aug. 8, 2017, U.S. Provisional Application No. 62/559,128, filed Sep. 15, 2017, U.S. Provisional Application No. 62/436,842, filed Dec. 20, 2016, and U.S. Provisional Application No. 62/485,045, filed Apr. 13, 2017, all of which are incorporated herein by reference in their entirety.

### TECHNICAL FIELD

These teachings relate generally to customizing content.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

Moreover, every day, consumer see and/or read various advertisements, for example, when they are on the way to a place of business, a travel destination, and/or home. Generally, these advertisements are directed to a general audience.

### BRIEF DESCRIPTION OF THE DRAWINGS

The above needs are at least partially met through provision of the vector-based characterizations of products described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 illustrates a simplified block diagram of an exemplary system for customizing content of a billboard in accordance with some embodiments;

FIG. 19 shows a flow diagram of an exemplary process of customizing content of a billboard in accordance with some embodiments;

FIG. 20 shows a flow diagram of an exemplary process of customizing content of a billboard in accordance with some embodiments;

FIG. 21 shows a flow diagram of an exemplary process of monitoring item distribution in accordance with some embodiments;

FIG. 22 shows a flow diagram of an exemplary process of monitoring item distribution in accordance with some embodiments;

FIG. 23 illustrates an exemplary system for use in implementing methods, techniques, devices, apparatuses, systems, servers, sources and monitoring item distribution, in accordance with some embodiments;

FIG. 24 comprises a simplified block diagram of an exemplary shopping system in accordance with various embodiments of these teachings;

FIG. 25 comprises a flow diagram as configured in accordance with various embodiments of these teachings;

FIG. 26 comprises a simplified screen shot of a customer profile in a database in accordance with various embodiments of these teachings;

FIGS. 27-33 comprise simplified screen shots of a user interface on an electronic user device as configured in accordance with various embodiments of these teachings;

FIG. 34 illustrates an exemplary system for use in implementing systems, apparatuses, devices, methods, techniques, and the like in monitoring retail products in a shopping space in accordance with various embodiments of these teachings;

FIG. 35 comprises a flow diagram as configured in accordance with various embodiments of these teachings;

FIG. 36 comprises a block diagram as configured in accordance with various embodiments of these teachings;

FIG. 37 comprises a flow diagram as configured in accordance with various embodiments of these teachings;

FIG. 38 comprises a flow diagram as configured in accordance with various embodiments of these teachings;

FIG. 39 comprises a flow diagram as configured in accordance with various embodiments of these teachings;

FIG. 40 comprises an illustration of blocks as configured in accordance with various embodiments of these teachings;

FIG. 41 comprises an illustration of transactions configured in accordance with various embodiments of these teachings;

FIG. 42 comprises a flow diagram in accordance with various embodiments of these teachings;

FIG. 43 comprises a process diagram as configured in accordance with various embodiments of these teachings;

FIG. 44 comprises an illustration of a delivery record configured in accordance with various embodiments of these teachings; and

FIG. 45 comprises a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

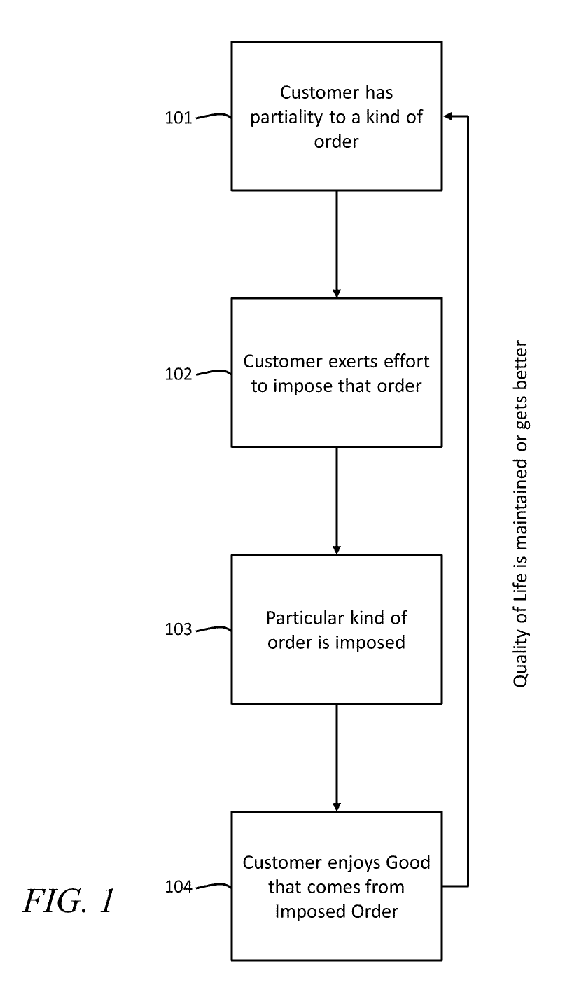

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

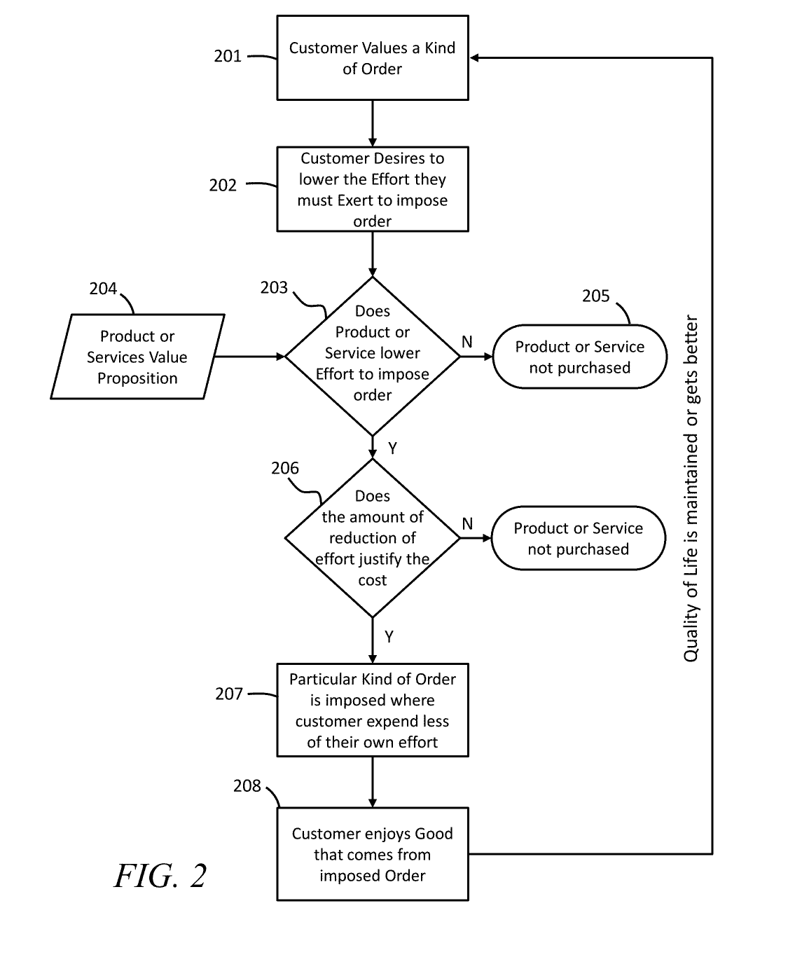

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

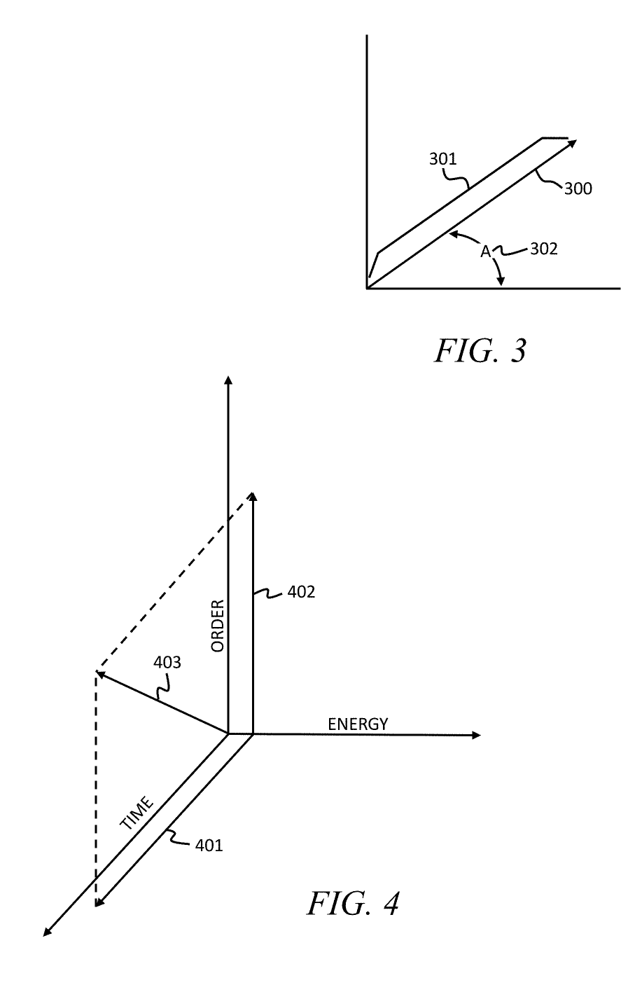

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

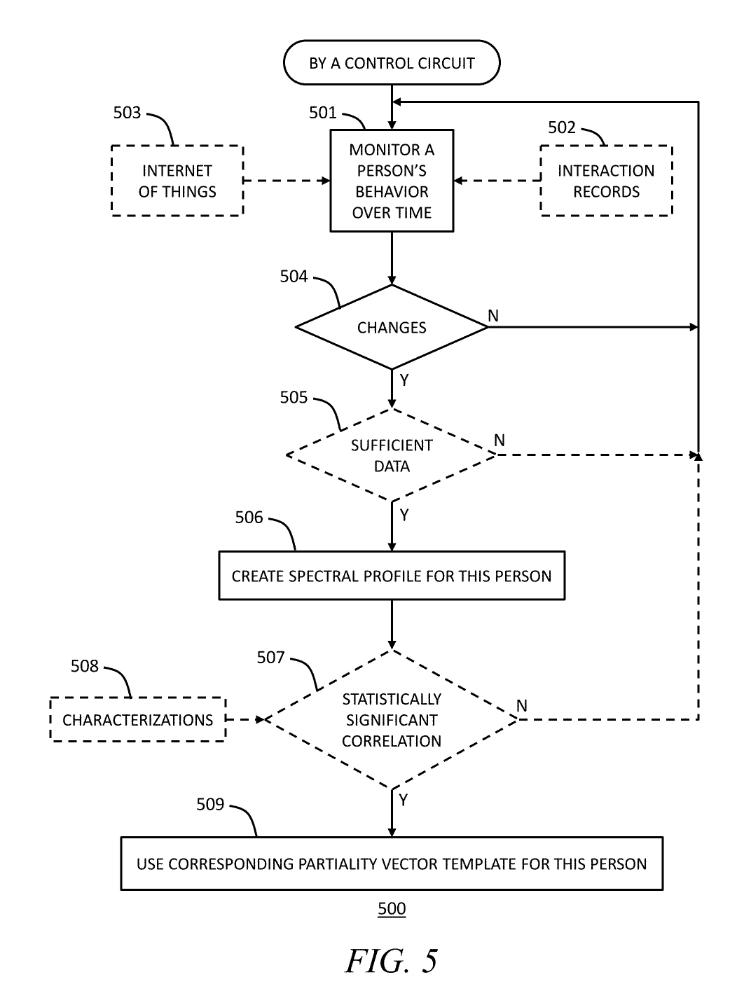

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

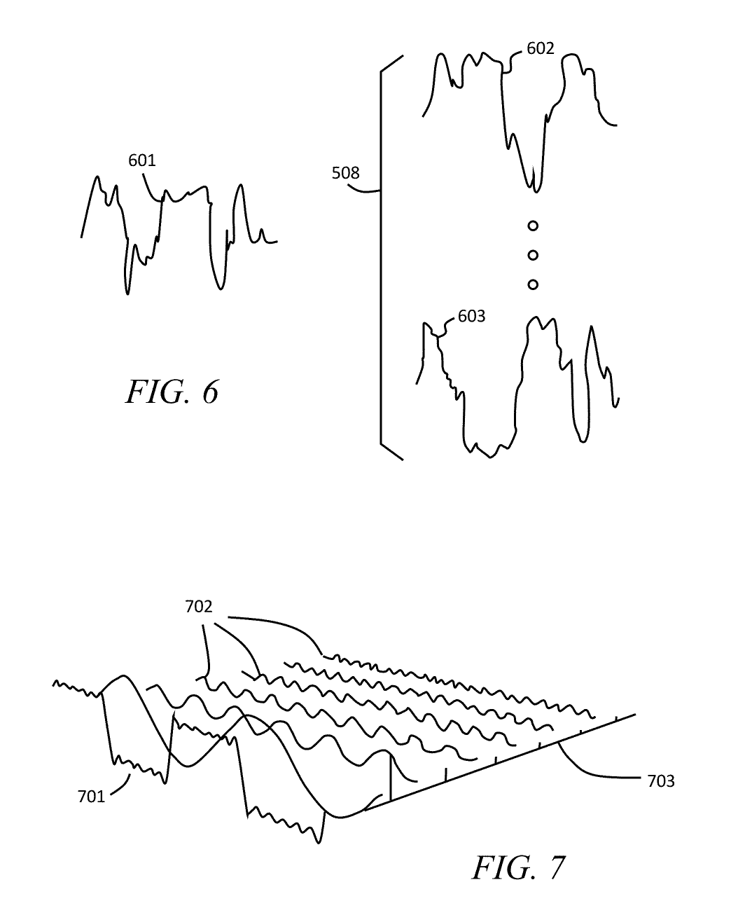

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

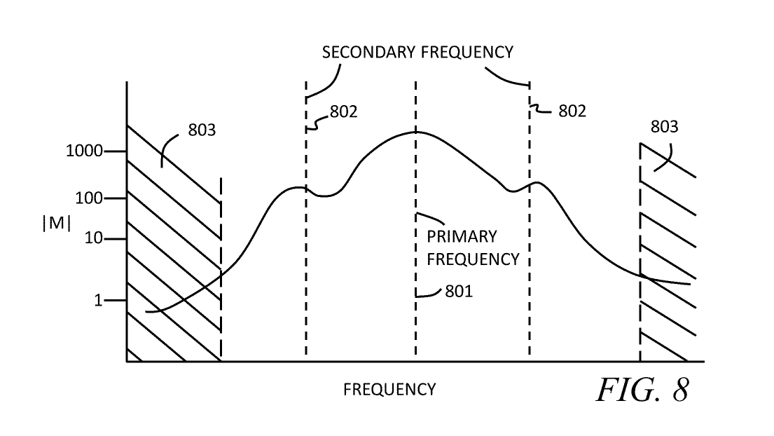

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

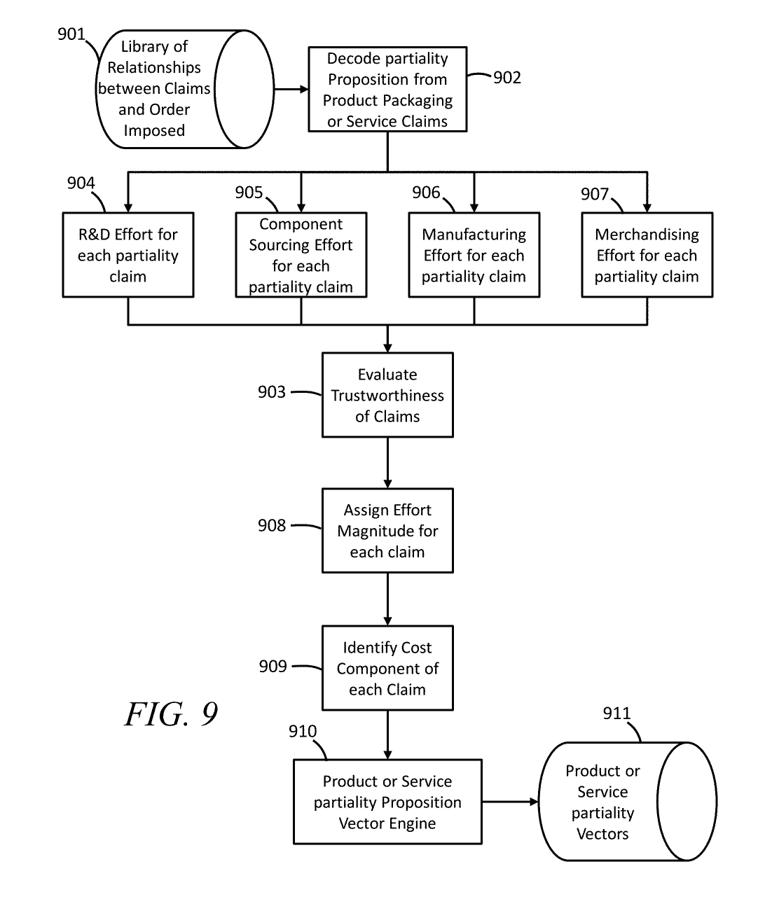

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself. (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

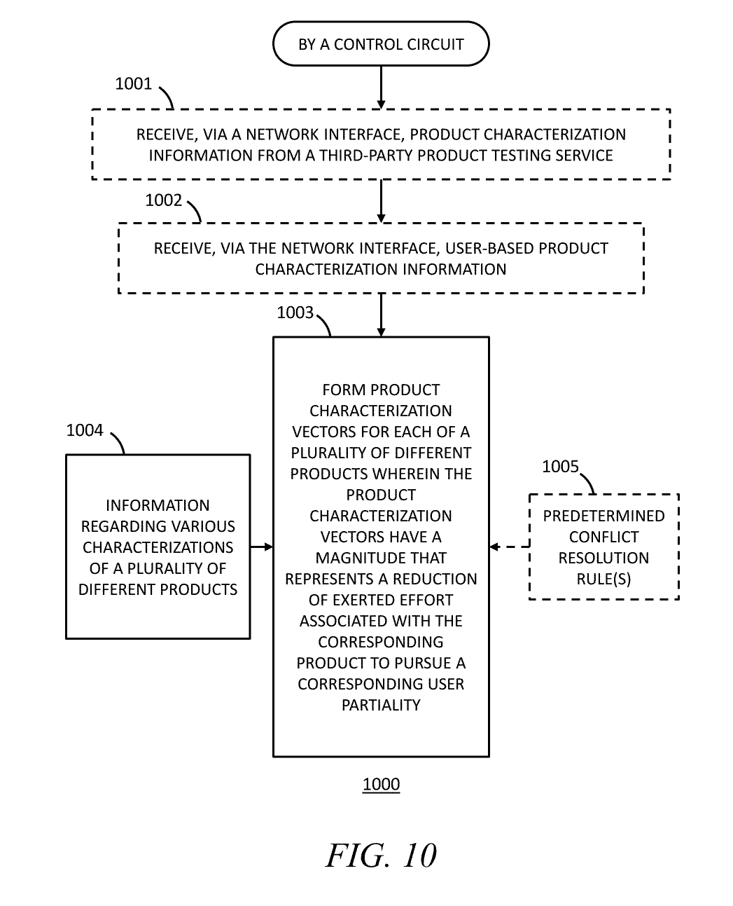

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

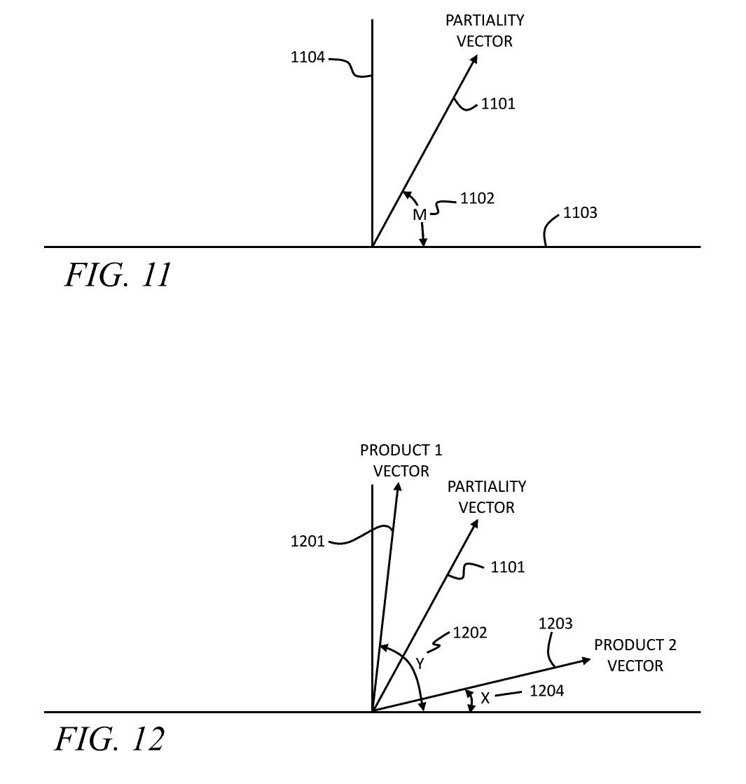

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

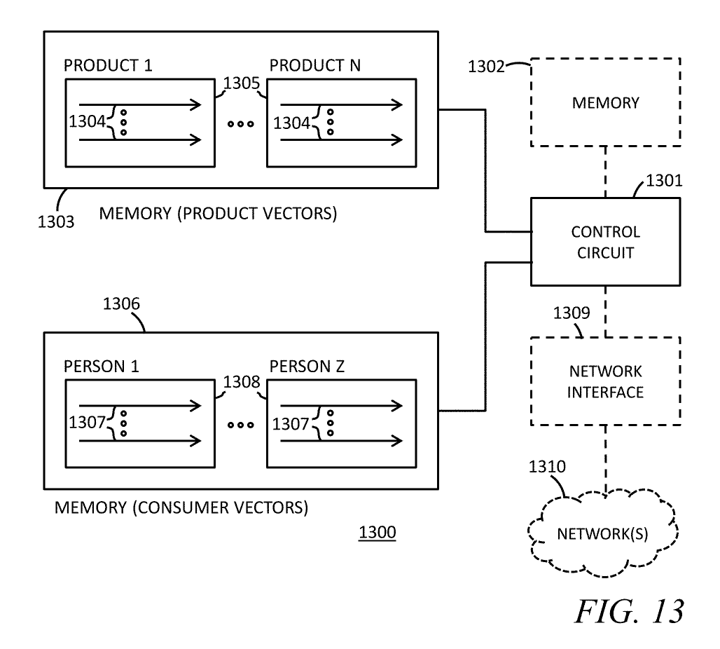

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

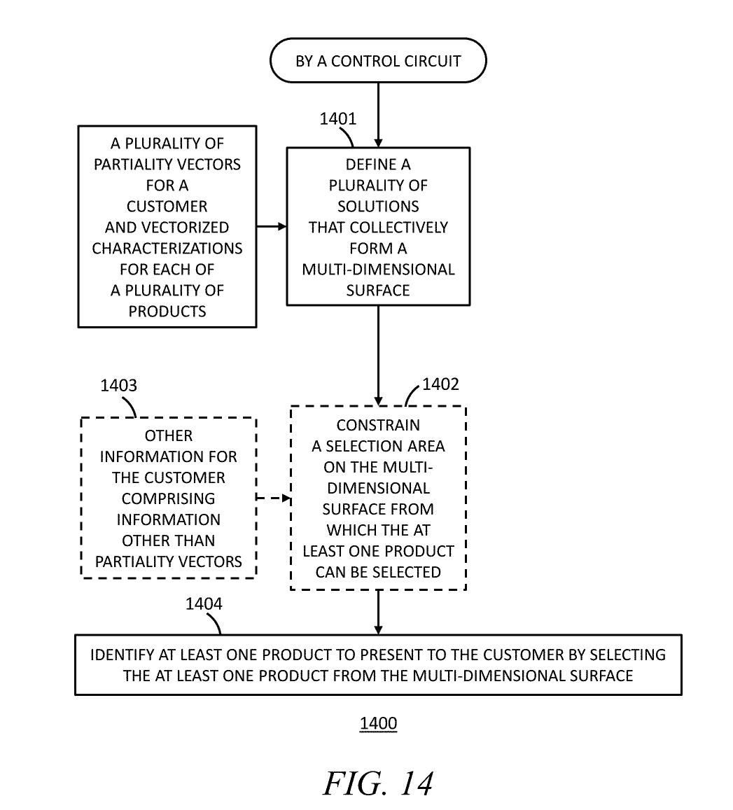

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

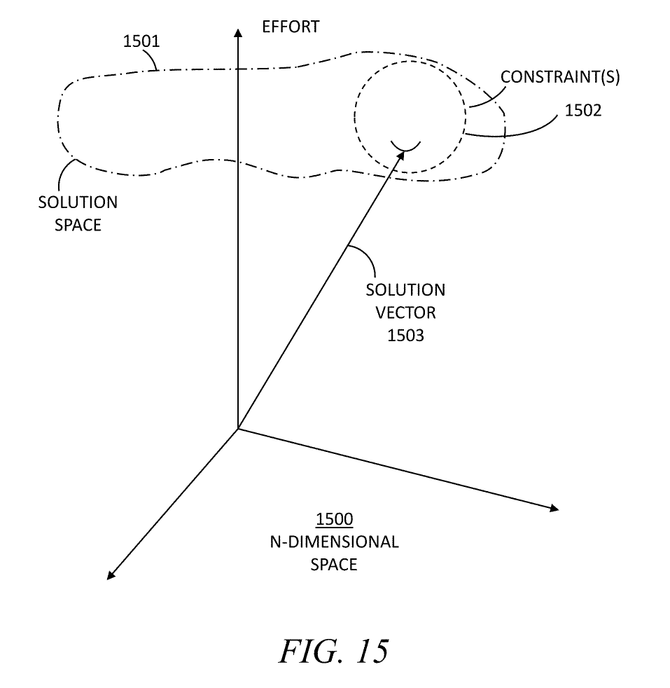

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

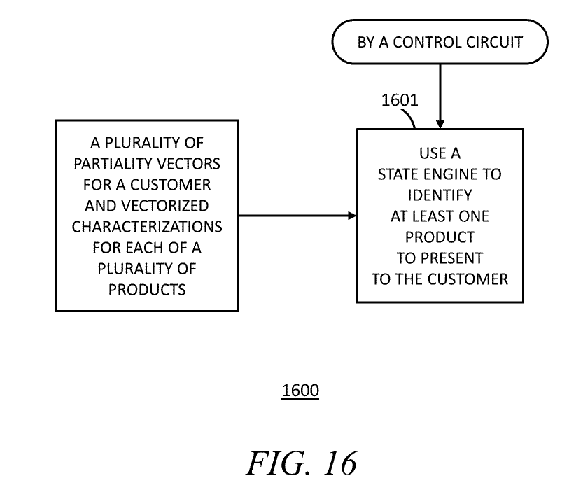

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM))).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

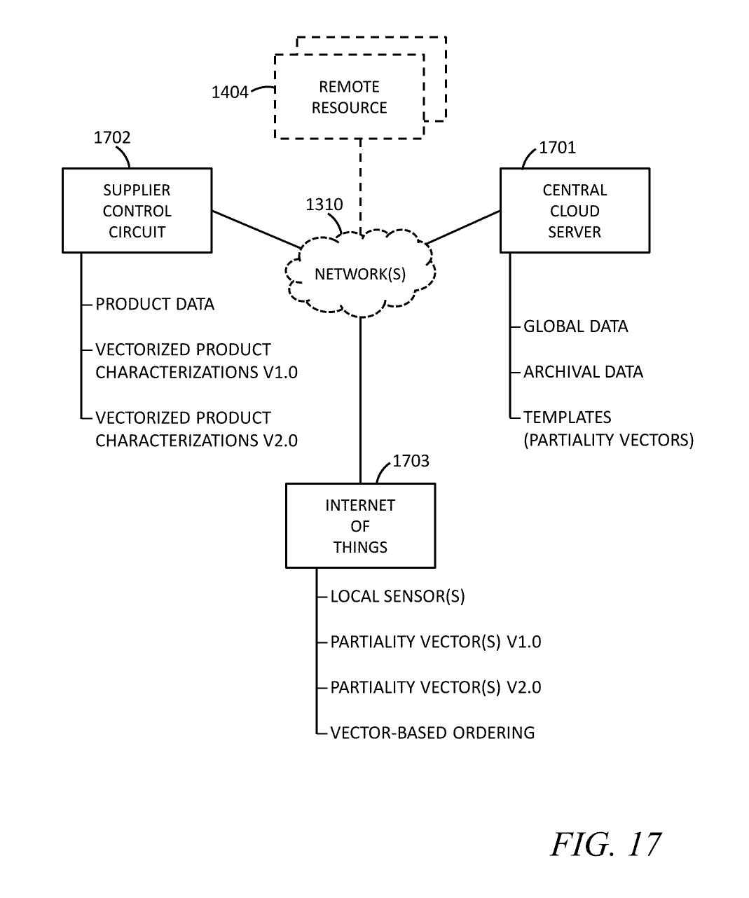

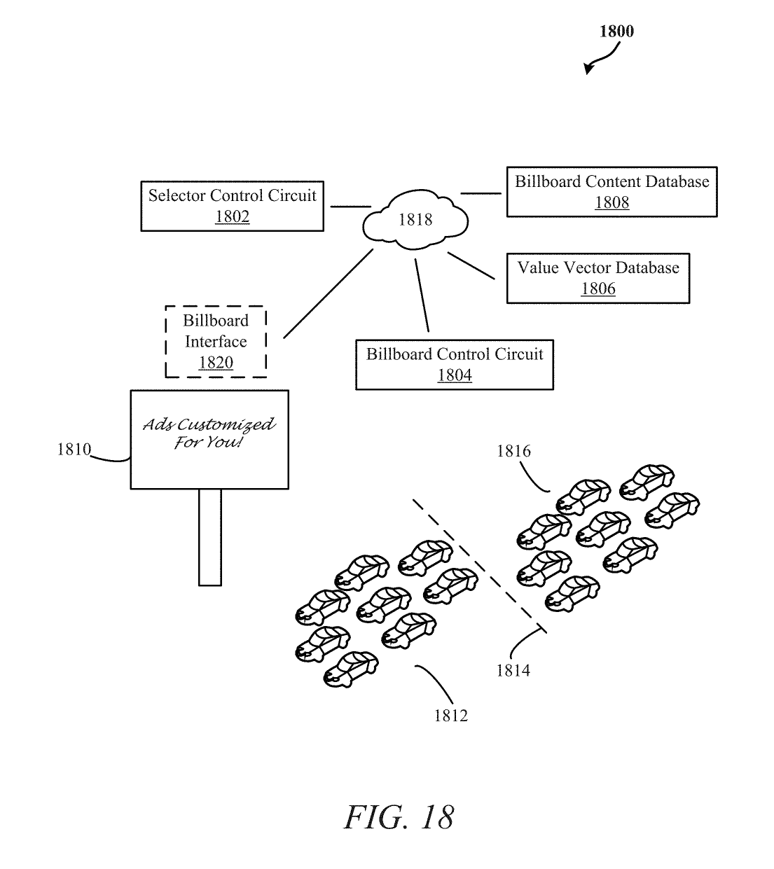

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

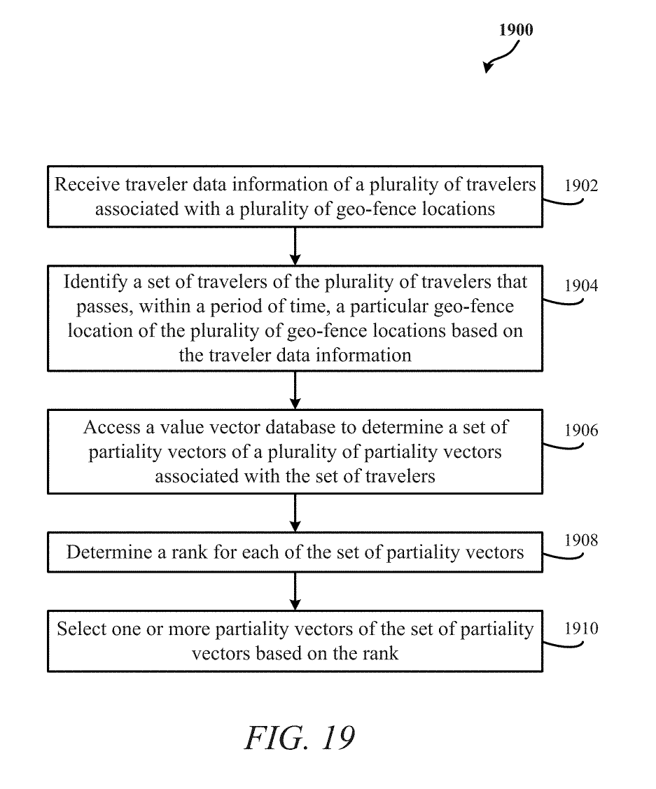

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

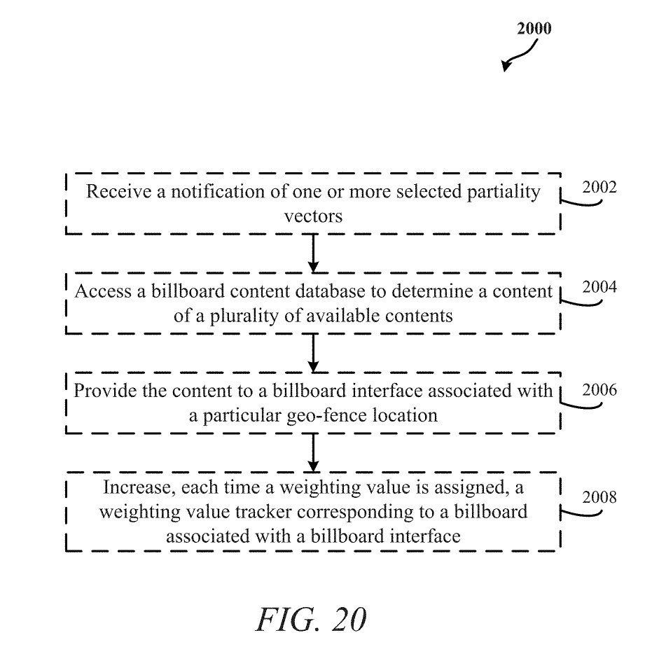

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

As such, the partiality vectors described above and illustrated in FIGS. 1 through 17 may be applicable in various scenarios where customization of content may be useful. One example of such a scenario is customization of content presented to a group of potential purchases, such as shown on a billboard, a bus stop, within a mass transit system, and the like. Generally speaking, pursuant to various embodiments, systems, apparatuses and methods are provided herein useful for customizing content of a billboard or other roadside advertising system. In some embodiments, a system for customizing content of a billboard comprises: a partiality vector database having stored therein: information including partiality information for each of a plurality of travelers in a form of a plurality of partiality vectors for each of the plurality of travelers. In one configuration, each of the partiality vectors has at least one of a magnitude and an angle that corresponds to a magnitude of the traveler's belief in an amount of good that comes from an order associated with that partiality. By one approach, the system may include a selector control circuit coupled to the partiality vector database. The selector control circuit may receive traveler data information of the plurality of travelers associated with a plurality of geo-fence locations. By one approach, the traveler data information may be based on the plurality of travelers having location services in their smart devices turned on. The smart devices may include a smart phone, a tablet, an iPad, a smart watch, a laptop, and/or the like. By another approach, the traveler data information may be determined based on location services data of the smart devices and retailer data associated with a plurality of retail customers. By yet another approach, the traveler data information may be determined based at least on mobile analytics information as described in U.S. Provisional Application No. 62/380,806, filed Aug. 29, 2016, entitled MOBILE ANALYTICS-BASED IDENTIFICATION (Attorney Docket No. 8842-139051-USPR_1837US01), and U.S. application Ser. No. 15/689,147, filed Aug. 29, 2017, which are both incorporated herein by reference in their entirety. In another configuration, the selector control circuit may identify a set of travelers of the plurality of travelers that passes, within a period of time, a particular geo-fence location of the plurality of geo-fence locations based on the traveler data information. In one example, the set of travelers may be identified by the selector control circuit based on the plurality of travelers that have historically passed the particular geo-fence location within the period of time based on the traveler data information. In another configuration, the selector control circuit may access the partiality vector database to determine a set of partiality vectors of the plurality of partiality vectors associated with the set of travelers. In another configuration, the selector control circuit may determine a rank for each of the set of partiality vectors. The rank may be based on a frequency distribution of the set of partiality vectors. In another configuration, the selector control circuit may select one or more partiality vectors of the set of partiality vectors based on the rank.

By another approach, the system may include a billboard control circuit communicatively coupled to the selector control circuit. The billboard control circuit may receive a notification of the one or more selected partiality vectors. In one configuration, the billboard control circuit may access a billboard content database to determine a content of a plurality of available contents. The content may be associated with at least one product having a particular vectorized characterizations of a plurality of vectorized characterizations in accordance with a threshold alignment of the one or more selected partiality vectors. In another configuration, the billboard control circuit may provide the content to a billboard interface associated with the particular geo-fence location.

In some embodiments, a method for customizing content of a billboard comprising: receiving traveler data information of a plurality of travelers associated with a plurality of geo-fence locations. By one approach, the method may include identifying a set of travelers of the plurality of travelers that passes, within a period of time, a particular geo-fence location of the plurality of geo-fence locations based on the traveler data information. By another approach, the method may include accessing a partiality vector database to determine a set of partiality vectors of a plurality of partiality vectors associated with the set of travelers. In one configuration, the partiality vector database have information including partiality information for each of the plurality of travelers stored therein. In one example, the partiality information for each of the plurality of travelers may be in a form of the plurality of partiality vectors for each of the plurality of travelers. In another example, the partiality vector may have at least one of a magnitude and an angle that may correspond to a magnitude of the traveler's belief in an amount of good that comes from an order associated with that partiality. In another configuration, the method may include determining a rank for each of the set of partiality vectors. In one example, the rank may be based on a frequency distribution of the set of partiality vectors. In another configuration, the method may include selecting one or more partiality vectors of the set of partiality vectors based on the rank.

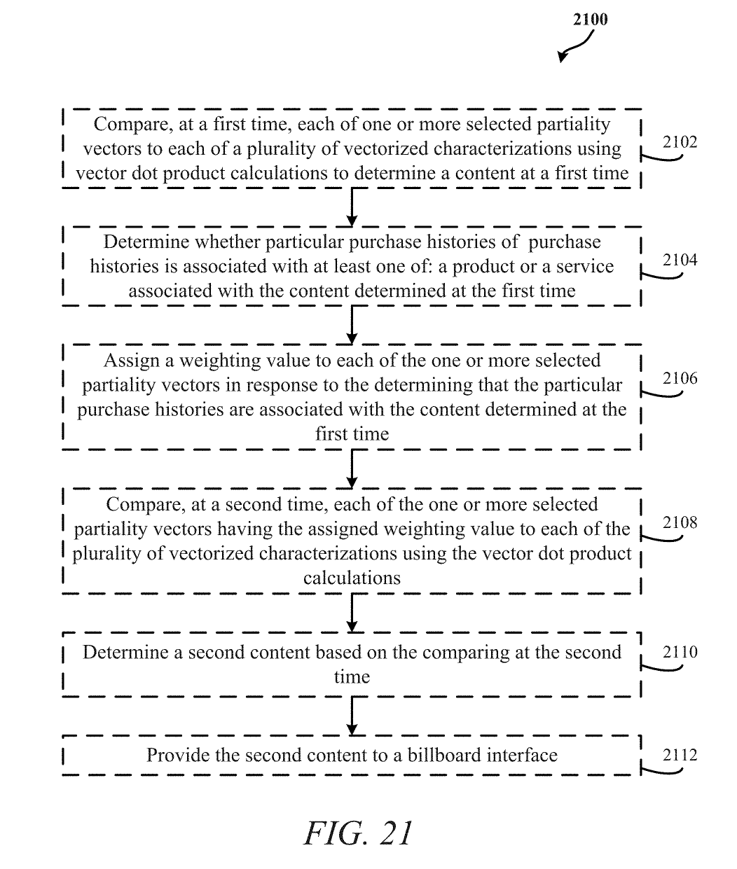

To illustrate, FIGS. 18 through 23 are described below. In addition, further descriptions of partiality vectors, partiality information, and/or vectorized characterizations may be found in paragraphs above and/or illustrated in FIGS. 1 through 17. FIG. 18 illustrates a simplified block diagram of an exemplary system 1800 for customizing content of a roadside advertisement system 1810, referred to for simplicity as a billboard, in accordance with some embodiments. The system 1800 includes a partiality vector database 1806. By one approach, the partiality vector database 1806 may correspond to the memory 1302 of FIG. 13. By another approach, the partiality vector database 1806 may correspond to a computer server configured to manage, operate on, and/or maintain (among other computer functionalities that a server may perform) data associated with partiality information of customers of one or more retailers. In one configuration, the computer server may be cooperated with a memory storing partiality information of customers. In one example, the memory may include external and/or internal memory devices.

In some embodiments, the partiality vector database 1806 may have stored therein information including partiality information for each of a plurality of travelers 1812, 1816, general template partiality information corresponding to groups of travelers that regularly travel along routes where advertisement is controlled, partiality information that may be associated with one or more travelers 1812, 1816 based on similarities with other known individuals, and/or other such partiality information. In one configuration, the partiality information for each of the plurality of travelers 1812, 1816 may be in a form of a plurality of partiality vectors for each of the plurality of travelers 1812, 1816. In such a configuration, each of the partiality vectors may have at least one of a magnitude and an angle that corresponds to a magnitude of the traveler's belief in an amount of good that comes from an order associated with that partiality. For example, the partiality vector database 1806 may include a first partiality vector for environmental consciousness, a second partiality vector for pet friendly, and a third partiality vector for low cost. By one approach, each of the plurality of partiality vectors in the partiality vector database 1806 may be associated with one or more of the plurality of travelers 1812, 1816. In one configuration, each of the plurality of travelers 1812, 1816 may be associated with each of the plurality of partiality vectors. In another configuration, each of the plurality of travelers 1812, 1816 may be variously associated with one or more of the partiality vectors. For example, one of the plurality of travelers 1812, 1816 may be associated with the first partiality vector for environmental consciousness and the third partiality vector for low cost while another one of the plurality of travelers 1812, 1816 may be associated with the third partiality vector for low cost and the second partiality vector for pet friendly.

By one approach, the system 1800 may include a selector control circuit 1802 coupled to the partiality vector database 1806 via a communication network 1818. The communication network 1818 may include a wired and/or a wireless communication network using one or more communication protocols to send and/or receive data between devices over the communication network 1818. In another configuration, the communication network 1818 may include one or more subnetworks using the one or more communication protocols. Alternatively or in addition to, the communication network 1818 may be adapted to communicatively couple a billboard control circuit 1804, a billboard content database 1808, and/or a billboard interface 1820.

By one approach, the selector control circuit 1802 may receive and/or access traveler data information associated with one or more, and typically a plurality of travelers 1812, 1816 that are associated with one or more geo-fence locations through the communication network 1818. For example, the traveler data information may be accessed from one or more computer servers and/or databases coupled to the communication network 1818. The computer server may be configured to manage, operate on, track, and/or maintain (among other computer functionalities that a server may perform) data associated with a plurality of customers. In one configuration, the plurality of customers may include the plurality of travelers 1812, 1816. By one approach, the traveler data information may include identifier information, partiality vector information, purchase histories of the plurality of travelers 1812, 1816, previous advertising content presented to the traveler, advertising effectiveness information based on purchases associated with advertising content, and other such information. In one example, the purchase histories may be associated with one or more retailers. In another example, the purchase histories may comprise product purchases by the plurality of customers over a period of time. In such an example, the purchase histories may be based on data associated with credit card data, point-of-sale data, a retailer assigned customer identifier or code data, consumer electronic device identifier information, and wireless access point data, among other options to obtain data associated with purchase histories of the plurality of customers. In another example, the traveler data information may include a plurality of geo-fence locations associated with the plurality of customers. By one approach, the traveler data information sent to the selector control circuit 1802 may be associated with the plurality of travelers 1812, 1816 that are associated with a particular geo-fence location 1814. By another approach, the selector control circuit 1802 may identify which of the plurality of customers are associated with the particular geo-fence location 1814. For example, the selector control circuit 1802 may filter through the traveler data information and select data associated with the particular geo-fence location 1814 to determine a group of travelers of the plurality of travelers 1812, 1816. In either approach, the selector control circuit 1802 may identify a set of travelers 1812 among the group of travelers of the plurality of travelers 1812, 1816 that passes, within a period of time, the particular geo-fence location 1814 of the plurality of geo-fence locations based on the traveler data information. For example, the particular geo-fence location 1814 may be associated with the billboard 1810 and/or the billboard interface 1820. The particular geo-fence location 1814 may comprise a threshold distance from the billboard 1810, a threshold distance from one or more places of business, a threshold line of sight distance from the billboard 1810, and/or a threshold time from the billboard 1810 and/or the one or more place of businesses, to name a few. In another example, the selector control circuit 1802 may determine the period of time based on a volume of travelers of the group of travelers that passes the particular geo-fence location 1814. For example, the selector control circuit 1802 may determine that there is a high volume of travelers among the group of travelers that passes between 11 AM and 1 PM. Thus, the selector control circuit 1802 may select, in this example, the period of the time to be between 11 AM and 1 PM. Alternatively or in addition to, the selector control circuit 1802 may determine the period of time based on a shared common destination, a shared start of travel origin, and/or total distance of travel of the group of travelers, among other options to identify possible shared characteristics of the group of travelers. In yet another example, one or more data in the traveler data information may indicate a pattern that during a threshold time between 3 PM to 3:30 PM on Monday through Friday, the set of travelers 1812 may pass the particular geo-fence location 1814. In another example, the traveler data information may indicate a second pattern indicating that the set of travelers 1812, at a particular time and passing the particular geo-fence location 1814, may have a common destination. As such, a customized content shown on the billboard 1810 may be associated with the common destination and tailored to a common set of one or more partiality vectors of the set of travelers 1812. For example, based on the traveler data information, during a threshold time between 9 PM to 9:30 PM on a Sunday, some of the plurality of travelers 1812, 1816 pass the particular geo-fence location 1814 and head towards a famous breakfast/brunch dinner. Thus, the selector control circuit 1802 may identify one or more patterns based on the traveler data information received, and may subsequently identify the set of travelers 1812 that is associated with the one or more patterns. As such, the selector control circuit 1802 may customize a content shown on the billboard 1810 for the set of travelers 1812 based on partiality information associated with the set of travelers 1812 that are accessed from the partiality vector database 1806.

By one approach, the selector control circuit 1802 may access the partiality vector database 1806 to determine a set of partiality vectors of the plurality of partiality vectors associated with the set of travelers 1812. In response to the access, the selector control circuit 1802 may perform a search of the set of partiality vectors associated with the set of travelers 1812. In one configuration, the selector control circuit 1802 applies one or more rules to initially determine which partiality vectors of the plurality of partiality vectors are associated with each of the set of travelers 1812. For example, the selector control circuit 1802 may perform a search for each of the set of travelers 1812 and save a result to a local memory. In response, the selector control circuit 1802 may compare each magnitude associated with each of the partiality vectors associated with each of the set of travelers 1812 with a predetermined magnitude threshold. Alternatively or in addition to, each magnitude of a particular partiality vector may be compared by the selector control circuit 1802 with a respective threshold associated with the particular partiality vector. As such, the selector control circuit 1802 may, in determining the set of partiality vectors, identify whether each partiality vector of the set of partiality vectors has a particular magnitude that is equal to or greater than a respective first threshold and/or the predetermined magnitude threshold. Alternatively or in addition to, the selector control circuit 1802 may determine an average magnitude of each of the partiality vectors associated with each of the set of travelers 1812. In response, the selector control circuit 1802 may identify whether each partiality vector of the set of partiality vectors has an average magnitude that is equal to or greater than a respective first threshold and/or the predetermined magnitude threshold. Thus, by one approach, after identifying the partiality vectors that is at least equal to the respective first threshold and/or the predetermined magnitude threshold, the selector control circuit 1802 may determine a frequency distribution of the identified partiality vectors and rank each of the identified partiality vectors based on the frequency distribution.

In one configuration, the selector control circuit 1802 may determine a frequency distribution of each partiality vector of the set of partiality vectors based on a number of travelers that are associated with each partiality vector of the set of partiality vectors. In one configuration, the selector control circuit 1802 may determine a percent distribution of each partiality vector of the set of partiality vectors based on the frequency distribution. In another configuration, the selector control circuit 1802 may determine at least one particular partiality vector of the set of partiality vectors having a particular determined percent distribution. In one example, the particular determined percent distribution may comprise a percent value that may be equal to or greater than a second predetermined threshold. In another example, a ranking of the at least one particular partiality vector may be determined based on the particular determined percent distribution.

In an illustrative non-limiting example, the set of travelers are identified as Pablo, Natasha, and Picasso. In comparing magnitudes of each partiality vectors in the partiality vector database 1806 associated with each of Pablo, Natasha, and Picasso with the respective first threshold and/or the predetermined magnitude threshold, the selector control circuit 1802 may determine that the following partiality vectors have at least reached the respective first threshold and/or the predetermined magnitude threshold: environmental consciousness, pet friendly, and low cost for Pablo; pet friendly, low cost, and cleanliness for Natasha; low cost, cleanliness, and made in USA for Picasso. Thus, the set of partiality vectors that have at least reached the respective first threshold and/or the predetermined magnitude threshold are environmental consciousness, pet friendly, low cost, cleanliness, and made in USA. Subsequently, the selector control circuit 1802 may determine a frequency distribution for each of the environmental consciousness, the pet friendly, the low cost, the cleanliness, and the made in USA partiality vectors based on a number of travelers that are associated with each partiality vector. For example, the selector control circuit 1802 may determine that the following are the frequency distribution for Pablo, Natasha, and Picasso: one traveler (Pablo) for environmental consciousness; two travelers (Pablo and Natasha) for pet friendly; three travelers (Pablo, Natasha, and Picasso) for low cost; two travelers (Natasha, and Picasso) for cleanliness; and one traveler (Picasso) for made in USA.

In some embodiments, the selector control circuit 1802 may determine a percent distribution (e.g., number of travelers identified for each partiality vector of the frequency distribution/total number of partiality vectors in the frequency distribution) for each of the environmental consciousness, the pet friendly, the low cost, the cleanliness, and the made in USA partiality vectors based on the frequency distribution. In continuing the illustrative non-limiting example above, the following are the percent distributions that may be determined by the selector control circuit 1802: 11% for the environmental consciousness, 22% for the pet friendly, 33% for the low cost, 22% for the cleanliness, and 11% for the made in USA. The percent distributions and/or any numbers described in the examples above or below are for illustration purposes. Thus, the selector control circuit 1802 is adapted to perform operations on a plurality of data concurrently and arrive at one or more values at near-real time.

In one configuration, the selector control circuit 1802 may receive a second threshold (e.g., a target ad threshold) corresponding to 30%, for example. In one configuration, the second threshold may comprise a value at which a retailer may determine to be an effective percent of customers and/or possible customers to direct a targeted advertising; an initial value to which an initial determination of effectiveness of targeted advertising may be based on; and/or any value that is predetermined by the retailer and/or based on a research performed in the industry the retailer is associated with; among other possible values.

Continuing the illustrative non-limiting example above, the selector control circuit 1802 may determine, after comparing each of the determined percent distribution with the second threshold, that among the environmental consciousness, the pet friendly, the low cost, the cleanliness, and the made in USA partiality vectors, the low cost partiality vector has a percent distribution that is equal to or greater than the 30% second threshold. Alternatively or in addition to, the selector control circuit 1802 may determine a corresponding rank of each of the set of partialities based on the determined percent distribution. Alternatively or in addition to, the selector control circuit 1802 may determine the corresponding rank of each of the set of partialities based on the determined frequency distribution. As such, a rank of a particular partiality vector may be based on a frequency distribution of the set of partiality vectors. Thus, by another approach, the selector control circuit 1802 may determine the corresponding rank based on the frequency distribution without determining the percent distribution. As such, the second threshold may correspond to a ranking value, not a percentage value. In either approach, the selector control circuit 1802 may select one or more partiality vectors of the set of partiality vectors based on the determined rank. In the illustrative non-limiting example above, the determined rankings are 3 rank for the environmental consciousness, 2^{nd} rank for the pet friendly, 1^{st} rank for the low cost, 2^{nd} rank for the cleanliness, and 3^{rd} rank for the made in USA.

In another configuration, the system 1800 may include the billboard control circuit 1804 that is communicatively coupled to the selector control circuit 1802. The billboard control circuit 1804 may receive a notification of the one or more selected partiality vectors. In one example, the notification may include data associated with the one or more selected partiality vectors, for example, the low cost and the cleanliness for being the first two highest ranking partiality vectors. The data may include one or more of selected partiality vectors, weighting values, rankings of the selected partiality vectors, and/or the like. By one approach, the notification may trigger the billboard control circuit 1804 to initiate access of the billboard content database 1808. In another example, the notification may be sent to the billboard control circuit 1804 periodically, whenever the pattern indicated in the traveler data information changed, and/or based on effectiveness of a previously shown content on the billboard 1810. By one approach, the billboard control circuit 1804 may access the billboard content database 1808 to determine a content of a plurality of available contents that is to be presented to the set of travelers 1812 considered. By one approach, the billboard content database 1808 may have a plurality of vectorized characterizations for each product associated with each of the plurality of available contents stored therein. In one implementation, each of the vectorized characterizations may indicate a measure regarding an extent to which a corresponding product of one of the plurality of available contents accords with a corresponding one of the plurality of partiality vectors. By another approach, the billboard content database 1808 may include a plurality of content associated with a plurality of advertisements. In one configuration, each of the plurality of content may be associated with one or more products. In such a configuration, each of the one or more products may be associated with a plurality of vectorized characterizations. In one example, a content may be associated with at least one product having particular vectorized characterizations of the plurality of vectorized characterizations in accordance with a threshold alignment of one or more selected partiality vectors. For example, the billboard control circuit 1804 may compare, at a first time, each of the one or more selected partiality vectors to each of the plurality of vectorized characterizations to determine an alignment between selected partiality vectors and the vectorized characterizations of products and/or advertising content. In some embodiments, the comparison may use vector dot product calculations, and determine the content to be presented at the first time based on the determined alignments.

Continuing the illustrative non-limiting example above, subsequent to receiving the one or more selected partiality vectors, the billboard control circuit 1804 may determine, by accessing the billboard content database 1808, that vectorized characterizations of at least 100 products are in accordance with a threshold alignment of the low cost partiality vector. Alternatively or in addition to, the billboard control circuit 1804 in further determining a particular content to show on the billboard 1810 may consider the alignment of multiple partiality vectors and corresponding product vectorized characterizations. In some instances, for example, the billboard control circuit 1804 may receive and/or send a request to the selector control circuit 1802 for additional partiality vectors that may be determined to be ranked 2^{nd} (3^{rd}, 4^{th}, 5^{th}, etc.). In response, in this example, the selector control circuit 1802 may send a second notification indicating the pet friendly, and the cleanliness partiality vectors. As such, by one approach, the billboard control circuit 1804 may further determine that a particular product of the at least 100 products are in accordance with a threshold alignment of the determined 1^{st} and 2^{nd} ranking partiality vectors, which in this example are the low cost, the pet friendly, and the cleanliness partiality vectors. In such an approach, the billboard control circuit 1804 may determine a particular content associated with the particular product based on the accessing of the billboard content database 1808. In yet another example, if after the determining described above, the billboard control circuit 1804 may still have determined more than one product that is in accordance with a threshold alignment of the determined 1^{st} and 2^{nd} ranking partiality vectors, the billboard control circuit 1804 may select a content that is most aligned with the determined 1^{st} and 2^{nd} ranking partiality vectors. Thus, the billboard control circuit 1804 may provide a particular content to the billboard interface 1820, where the particular content is customized for the set of travelers 1812, for example, Pablo, Natasha, and Picasso. In one configuration, the customization may be based in part on the partiality vectors associated with Pablo, Natasha, and Picasso.

In another example, the billboard control circuit 1804 may determine that a particular vectorized characterization of only one product (instead of the at least 100 products as previously described) is in accordance with a threshold alignment of the low cost partiality vector. In such an approach, the billboard control circuit 1804 may determine a particular content associated with the one product based on the accessing of the billboard content database 1808. As such, the billboard control circuit 1804 may provide the determined content to the billboard interface 1820 that is associated with the particular geo-fence location 1814.

In some embodiments, the selector control circuit 1802 in selecting a content may additionally determine whether particular purchase histories of the purchase histories may be associated with at least one of: a product or a service associated with a content determined at a first time. By one approach, the selector control circuit 1802 may assign a weighting value to each of the one or more selected partiality vectors in response to the determination that the particular purchase histories are associated with the content determined at the first time. By one approach, the weighting value may correspond to effectiveness of advertising on the billboard 1810. Thus, the more the set of travelers 1812 purchase a product based on a content shown on the billboard 1810, the more the billboard control circuit 1804 selects a content having a vectorized characterization in accordance with a threshold alignment of a partiality vector shared by the set of travelers 1812.

For example, continuing the illustrative non-limiting example above, the selector control circuit 1802 may determine that purchase history of a first traveler of a set of travelers indicates that the first traveler may have purchased a product associated with a content previously shown on the billboard 1810. As such, by one approach, the billboard control circuit 1804 may assign a weighting value, for example, to the low cost partiality vector, during vector dot product calculations. Thus, the selector control circuit 1802 may subsequently compare each of one or more subsequently selected partiality vectors (e.g., where at least the low cost partiality vector is at least assigned the weighting value) to each of a plurality of vectorized characterizations using the vector dot product calculations. As such, when a vector dot product is applied between the weighted low cost partiality vector and at least one of the plurality of vectorized characterizations, a resulting threshold alignment may have a value greater than a value of a threshold alignment resulting from a vector dot product between an unweighted partiality vector and at least one of the plurality of vectorized characterizations. Thus, when the billboard control circuit 1804 has determined a content to provide to the billboard interface 1820, the partiality information that the determined content may project is weighted towards the low cost partiality vector. As such, the billboard control circuit 1804 may determine, based on the weighting value, that the low cost partiality vector is a particular partiality vector that has historically been most effective in encouraging the set of travelers to purchase at least a product associated with a content shown on the billboard 1810. Subsequently, in one configuration, the billboard control circuit 1804 may determine a second content based on a comparison, at a second time, of one or more selected partiality vectors having the assigned weighting value to a plurality of vectorized characterizations using vector dot product calculations.

In some embodiments, the selector control circuit 1802 may, each time the weighting value is assigned, increase a weighting value tracker corresponding to the billboard 1810 that is associated with the billboard interface 1820. In one example, the weighting value tracker may indicate overall effectiveness of advertising on the billboard 1810. Thus, in addition to tracking the particular partiality vector that encourages the set of travelers to buy a particular product, the selector control circuit 1802 may also track the overall effectiveness of the billboard 1810 in reaching the set of travelers associated with the particular partiality vector. For example, the selector control circuit 1802 may assign a weighting value to each of one or more selected partiality vectors based on a determination that particular purchase histories of the plurality of travelers 1812, 1816 may be associated with a previous content provided to the billboard 1810 associated with the billboard interface 1820. In response, the selector control circuit 1802 may increase a weighting value tracker corresponding to the billboard 1810 to track the effectiveness of showing content on the billboard 1810.

In some embodiments, the selector control circuit 1802 and the billboard control circuit 1804 are part of a distributed computing environment. For example, the selector control circuit 1802 may be part of a computer server configured to manage, operate on, and/or maintain (among other computer functionalities that a server may perform) data associated determining partiality vectors used to customize contents for advertising. In such an example, the selector control circuit 1802 may be coupled to a plurality of billboard control circuits configured to determine a content associated with the partiality vectors that are highly represented in the set of travelers that passes, within a particular period of time, a geo-fence location associated with corresponding billboard. In another example, the selector control circuit 1802 and/or the billboard control circuit 1804 may include one or more processing circuits executing one or more functions corresponding to the selector control circuit 1802 and/or the billboard control circuit 1804. For example, a traveler electronic device may execute, as part of a distributed computing environment, at least one of the functions corresponding to the selector control circuit 1802 or the billboard control circuit 1804.

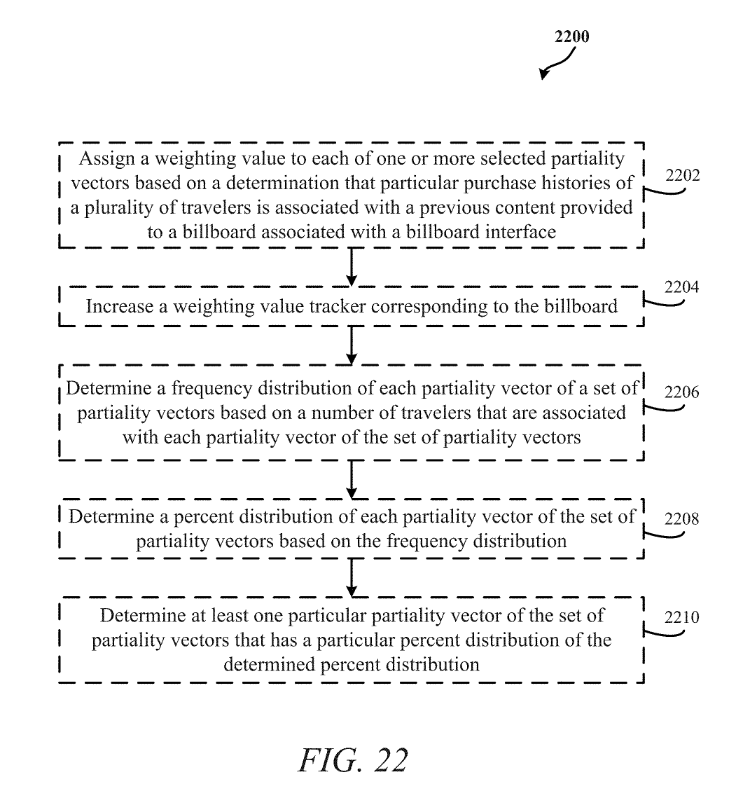

FIG. 19 illustrates a flow diagram of an exemplary method 1900 for customizing content of a billboard in accordance with some embodiments. By one approach, the exemplary method 1900 may be implemented in the system 1800 of FIG. 18. By one approach, the method 1900 may be implemented in the selector control circuit 1802 or the billboard control circuit 1804 of FIG. 1. By another approach, one or more steps in the method 1900 may be implemented in the selector control circuit 1802 or the billboard control circuit 1804 of FIG. 1. The method 1900 includes, at step 1902, receiving traveler data information of a plurality of travelers associated with a plurality of geo-fence locations. In one configuration, the method 1900 may include identifying a set of travelers of the plurality of travelers that passes, within a period of time, a particular geo-fence location of the plurality of geo-fence locations based on the traveler data information, at step 1904. The method 1900 may include, at step 1906, accessing a partiality vector database to determine a set of partiality vectors of a plurality of partiality vectors associated with the set of travelers. By one approach, the partiality vector database may have information including partiality information for each of the plurality of travelers stored therein. In one configuration, the partiality information for each of the plurality of travelers may be in a form of the plurality of partiality vectors for each of the plurality of travelers. In one example, the partiality vector may have at least one of a magnitude and an angle that corresponds to a magnitude of the traveler's belief in an amount of good that comes from an order associated with that partiality. By another approach, the method 1900 may include, at step 1908, determining a rank for each of the set of partiality vectors. In one example, the rank may be based on a frequency distribution of the set of partiality vectors. By another approach, the method 1900 may include, at step 1910, selecting one or more partiality vectors of the set of partiality vectors based on the rank.

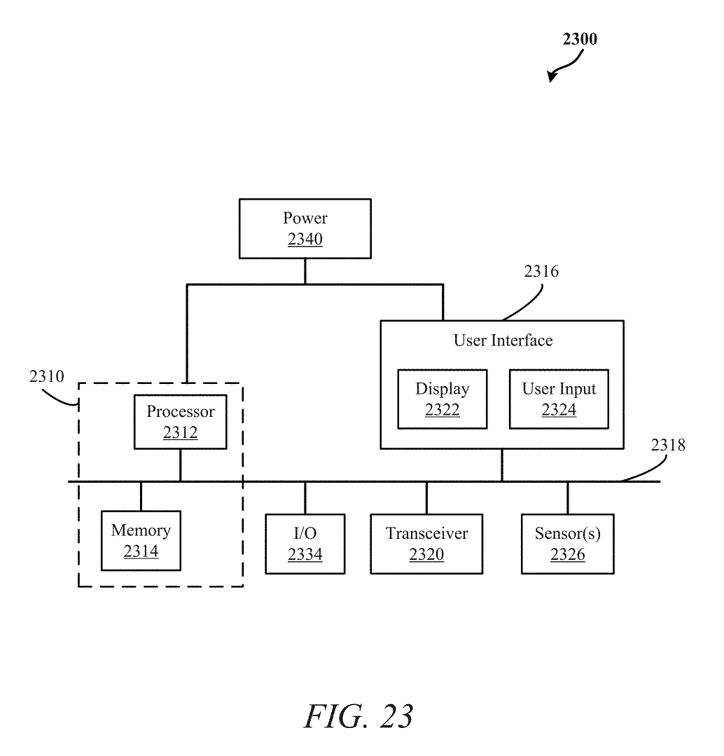

FIG. 20 illustrates a flow diagram of an exemplary method 2000 for customizing content of a billboard in accordance with some embodiments. The method 2000 may be implemented in the system 1800 of FIG. 18. By one approach, the method 2000 may be implemented in the selector control circuit 1802 or the billboard control circuit 1804 of FIG. 1. By another approach, one or more steps in the method 2000 may be implemented in the selector control circuit 1802 or the billboard control circuit 1804 of FIG. 1. By another approach, the method 2000 and/or one or more steps of the method may optionally be included in and/or performed in cooperation with the method 1900 of FIG. 19. The method 2000 may include, at step 2002, receiving a notification of the one or more selected partiality vectors. In one configuration, the method 2000 may include accessing a billboard content database to determine a content of a plurality of available contents, at step 2004. In one implementation, the content may be associated with at least one product having a particular vectorized characterizations in accordance with a threshold alignment of the one or more selected partiality vectors. In another configuration, the method 2000 may include, at step 2006, providing the content to a billboard interface associated with the particular geo-fence location. In another configuration, the method 2000 may include, at step 2008, increasing, each time the weighting value is assigned, a weighting value tracker corresponding to a billboard associated with the billboard interface. In one example, the weighting value tracker may indicates effectiveness of advertising on the billboard.

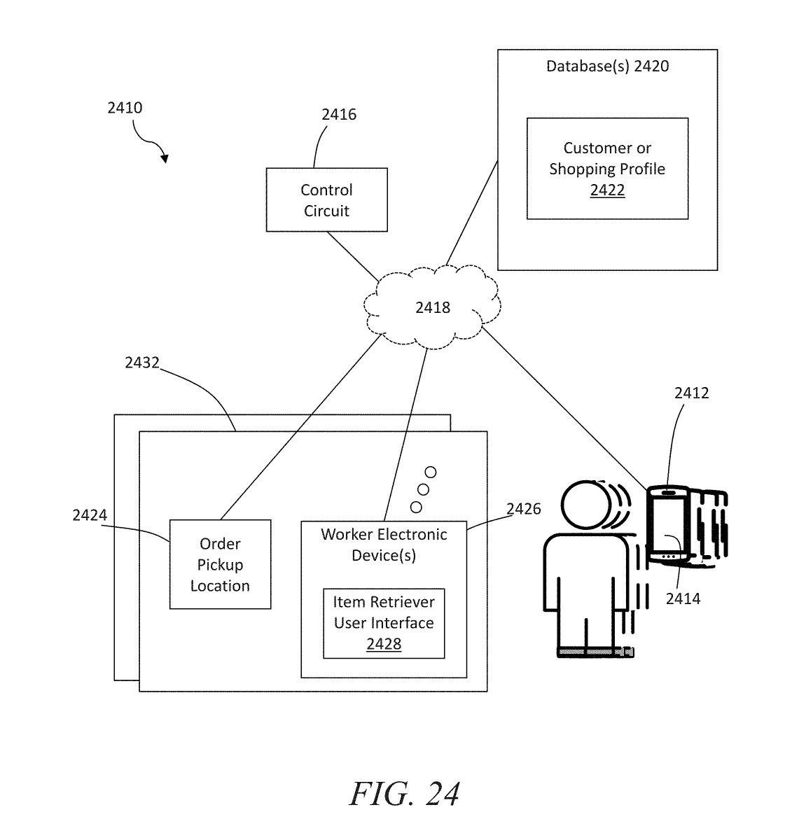

FIG. 21 illustrates a flow diagram of an exemplary method 2100 for customizing content of a billboard in accordance with some embodiments. The method 2100 may be implemented in the system 1800 of FIG. 18. By one approach, the method 2100 may be implemented in the selector control circuit 1802 or the billboard control circuit 1804 of FIG. 1. By another approach, one or more steps in the method 2100 may be implemented in the selector control circuit 1802 or the billboard control circuit 1804 of FIG. 1. By another approach, the method 2100 and/or one or more steps of the method may optionally be included in and/or performed in cooperation with the method 1900 of FIG. 19 and/or the method 2000 of FIG. 20. The method 2100 may include, at step 2102, comparing, at a first time, each of the one or more selected partiality vectors to each of the plurality of vectorized characterizations using vector dot product calculations to determine the content at the first time. By one approach, the method 2100 may include, at step 2104, determining whether particular purchase histories of the purchase histories is associated with at least one of: a product or a service associated with the content determined at the first time. In one example, the traveler data information may comprise purchase histories of the plurality of travelers. In such an approach, the method 2100 may include, in response to the determining that the particular purchase histories are associated with the content determined at the first time, assigning a weighting value to each of the one or more selected partiality vectors, at step 2106. In another configuration, the method 2100 may include, at step 2108, comparing, at a second time, each of the one or more selected partiality vectors having the assigned weighting value to each of the plurality of vectorized characterizations using the vector dot product calculations. In another configuration, the method 2100 may include, at step 2110, determining a second content based on the comparing at the second time. In another configuration, the method 2100 may include, at step 2112, providing the second content to the billboard interface.

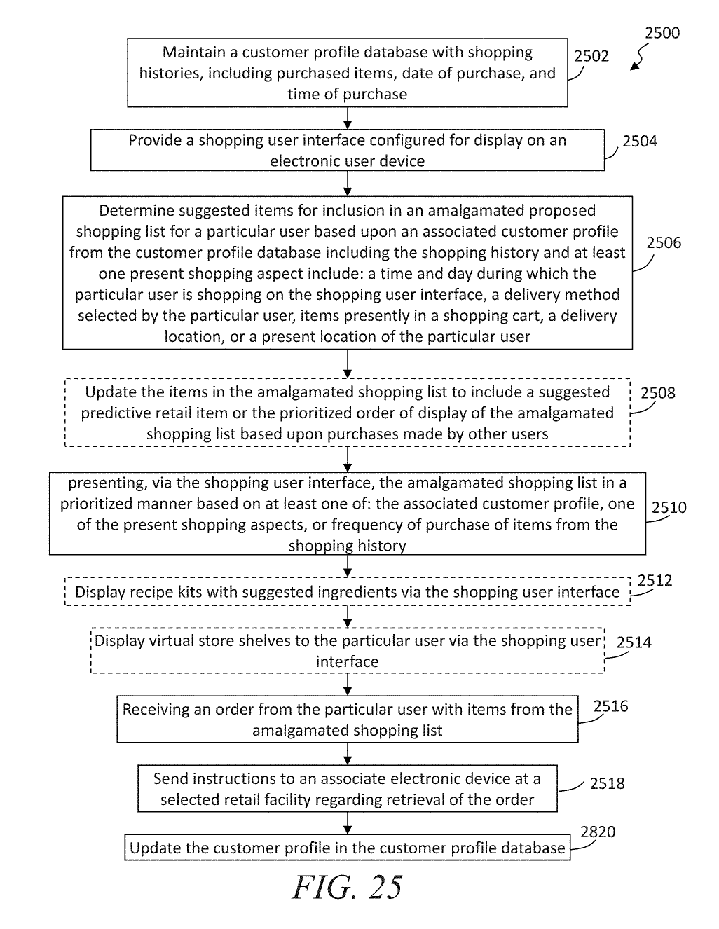

FIG. 22 illustrates a flow diagram of an exemplary method 2200 for customizing content of a billboard in accordance with some embodiments. The method 2200 may be implemented in the system 1800 of FIG. 18. By one approach, the method 2200 may be implemented in the selector control circuit 1802 or the billboard control circuit 1804 of FIG. 1. By another approach, one or more steps in the method 2200 may be implemented in the selector control circuit 1802 or the billboard control circuit 1804 of FIG. 1. By another approach, the method 2200 and/or one or more steps of the method may optionally be included in and/or performed in cooperation with the method 1900 of FIG. 19, the method 2000 of FIG. 20, and/or the method 2100 of FIG. 21. The method 2200 may include, at step 2202, assigning a weighting value to each of the one or more selected partiality vectors based on a determination that particular purchase histories of the plurality of travelers is associated with a previous content provided to a billboard associated with the billboard interface. In one example, the traveler data information may comprise the particular purchase histories. By another approach, the method 2200 may include, at step 2204, increasing a weighting value tracker corresponding to the billboard. In one implementation, the weighting value tracker may indicate effectiveness of advertising on the billboard. By another approach, the method 2200 may include, at step 2206, determining the frequency distribution of each partiality vector of the set of partiality vectors based on a number of travelers that are associated with each partiality vector of the set of partiality vectors. By another approach, the method 2200 may include, at step 2208, determining a percent distribution of each partiality vector of the set of partiality vectors based on the frequency distribution. By another approach, the method 2200 may include determining at least one particular partiality vector of the set of partiality vectors that has a particular percent distribution of the determined percent distribution, at step 2210. In one example, the particular percent distribution may comprise a percent value that may be equal to or greater than a second threshold. In another example, the determining of the rank may be based on the particular percent distribution.

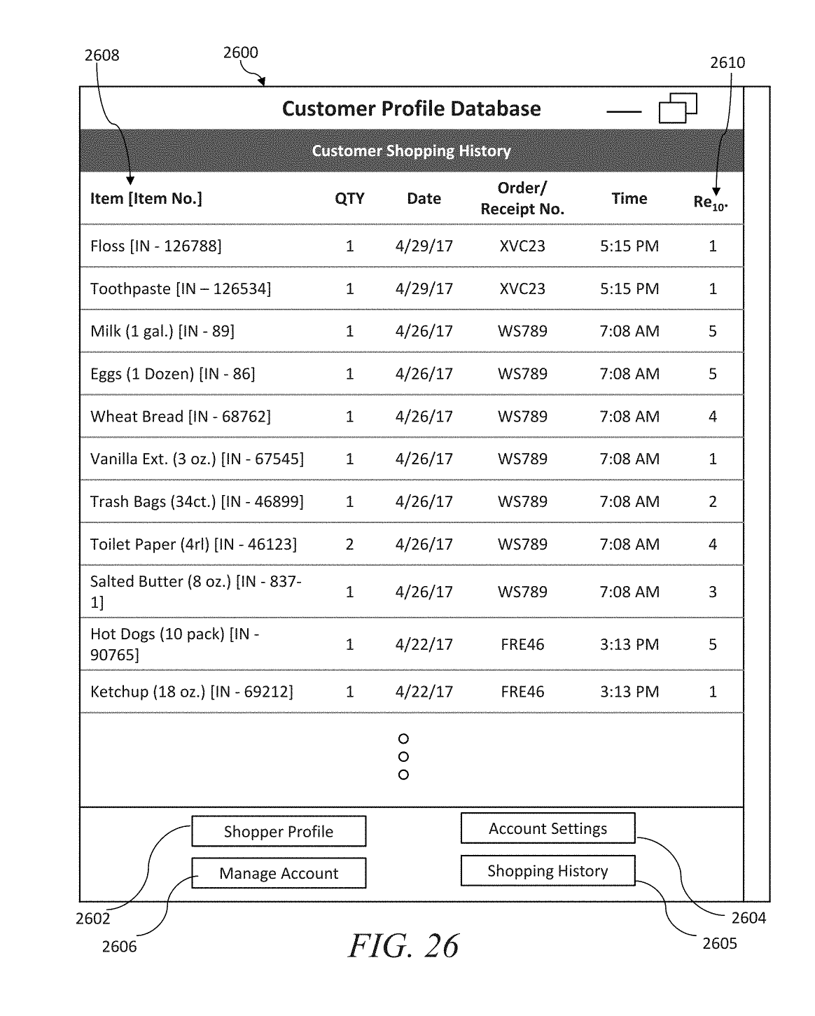

Further, the circuits, circuitry, systems, devices, processes, methods, techniques, functionality, services, servers, sources and the like described herein may be utilized, implemented and/or run on many different types of devices and/or systems. FIG. 23 illustrates an exemplary system 2300 that may be used for implementing any of the components, circuits, circuitry, systems, functionality, apparatuses, processes, or devices of the process 500 of FIG. 5, the process 900 of FIG. 9, the process 1000 of FIG. 10, the apparatus 1300 of FIG. 13, the process of FIG. 14, the approach 1600 of FIG. 16, the system 1800 of FIG. 18, the method 1900 of FIG. 19, the method 2000 of FIG. 20, the method 2100 of FIG. 21, the method 2200 of FIG. 22, and/or other above or below mentioned systems or devices, or parts of such circuits, circuitry, functionality, systems, apparatuses, processes, or devices. For example, the system 2300 may be used to implement some or all of the system 1800 for customizing content of a billboard, the selector control circuit 1802, the billboard control circuit 1804, the billboard content database 1808, the partiality vector database 1806, the billboard interface 1820, the communication network 1818, and/or other such components, circuitry, functionality and/or devices. However, the use of the system 2300 or any portion thereof is certainly not required.

By way of example, the system 2300 may comprise a processor module (or a control circuit) 2312, memory 2314, and one or more communication links, paths, buses or the like 2318. Some embodiments may include one or more user interfaces 2316, and/or one or more internal and/or external power sources or supplies 2340. The control circuit 2312 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 2312 can be part of control circuitry and/or a control system 2310, which may be implemented through one or more processors with access to one or more memory 2314 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 2300 may be used to implement one or more of the above or below, or parts of, components, circuits, systems, processes and the like. For example, the system 2300 may implement the system 1800 for customizing content of a billboard with the selector control circuit 1802 and/or the billboard control circuit 1804 being the control circuit 2312.

The user interface 2316 can allow a user to interact with the system 2300 and receive information through the system. In some instances, the user interface 2316 includes a display 2322 and/or one or more user inputs 2324, such as buttons, touch screen, track ball, keyboard, mouse, etc., which can be part of or wired or wirelessly coupled with the system 2300. Typically, the system 2300 further includes one or more communication interfaces, ports, transceivers 2320 and the like allowing the system 2300 to communicate over a communication bus, a distributed computer and/or communication network (e.g., a local area network (LAN), the Internet, wide area network (WAN), etc.), communication link 2318, other networks or communication channels with other devices and/or other such communications or combination of two or more of such communication methods. Further the transceiver 2320 can be configured for wired, wireless, optical, fiber optical cable, satellite, or other such communication configurations or combinations of two or more of such communications. Some embodiments include one or more input/output (I/O) interface 2334 that allow one or more devices to couple with the system 2300. The I/O interface can be substantially any relevant port or combinations of ports, such as but not limited to USB, Ethernet, or other such ports. The I/O interface 2334 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 2326 to provide information to the system and/or sensor information that is communicated to another component, such as the selector control circuit 1802, the billboard control circuit 1804, the billboard interface 1820, the billboard content database 1808, the partiality vector database 1806, the billboard 1810, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 2300 comprises an example of a control and/or processor-based system with the control circuit 2312. Again, the control circuit 2312 can be implemented through one or more processors, controllers, central processing units, logic, software and the like. Further, in some implementations the control circuit 2312 may provide multiprocessor functionality.

The memory 2314, which can be accessed by the control circuit 2312, typically includes one or more processor readable and/or computer readable media accessed by at least the control circuit 2312, and can include volatile and/or nonvolatile media, such as RAM, ROM, EEPROM, flash memory and/or other memory technology. Further, the memory 2314 is shown as internal to the control system 2310; however, the memory 2314 can be internal, external or a combination of internal and external memory. Similarly, some or all of the memory 2314 can be internal, external or a combination of internal and external memory of the control circuit 2312. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 2314 can store code, software, executables, scripts, data, content, lists, programming, programs, log or history data, user information, customer information, product information, and the like. While FIG. 23 illustrates the various components being coupled together via a bus, it is understood that the various components may actually be coupled to the control circuit and/or one or more other components directly.

To improve the shopping experience for customers, a variety of in-store and remote shopping paradigms and methods have been developed. For example, some retailers have mobile applications operable on customers' mobile electronic devices. Further, some of these provide customers options for delivery of the ordered goods. Many of these do not provide the ease of experience and quickness that customers desire, thereby leading to decreased customer satisfaction and, ultimately, less engagement or shopping. Thus, there is a need to improve the shopping experience so that customers may shop remotely from the physical retail facility in an expedient manner.

To improve the shopping experience for customers, a variety of in-store and remote shopping paradigms and methods have been developed. For example, some retailers have mobile applications operable on customers' mobile electronic devices. Further, some of these provide customers options for delivery of the ordered goods. Many of these do not provide the ease of experience and quickness that customers desire, thereby leading to decreased customer satisfaction and, ultimately, less engagement or shopping. Thus, there is a need to improve the shopping experience so that customers may shop remotely from the physical retail facility in an expedient manner.

Generally speaking, pursuant to various embodiments, systems, apparatuses, and methods are provided herein useful to provide a manner of streamlining remote selection or ordering of products, such as, for example, via a mobile application or app that presents an auto-generated amalgamated proposed shopping list or proposed shopping cart. In this manner, a customer may use the shopping system to accept items for purchase quickly and easily.

Many customers are interested in streamlining their to-do lists and are interested in remote or mobile shopping options. Many shoppers find it quicker to swing into a local store to pick up items they routinely purchase because they know where the items are located in their local store and the exact items they wish to purchase, as opposed to taking the time to search for and order the products online, especially if they are concerned that the exact items of interest may not be quickly located. The shopping system described herein reduces the time, effort, and frustration attendant many remote shopping applications. Further, these teachings may be employed for delivery or pick-up of a retail order.

Accordingly, to provide the customers an easily identifiable list of products likely to be purchased at a given time and/or location, the shopping system generates or identifies items or products for inclusion in an amalgamated shopping list and then presents the products in a particular manner, such as by presenting them in a manner of corresponding to the likelihood of customer interest or based on the particular customer priorities. Some predictive shopping systems remind a shopper of items to purchase and allow the shopper to modify the presented shopping list on their computing devices. See, e.g., U.S. application Ser. No. 15/453,003 filed Mar. 8, 2017 (attorney docket no. WMT-139 (1249US02), which is incorporated herein by reference in its entirety. In addition to identifying items for inclusion in the amalgamated shopping list, the present teachings also display the amalgamated shopping list in a prioritized manner based on different shopping aspects, such as, for example, the date or time of day. This is particularly helpful for certain shopping paradigms, such as grocery shopping, where the particular user may have recently purchased hundreds (or even thousands) of items from the store. For example, if the system is designed to present the items purchased in the last ten orders and this includes four hundred items, these items will be presented in a prioritized manner so that the user may focus on the items most likely to be of interest when submitting a subsequent remote order.

As discussed further below, the present teachings also may identify predictive suggestions for the shopping list based on other customers' behaviors. Accordingly, the predictive items in the amalgamated shopping list can be located based on the customer's shopping history (such as, for example, the items from the shopper's previous ten purchases or orders) and also located based on other customer's present shopping behaviors (such as, for example, suggesting an item that a large majority of other shoppers are purchasing or a certain percentage of shoppers in a given geographic area). In some configurations, the pool of other customers being analyzed for predictive suggestions may be narrowed to include only customers with at least somewhat aligned value vectors or other similarities.

In one illustrative configuration, an amalgamated grocery or shopping list for a particular customer will include the purchases made during the customer's previous X number of store visits or orders (such as, for example, the last ten purchases). The customer or user can then scroll through the amalgamated list and click or swipe at items to accept them for purchase or to add them into the cart, which is then electronically transmitted to a retail facility for fulfillment. In some embodiments, the electronic shopping cart may be reviewed and the order confirmed before submission thereof. The items on the amalgamated shopping list typically remain thereon until a user has manually removed them from the list or the set number of purchases, orders, or visits (e.g., ten previous purchases) has passed without purchasing the item. For example, if a customer regularly buys a particular breakfast cereal every third visit to the grocery store (and the system only removes items from the amalgamated list after ten purchases, orders, or visits without purchase), that particular breakfast cereal (including the preferred flavor, size, etc.) will typically remain on the amalgamated list unless manually removed therefrom, whereas if the customer has only purchased a fresh pineapple once, the fresh pineapple will be removed from the amalgamated list after the set number of purchases, orders, or visits, i.e., ten in this example.

In one aspect, the quantity of items from the amalgamated list that are put into the user's electronic cart are determined by the number of swipes or clicks. For example, if the user needs three boxes of their preferred breakfast cereal, the user can tap or swipe at the associated icon on the list three times to get three boxes of their preferred cereal into the order, electronic cart, or basket. In one illustrative approach, the amalgamated list is prioritized, such as, for example, prioritized such that the most frequently purchased items are found at the top or beginning of the list or by putting the items most likely to be purchased at the date and/or time of the order at the top of the amalgamated list. By way of example, if the customer is submitting an order on Saturday morning for pick up at their local store, the system, in one illustrative configuration, may recognize that this particular customer typically purchases eggs and orange juice at that time and those items may be placed at the top of the amalgamated grocery list because they are purchased whenever the customer purchases groceries on Saturday morning.

In addition, the electronic shopping application also may provide predictive suggestions or recommendations to the user, such as, by including these predictive suggestions in the amalgamated shopping list. For example, around the holidays, the predictive list may recommend cultural and/or seasonal items, such as a whole turkey just before the thanksgiving holiday or hot dogs around summer holidays. The control circuit and/or the electronic shopping application also may analyze shopping patterns or other items in the customer's cart to recommend or provide predictive suggestions. In another example, the user can be provided an alternative item that is likely of interest in the amalgamated shopping list (e.g., if the user typically purchases low sodium items and a new low sodium pasta sauce is now being offered from the brand the user typically purchases). In one configuration, the alternative item is presented in a different or special manner (e.g., in a different font or color) to indicate that it is a suggested, alternative item that has not been previously purchased, but in which the user may be interested based on the customer's profile.

In another illustrative configuration, the electronic shopping application also provides a recipe grocery shopping list or kit. By one approach, the customer may click or select a recipe icon and a recipe kit with most or all of the items needed to make the recipe are added to the customer's cart, as opposed to having to add each of the items individually. Further, when the customer has added a recipe kit or recipe shopping list into their cart, a copy of the recipe may be included with the grocery order. For example, the store associate may pack a copy of the recipe when the associate packs the grocery items.

In some embodiments, the electronic shopping application displays a representation of the store layout, which may be manipulable and/or expandable so that customers can view and/or scroll through virtual shelves that illustrate or provide all of the available grocery items in a location searchable manner. By one approach, the electronic shopping application permits the user to select one of the virtual shelves for further, more detailed viewing. Similarly, the electronic shopping application also may include a map of the store, which may permit the user to select an aisle for further viewing or an inventory listing. Additionally, a customer may select an item and click on a map adjacent thereto to provide information on the location of the particular item in a physical retail store. For example, if the customer selects or taps on their favorite breakfast cereal, a map icon may be selectable adjacent the cereal that will present the store aisle and shelf location where the cereal is found at the store. This may be of particular interest for customers who are typically accustomated to purchasing items in a particular location of a retail store.

In some embodiments, the electronic cart or basket is reviewed by the user before submission of the order to the retail facility. Along with the items in the electronic cart or basket, the user typically selects a pick-up time and location (or delivery location and shipping carrier or speed) and provides other, identifying information. Upon submission of the order, workers at the retail facility can retrieve or collect the grocery items ordered and pack them for pick-up or delivery to the customer. In this manner, the customer need only come to the store to pick up the selected grocery items (or receive them at their shipping address if delivered). In some configurations, the order may be retrieved while the customer remains in their vehicle. For example, the order may be delivered to the customer's car at the retail facility (in such configurations, vehicle identifying information may be submitted during order submission) or the retail facility may have a drive through window through which orders can be transferred.

As noted above, the items in an amalgamated grocery shopping list will be presented in a manner tailored to the particular customer and the time of day and/or year of the display. In this manner, the list attempts to present the items likely to be of interest to a particular customer at the top of that customer's electronic shopping list in the mobile shopping application. In this manner, the system looks at priorities associated with the various items to be included in the shopping list. These priorities and rules may include: frequency of purchasing; day of the week; time of day and/or year when shopping; where the purchases are to be made and received (location, such as, e.g., home, work or store); where or how the products are to be delivered or otherwise accessed (e.g., pick up at the store, aerial drone delivery, terrestrial drone delivery, traditional delivery, USPS, or third party); and the customer's geographic location. Additionally, the order of presentation of the shopping list can be adjusted depending on the customer's value vectors discussed below. Once the system has analyzed the assigned priorities of the shopping list items based on the above considerations, the system will present the amalgamated list of recently purchased items (and potentially the suggested items) identified for presentation in a prioritized manner.

In one illustrative configuration, the shopping system includes a selection user interface that receives selections of proposed or suggested items for purchase from the amalgamated proposed shopping list for that particular user, a database of shopping profiles with shopping histories (e.g., items purchased, dates of purchase, and purchase time of day), and a control circuit in communication with the database and the electronic user devices. In one illustrative approach, the control circuit is configured to determine the proposed cart items or suggested items for inclusion in the amalgamated proposed shopping list for the particular user (where the suggested items include previously purchased items that were purchased within a previous predetermined number of visits, purchases, or orders or within a previous predetermined period of time and predictive suggestions), present (via the shopper selection user interface) the amalgamated proposed shopping list to the particular user based on a set of priorities (which are typically assigned based on a frequency of purchase of the previously purchased items and at least one of a time of day or time of year), receive the suggested item selections for purchase or inclusion in an electronic shopping cart, and send instructions to an associate electronic device at a retail facility to retrieve the selected or purchased items in the electronic shopping cart prior to arrival of the particular user at the retail facility for pickup thereof.

In some embodiments, the database of shopping profiles includes value vector details and these may be updated after additional purchases or upon other, additional shopping events (e.g., product return or order cancellation). By one approach, the control circuit updates the shopping history of the user with the suggested items subsequently purchased by the user. In some configurations, the shopping profiles in the database also include a location of item purchase, a location of item delivery, and/or a manner of delivery. Accordingly, the control circuit may further analyze the location of item purchase, the location of item delivery, and/or the manner of delivery to update the assigned set of priorities and any amalgamated proposed shopping lists associated therewith.

In operation, these teachings reduce the time and effort required to order items by analyzing the customer's shopping profile and details of the current shopping session or order (e.g., date, time, manner of delivery, etc.) to provide an amalgamated proposed shopping list or proposed shopping cart that is displayed in a manner that includes and prominently displays items of particular interest at the time or according to the customer's priorities. The shopping system described herein permits the user to quickly order items (including reordering items previously ordered), but does not require a subscription or a regularly scheduled order. As noted above, the suggested items typically include previously purchased items and predictive suggestions, which the system believes the customer is likely to be interested in purchasing based on a number of factors.

By one approach, the predictive suggestion(s) are based, in part, on the day of the week, time of the year or day, and/or the recent purchases of other shoppers, among other aspects. For example, the predictive suggestions may include a seasonal item, items purchased by shoppers having a similar shopping profile to the particular user (such as, for example, those having value vectors aligned with the user), items purchased by a certain percentage of other shoppers (such as other mobile shoppers or all shoppers within a particular window of time), items frequently purchased by other mobile shoppers, or alternative suggested items (such as updated or recently released products). In one illustrative example, the alternative suggested item is similar to a previously purchased item such that it has a corresponding product profile or aligning value vectors with item(s) in the shopping history, in the electronic shopping cart, or a selected suggested item.

In one illustrative approach, the shopping system may provide or display recipe kits for purchase on the selection user interface. By one approach, the recipe kits include the items for making the recipe and these items can be added to the cart or confirmed purchase in the electronic shopping cart by clicking or selecting the recipe. When a user selects one of the recipe kits, the ingredients necessary for making the recipes (or the ingredients beyond basic pantry staples) will be automatically added to the user's electronic shopping cart. In addition to displaying the recipe kits (and possibly the ingredients contained with the kit), the selection user interface also may display optional add-on items that complement the basic recipe. In this manner, both the recipe items and the additional items can be quickly added to the electronic shopping cart. By way of example, the selection user interface may have a link or an icon denoting recipe kits that may include, for example, a “pasta night kit” and/or a “pancake kit,” among a myriad of other options. The pasta night kit may include noodles, sauce, and meatballs and may have garlic bread as an add-on button.

In another configuration, the selection user interface provides a magnifying or expander feature that permits the particular user to tap and hold on at least one suggested item to view related items or additional information on the at least one suggested item. This permits the user to quickly locate additional information about the product, such as a product recently purchased, to locate alternative options or additional information.

In some embodiments, the selection user interface is further configured to display virtual store shelves with retail products that the particular user may select for addition to the electronic shopping cart. In one illustrative configuration, the store shelves are depicted in a scrollable display resembling a particular selected retail facility such that the user can scroll through the store shelves in the order found in the selected facility. The user may then click or otherwise select a store shelf of interest for further examination thereof. In such a scrollable display, the user may click or expand the shelf such that the user may then see the particular items located on the store shelf. While the user may scroll between shelves, the length of a specific shelf also may be scrollable. In one example, a user may view nearly the length of a selected shelf in lower resolution, but may select or expand a portion of the shelf to provide additional information or a better quality image of that portion of the shelf. In a similar manner, the selection user interface may display a store map that is selectable by area or department to thereby provide information on product location in a physical retail store. For example, the map may have six departments that are selectable and once one of these departments, such as the produce department, is selected, the map may zoom into this area of the store and then provide other selectable areas or categories.

As suggested above, the electronic shopping interface or application is designed for quick and easy shopping by a user. When the application is opened, the selection user interface may display the amalgamated shopping list on an opening or landing page for immediate consideration by the user. Once the user has selected or accept the items for purchase, the system may permit the user to review the shopping cart or items before purchase, if desired. Accordingly, the selection user interface is configured to present the electronic shopping cart and the selected items therein prior to submission of the electronic shopping cart to the retail facility for delivery or preparation for pick-up.

Further, in operation, the selection user interface is configured to receive transaction information including payment information, a retrieval location, and a retrieval time (or delivery method and location) from the user with their order. This additional information may be provided when an account is set up and/or when an order or purchase is submitted.

As noted above, these teachings may be employed for delivery or pick-up of a retail order. Once the user submits an order, it is generally transmitted from the control circuit to a retail facility, such as a store or a distribution center. At that time, a worker or an associate at the retail facility may be tasked with procuring or retrieving items from the facility shelves. By one approach, the shopping system includes an item retriever user interface operable on an associate electronic device. Specifically, the associate electronic device may include an item retriever user interface configured to display multiple orders stored in the database. Further, in one illustrative approach, the item retriever user interface is configured to display the items in the order and provide instructions to the associate regarding efficient retrieval of the ordered items, such as, for example, grouping items by location for fastest order fulfillment.

In some configurations, the selection user interface and/or the item retriever user interface are provided to the electronic user devices by the control circuit. In other configurations, the selection user interface and/or the item retriever user interface are configured to be executed by the electronic user devices when in communication with the central computer.

In operation, the mobile application that presents an auto-generated amalgamated proposed shopping list or cart allows a shopper to easily and quickly shop for items of interest that are curated based on the individual shopper, day of the week, the time of day, week, or year, along with other aspects, such as for example, the shopping behaviors of other shoppers. In one exemplary approach, the shopping system includes a selection user interface that displays an amalgamated proposed shopping list for a particular user and receives a selection from the list, a database of shopping profiles with shopping histories including items purchased, dates of purchase, and purchase time of day, and a control circuit in communication with the database and the electronic user devices. By one approach, the control circuit is configured to obtain a first set of rules that identify a suggested product for inclusion in the amalgamated proposed shopping list for the particular user as a function of prior purchase, obtain a second set of rules that identify another suggested product for inclusion in the amalgamated proposed shopping list for the particular user as a function of predictive correlation that identifies predictive suggestions (where the predictive correlation is based, in part, on the shopping profile of the particular user having value vector characteristics similar to particular product profiles), determine items to include in the amalgamated proposed shopping list for a particular user based on the first and second set of rules, obtain a third set of rules that identify a presentation ordering of the suggested products in the amalgamated proposed shopping list for the particular user as a function of a frequency of items purchased by the particular user, frequency of items purchased by other shoppers and at least one of a day of the week, time of day or time of year, and receive at least one of the requested selected items for inclusion in an electronic shopping cart. Further, in such a confirmation, the control circuit also is configured to send instructions to an associate electronic device at a retail facility regarding gathering the requested selected items prior to the particular customer's arrival at the retail facility for pickup thereof (or prior to expected delivery thereof).

In operation, the mobile application is usable to permit the user to receive a personalized shopping list that is presented based on a number of shopping aspects. As noted above, the order can be picked up by the shopper or delivered to a selected address. By one approach, a method of providing a proposed shopping cart or suggested shopping list includes, for example, maintaining a customer profile database with shopping history stored therein (including purchased items, date of purchase, and time of purchase), providing a shopping user interface configured to be displayed on an electronic user device, determining suggested items for inclusion in an amalgamated proposed shopping list for a particular user based upon an associated customer profile from the customer profile database including the shopping history and at least one present shopping aspect (such as, for example, the shopping time and day, a delivery method selected by the particular user, items presently in a shopping cart, a delivery method, and/or a present location of the particular user), presenting the amalgamated shopping list in a prioritized manner (which may be based on the associated customer profile, one of the present shopping aspects, and/or frequency of purchase of items from the shopping history), and receiving an order from the particular user with items from the amalgamated shopping list.

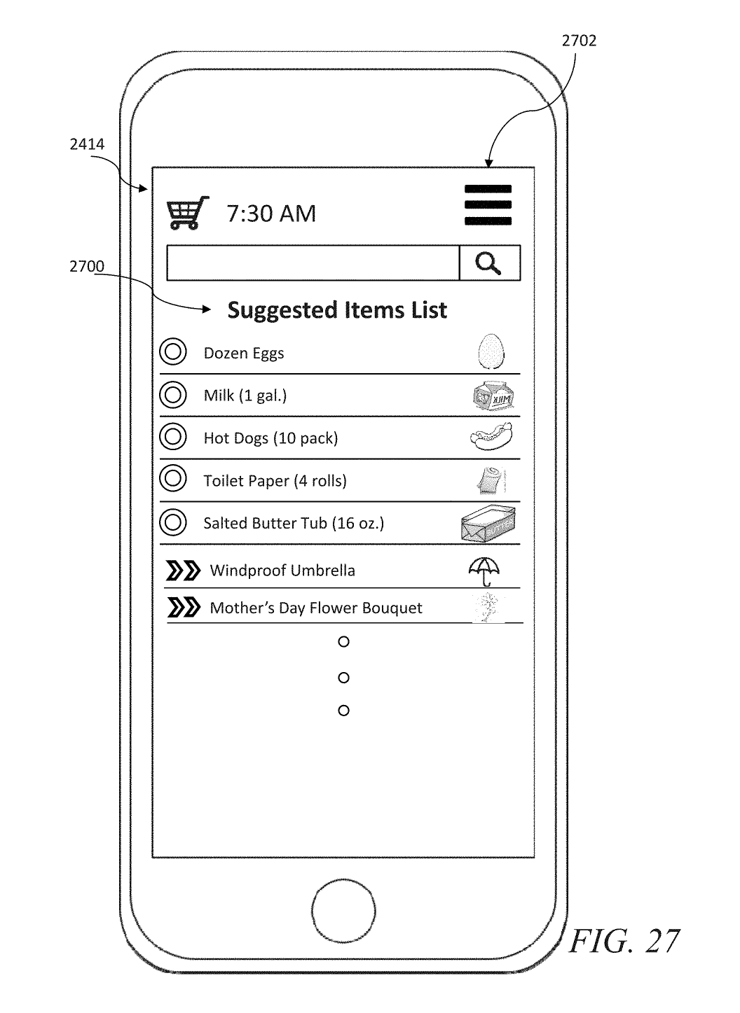

These teachings may be configured to provide an electronic user interface such that shoppers can quickly order suggested items presented based on the user's profile (including the user's preferences or values) and shopping aspects, such as the date and time of the order. FIG. 24 illustrates an exemplary shopping system 2410 configured to utilize the preferences or value vectors associated with a shopping or customer profile 2422, which is stored in one or more databases 2420. In some embodiments, the shopping system 2410 also includes one or more electronic user devices 2412 with selection user interfaces 2414 associated therewith, a control circuit 2416, and worker electronic devices 2426 with item retriever user interfaces 2428 associated therewith.

The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art. The control circuit 2416 may be configured (for example, by using corresponding programming stored in a memory as will be well understood by those skilled in the art) to carry out one or more of the steps, actions, and/or functions described herein. The methods, techniques, systems, devices, services, servers, sources and the like described herein may be utilized, implemented and/or run on many different types of devices and/or systems.

As illustrated in FIG. 24, the various components or devices of system 2410 may communicate directly or indirectly, such as over one or more distributed communication networks, such as network 2418, which may include, for example, LAN, WAN, Internet, cellular, Wi-Fi, and other such communication networks or combinations of two or more of such networks.

The illustrative shopping system 2410 streamlines remote shopping by suggesting items for an order or pre-filling an electronic shopping cart for the customer. In operation, the control circuit and selection use interface 2414 typically present an updated or current amalgamated proposed shopping list with suggested items for an order at each shopping or browsing session (or at least analyze the customer profile 2422 and the shopping aspects at each shopping session). For example, the items in the amalgamated proposed shopping list or the prioritized display of the items in the amalgamated proposed shopping list may be updated based on, for example, the time of day. As noted above, the suggest items are included in the amalgamated proposed shopping list based on previous shopping behaviors, various aspects of the shopping session (such as the day of the week, time of day or time of year, etc.), and the present shopping behaviors of other remote or in-store shoppers. These aspects also may impact which items are included in the amalgamated proposed shopping list.

Providing a prioritized, amalgamated proposed shopping list in the manner described herein, reduces the time required for remote shoppers to quickly select items and submit an order. Alternatively, if a remote shopper were to telephone a store to submit an order for pick-up, the shopper would need to verbally identify each of the items they wish to purchase, which typically take significant time as many products come in a variety of sizes, flavors, etc. Further, the store would be required to have a substantial workforce to accept and process the call-in orders. Also, store clerks typically don't have sufficient information about each caller to quickly suggest items that the shopper typically purchases or information about the shopping behaviors of other shoppers. The systems described herein also reduce the chances that a customer will forget items when shopping remotely because they are not receiving the visual cues that serve as reminders for certain purchases, such as, for example, by walking past the dairy aisle if the customer needs milk.

In addition, while some available shopping applications permit a shopper to reorder previous orders, sign up for a product subscription, or schedule regular product delivery, none of these available offerings generate a prioritized, amalgamated proposed shopping list or suggested shopping cart that is based on the shopping behaviors (of the user and/or other shoppers) and shopping session aspects, as noted above. Further, available shopping applications that provide subscriptions or the like do not fully account for the varied consumption levels of customers.

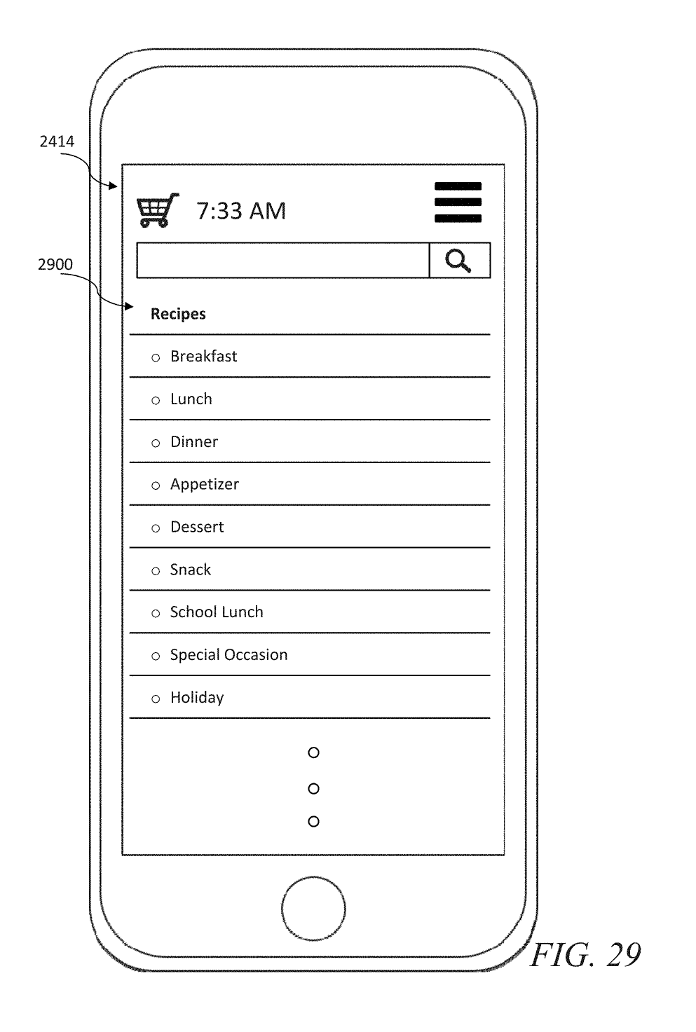

To provide the prioritized, amalgamated shopping list or cart that is customized for each remote shopper at each shopping session, the illustrative shopping system 2410 stores shopping or customer profiles 2422 associated with each of the particular users of the shopping application. The customer profiles 2422 are updated upon submission of new remote orders or in-store purchases at a physical retail shopping facility. FIG. 26 depicts a partial, illustrative screen shot 2600 showing a portion of the customer shopping history of a customer profile. The customer profile 2422 may further include, for example, a shopper profile tab 2602 that includes personal information about the customer and may include details of the user's preferences and value vectors, an account settings tab 2604, a manage account tab 2606, and a shopping history tab 2605, among other information. FIG. 26 illustrates information that may be cataloged in the shopping history tab 2605. Once a user selects another of the tabs (e.g., the shopper profile tab 2602, the account settings tab 2604, or the manage account tab 2606), information pertaining to those aspects will be viewable.

In one illustrative approach, the shopping history tab 2605 may include a listing of products (and/or services) purchased and/or ordered by the customer. The example item listing 2608 in FIG. 26 illustrates the items purchased (by name and item number), the quantity purchased, the order or receipt reference number, the date of purchase, time of purchase, and the number of times the item has purchased in the last ten visits, illustrated at the column header as Re₁₀ 2610. While the frequency or recurrence of the item purchase within the last ten purchases or orders is tracked in this example, the system may be configured to track purchase frequency over a longer or shorter period, such as the last 20 purchases or last 8 purchases.

In some approaches, the system 2410 includes items purchased within a previous predetermined number of orders or visits (such as ten) in the amalgamated proposed shopping list. In other approaches, the system 2410 includes the items purchased within a previous predetermined period of time, such as ten weeks. In such a configuration, the Re₁₀ 2610 would denote the frequency or recurrence of item purchase within the last ten weeks.

The information in the customer profile 2422 may be used in a variety of manners, such as, for example, by the control circuit 2416 and the user interface 2414 to determine which items to include and how to present the items in an amalgamated proposed shopping list for the particular customer. By one approach, the amalgamated proposed shopping list includes items that were previously purchased within the last ten purchases. Further, the system 2410 also may analyze and adjust the priorities of purchases (to impact the order of presentation) based on frequency of purchase such that the most frequently purchased items are weighted and displayed most prominently in the amalgamated shopping list, such as, for example, at the top of the proposed shopping list. In addition to frequency, the proposed shopping list may be prioritized by other factors, such as, for example, the time or date of the shopping session. In this manner, if the system 2410 determines that the purchases regularly differ based on date or time, the assigned priorities of the items in the list may be adjusted based on the date or time of the present shopping session. Accordingly, if purchases made on Tuesday afternoon typically include cleaning supplies, the system 2410 may adjust the assigned priorities of the items in the amalgamated proposed shopping list to more heavily weight the cleaning supplies if the user is remotely shopping on Tuesday afternoon so that the cleaning supplies are prominently displayed in the prioritized shopping list. Other aspects or factors that may impact the assigned priorities include the location of purchase, delivery method, and/or delivery location. Accordingly, the priority of items in the proposed shopping list may be changed to move the items previously delivered, purchased, and/or received in the same manner, time, and/or location as the present selections to a more prominent location in the list. In short, the shopping aspects may be analyzed so that items ordered under circumstances similar to aspects of the present shopping session are more prominently displayed in the prioritized amalgamated shopping list. By analyzing the patterns of purchases or orders, the system presents a proposed shopping list to customers that accounts for the particular customer's shopping habits.

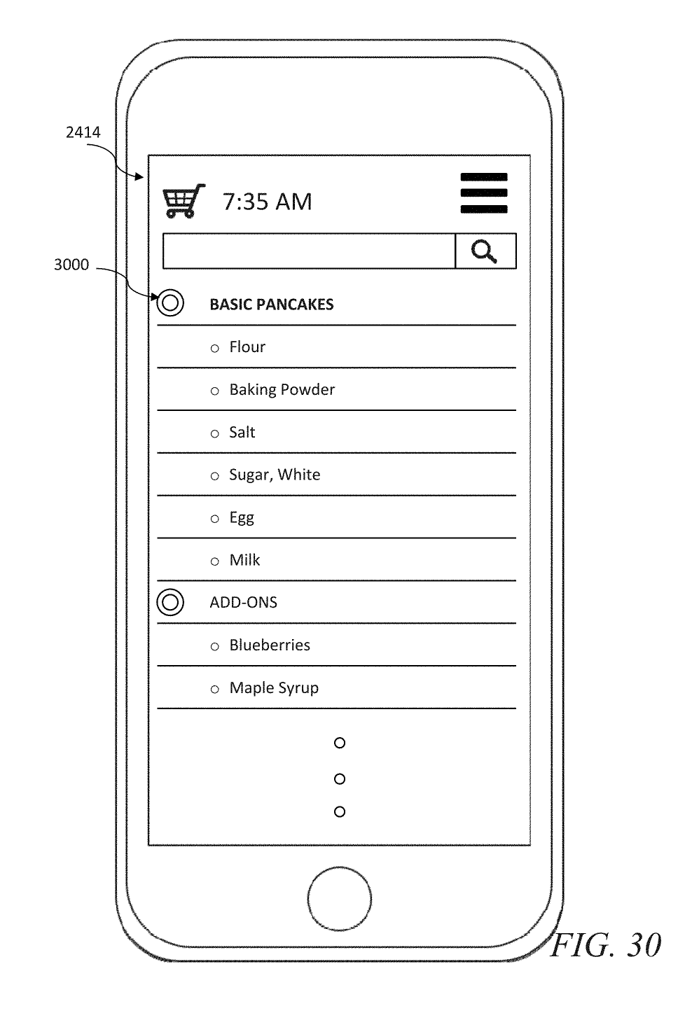

As noted above, the information in a user's customer profile 2422 is used to determine the suggested items in the associated user's amalgamated proposed shopping list that is displayed or presented to the particular user via the selection user interface 2414. The customer profile 2422 also may be analyzed to determine the prioritized order of display of the suggested items. FIG. 27 shows a screen shot 2702 of an illustrative selection user interface 2414 displaying an amalgamated proposed shopping list or suggested item list 2700. The exemplary screen shot 2702 displaying the suggested items list 2700 on the user interface 2414 may be presented to the particular user having the customer profile illustrated, in part, in FIG. 26.

In the illustrated suggested items list 2700, the top of the list includes a dozen eggs and a gallon of milk, followed by hot dogs. In the shopping history of FIG. 26, these items have all been purchased five times in the last ten orders. Thus, the shopping system 2410 has weighted the priorities of those three items above the remainder of the purchased items or suggested items. Further, the shopping system 2410 has displayed the eggs and milk above the hot dogs, as those have been more recently purchased, as shown in FIG. 26. Thus, the exemplary suggested items list 2700 displays previously purchased items based on assigned priorities corresponding to frequency of purchase and date of purchase.

In another configuration, the rules for assigned priorities may result in a differently ordered list of suggested items. For example, since the particular user appears to be shopping at 7:30 am, per the clock on the user interface 2414 of FIG. 27, the suggested items list 2700, may determine that the time of the order closely matches the time of the previous order on Apr. 26, 2017, i.e., 7:08 am, such that the wheat bread (which has been purchased four times in the last ten orders) should be displayed before the hot dogs (which were purchased at 3:13 pm previously). For example, if the order time is within a certain window of time, such as 45 minutes, of previous orders, the system 2410 may weight those priorities above the frequency. In addition, the customer profile 2422 may further indicate that every Saturday morning order during the 7 o'clock hour includes milk, eggs, and wheat bread, and therefore, the system 2410 may put these items at the top of the suggested items list in some configurations. In yet another configuration, the system 2410 may load those three items into a proposed shopping cart such that the user merely needs to select submit order to purchase those items for delivery. Such a proposed shopping cart may be edited to include additional items or remove those the user does not wish to purchase.

Returning to FIG. 27, the suggested items list 2700 includes two items not included in the screen shot of the customer shopping history in FIG. 26. Instead of previous purchases, these are predictive purchases. The predictive purchase suggestions may be highlighted or otherwise differentiated so the user understands that these were not previously purchased. As illustrated in FIG. 27, these predictive purchases are set off by a set of double arrows so that the user knows these were not previously purchased, but instead, that the system 2410 believes the user may be highly interested in purchasing these items based on factors outside of their purchase history. For example, the system 2410 may analyze the purchases of other remote shoppers in a geographic area (such as by analyzing the zip code of the delivery location) and may determine that a certain percentage of shoppers are ordering umbrellas. Thus, the system 2410 may present this as a predictive suggest to the user on their associated user interface 2414. By way of an occasional or seasonal example, the system 2410 may suggest a Mother's Day flower bouquet to the user on the second Sunday in May. This suggestion may be based on the shopping behaviors of other shoppers or by the system 2410 analyzing the user's previous year's purchases on or shortly before the holiday. In this manner, the system 2410 may populate the amalgamated proposed shopping list with seasonal items purchased during previous seasons, even though the user has not purchased those items recently, such as, for example, in the last ten visits.

Predictive purchases also may be determined based on changes in inventory, such as the result of a newly released product (possible one with value vectors that align with the value vectors of the particular user) or seasonal items determined based on the time of the year. In yet other configurations, the shopping system 2410 may recommend items as predictive items that fit a core value of a user (as captured in a value vector) better than a previously purchased items that may be on the amalgamated proposed shopping list. By one approach, this predictive item is displayed adjacent the previously purchased items. For example, icons depicting the two items may be disposed adjacent one another with the predicative item shaded or otherwise denoted as alternative to previously the purchased item.

By one approach, the quantity of items from the amalgamated shopping list that are added to the user's electronic shopping cart are determined by the number of swipes or clicks on the item. For example, if the user needs three dozen eggs in this particular order, the user can tap or swipe at the listing for a dozen eggs or an egg icon three times to get three dozen eggs added into the electronic shopping cart of basket. For example, in FIG. 27, while the user may select the radial button on the left of the suggested items list for a single order, the user may tap on the icon on the right-hand portion of the screen to add the tapped number of each of the items into the electronic shopping cart. In this manner, if the user needs three dozen eggs, they can tap on the egg icon to the right of the written description three times to add the three dozen eggs into their cart.

FIG. 28 illustrates the electronic user interface 2414 with a screen shot 2800 of scrollable, virtual store shelves. As shown, the virtual shelves have sections numbers and pictorial depictions of the items located in that portion of the aisle. If a user is interested in seeing a more detailed view (and/or different) view of that portion of the shelf, the user can click on the section. In one embodiment, this changes the view from an overhead view to a side view of the shelf so that the user can see the items displayed on the shelf as they would if they were walking down the aisle in the store. This is particularly helpful for visual individuals who need visual cues or reminders about items they need to purchase. In this manner, if the user navigates to the pizza aisle to get ingredients to make a pizza crust, they also may receive a visual cue reminding them to get sauce, toppings, or certain spices for the pizza as well.

In addition to virtual shelves, the user interface may provide a magnifying or shelf expander feature. By one approach, the user may, for example, pinch and stretch the icon on a touch screen or right click on an item to expand the product and open up a virtual shelf that shows more products, such as those found on the shelf adjacent the originally displayed product. In some configurations, the expanded product opens up a virtual shelf that shows products organized by, for example, product similarity, popularity, price, or other measure, such as display location on the shelf. In addition to expanding or right clicking an item, the user may be able to hold their finger on an item on a touch screen or have an arrow hover over the item to see additional information about the item, such as, for example, ingredients, nutritional information, and/or size, among other information.

As mentioned above, the user interface 2414 also may present recipe kits for purchase. By one approach, the kits are presented on the page with the suggested items. In another approach, a recipe kits icon is located near the suggested items. In yet other configurations, the recipes kits are available via search or navigation through a drop down or expandable menu. FIG. 29 illustrates a screen shot 2900 showing a number of meals that are searchable for recipes. In this manner, a user may select “dinner” to locate meals to make for dinner. Further, the recipes may be searchable in a number of manners, such as by ingredients, dietary restrictions, or time constraints, among others.

FIG. 30 shows a screen shot 3000 of a recipe that may be displayed upon selection of the “breakfast” recipe category from the listing in FIG. 29. Alternatively, this ingredient listing may be displayed after selection of the “basic pancakes” recipe from a larger listing of “breakfast” recipes. By way of example, the “basic pancakes” recipe kit list ingredients including flour, baking powder, salt, white sugar, egg, and milk. If the user selects to add this “basic pancake” recipe kit to their cart, they can select the larger radial to the left of the “basic pancakes” title and each of the ingredients in the recipe kit will be added to the car. In another configuration, if the user does not want to purchase some of the ingredients, such as, for example, salt and baking powder, the user may select the smaller radials or tap on the ingredient themselves to have the individual ingredient added to the electronic shopping cart.

Further, the user interface 2414 also may display supplemental ingredients or “add-ons” that a user may select to purchase with the ingredients for the “basic pancakes” recipe. In the illustrative example of FIG. 30, the user interface 2414 displays “blueberries” and “maple syrup” adjacent to the ingredients listed in the primary recipe displayed, i.e., the “basic pancakes” ingredients. In one configuration, the control circuit 2416 analyzes the purchasing behaviors of other customers to determine what “add-ons” to display.

The user interface 2414 may take a variety of configurations. For example, the suggested items list or recipe kits may be displayed in a variety of manners. The example of FIG. 27 includes a text listing of suggested items along with icons disposed adjacent thereto. The amalgamated proposes shopping list or suggested items list may include only text, text and drawings, or primarily pictorial depictions or icons. FIG. 31 shows a screen shot 3100 that primarily displays icons in the suggested items list. As shown, a visual list of items is presented in an amalgamated proposed shopping list. Further, the visual list may be ranked or displayed in a prioritized manner, such as, for example, by frequency of purchase over the last ten visits, as discussed above.

In one configuration, the user may scroll through the suggested items displayed on the user interface 2414 to quickly locate those items of interest. Further, the user interface 2414, also may display the arrival time for store pick-ups or delivery drop-offs in this screen before reviewing the cart before submission of the order

As noted above, the user may tap the icon, text, or the radial adjacent the text to add the item into the user's electronic shopping cart. As illustrated in the screen shot 3200 of FIG. 32, the user also may swipe or drag the item or icon into the electronic shopping cart. Whether tapping, dragging, or otherwise selecting, each swipe or tap generally adds another item into the cart. As shown in FIG. 32, one spaghetti sauce appears to be located within the cart and the user is dragging a second sauce into the electronic shopping cart. Thus, the user appears to need at least two bottles of spaghetti sauce.

As shown in FIG. 33, the spaghetti sauce has been twice added to the electronic shopping cart. FIG. 33 also illustrates how the items purchased infrequently, such as only once in the last ten visits or orders, may be separated or added in a distinct section at the end or bottom of the suggested items list so that they do not clutter the suggested item listing, thereby focusing the user's attention on the items most likely to be of interest.

The amalgamated proposed shopping list also may be manually edited by the user. For example, the customer can easily remove items from the proposed shopping list so they do not show up again automatically. For example, if the customer purchased a can of mussels and will not be purchasing that product again soon, the user can swipe (e.g., swipe left, away from the electronic shopping cart in FIG. 33) to remove the product off the list before it would automatically drop off the list.

As noted above, the control circuit 2416 updates the customer profile 2422 upon receipt of subsequent orders. In this manner, the control circuit 2416 and the electronic user interface 2414 may display an updated, amalgamated proposed shopping list thereafter. In some configurations, once the user has added an item in the electronic shopping cart not previously purchased, the item is added to the amalgamated proposed shopping list in the section directed to single purchase items.

In one exemplary configuration, a user opts into receiving an amalgamated proposed shopping list (such as by affirmatively noting that the user wants a list of suggested items or recently purchased items to help the user shop rapidly), whereas in another configuration such a shopping list is presented to the customer who is given the option to remove the feature. By one approach, the user may select the number of recent orders or purchases to include in the aggregated list of purchases and other proposed or suggested items.

As noted above, the proposed or suggested items may be displayed or provided to the user in an amalgamated proposed shopping list or, in another configuration, in a proposed shopping cart. While the suggested items in the proposed shopping list are typically selected for purchase by adding them into the shopping cart, items in the proposed shopping cart do not need to be added thereto, but instead, the user merely needs to select order to purchase all of the items in the shopping cart. For example, if there are items that the particular user has ordered every Monday morning for the last three months and the user is submitting an order on Monday morning, the control circuit 2416 may include each of those items in a proposed electronic cart on the electronic user interface 2414 of that particular user. In this manner, the customer merely needs to open the mobile application, review the proposed electronic shopping cart and submit the order for pick up or delivery. This is not an automatic order such as that created via subscription, but the control circuit 2416 prepares a potential order for the customer, which the customer then manually submits to the control circuit 2416.

Once a control circuit 2416 receives an order, the selected retail facility 2432 is then provided information regarding the order for fulfillment thereof. As illustrated in FIG. 24, the retail facility 2432 may have work electronic devices 2426 with item retriever user interfaces 2428. The item retriever user interfaces 2428, in one configuration, displays orders that need to be gathered and the time by which the orders need to be retrieved. Further, the retriever user interface 2428 displays the orders such that the orders may be selected to display a listing of all items that need to be retrieved. In one configuration, the item retriever user interface 2428 provides information regarding where the items are located in the retail facility. In addition, the user interface 2428 may organize or display the ordered items in a manner for quick retrieval or may instruct the associate regarding how to procure to the items most efficiently. In one illustrative approach, the ordered items are broken down into environmentally sensitive products and non-environmentally sensitive products. In this manner, the associate may retrieve the environmentally sensitive products (such as frozen goods) after retrieving the remainder of the items or placing those products in specialized containers.

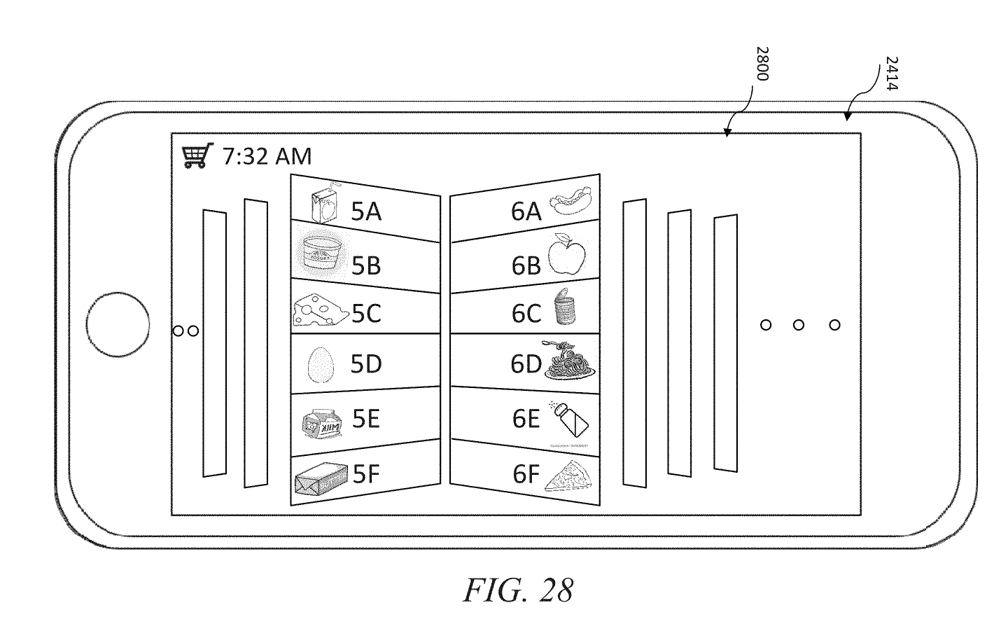

In one illustrative example, illustrated in FIG. 25, a method 2500 for providing an auto-generated proposed shopping list that is presented to customers, and this method may be facilitated with the devices discussed herein. In step 2502, the method includes maintaining a customer profile database with shopping histories, including purchased items, date of purchase, and time of purchase. Further, in step 2504, the method includes providing a shopping user interface configured for display on an electronic user device, such as, for example, a handheld or mobile user device including, e.g., smartphones or tablets.

The method also includes determining 2506 suggested items for inclusion in an amalgamated proposed shopping list for a particular user based upon an associated customer profile from the customer profile database and at least one present shopping aspect, such as, for example, the date and time in which the user is shopping, a delivery method selected, items presently in the shopping cart, a delivery location, or a present location of the user, among others. In this manner, the control circuit 2416 may be able to analyze aspects of the shopping session and the customer profile to determine what items to include in a shopping list (or possibly a shopping cart as noted below). A similar analysis may be done to determine how or in what order to present the items.

In some configurations, the method includes adding or updating 2508 the amalgamated shopping list to include a suggested, predictive retail item that, while not previously purchased by the user, is likely to be of interest to the user for purchase. Updating 2508 the shopping list also may include updating the order of display of the amalgamated proposed shopping list. By one approach, the updating 2508 of the shopping list may be based, for example, on the shopping behaviors of other shoppers or changes in the available offerings, such as, for example, when a new product that is being sold that is like others purchased by the user but further aligns with the value vectors of the user, as discussed above.

In step 2510, the method includes presenting, via the shopping user interface, the amalgamated shopping list in a prioritized manner based on the customer profile, a present shopping aspect (e.g., time of day, etc.) and/or frequency of purchase of items from the shopping history. In operation, this may permit the user to more quickly scan and order items in the amalgamated proposed shopping list.

After presentation of the amalgamated shopping list in a prioritized manner, the user can review the list and determine whether to proceed with purchase of the items on the list, such as by selecting them or adding them to the electronic shopping cart. In some configurations, the user interface may include an “add all” button that permits the user to add all of the items in the amalgamated proposed shopping list into the electronic shopping cart for purchase. The electronic user interface also may include other features that permit a user to shop or order remotely, such as a search field or a menu of items. Before submission of the electronic order, the user is typically provided an opportunity to review the electronic shopping cart before submitted the order. In some configurations, the user also may input or confirm payment and other order details, such as delivery method and location, payment, shipping speed, etc. Alternatively, in some configurations, these aspects may have default settings that the user requests unless otherwise noted.

After presentation of the shopping list and submission of the order by the user, the method 2500 includes receiving 2516 an order from the particular user with items from the amalgamated shopping list and sending 2518 instructions to a worker or associate electronic device at a selected retail facility regarding retrieval of the order. The selected retail facility may include the particular pick up destination chosen by the particular user or it may be a location selected by a control circuit for fulfillment of the order for delivery. By one approach, the selected location may be a facility with available items that is within a certain distance from the delivery location.

By one approach, the associate electronic device includes a listing of all items that need to be gathered for the submitted order. In one configuration, the associate electronic device may include an interface that notes or otherwise displays the location of the items where the associate may retrieve the items. In addition, the user interface may organize the ordered items in a manner for quick retrieval and the associate user interface may provide instructions for retrieval, which may be, for example, written or illustrated on a display or audibly provided via a speaker or headphones associated with the associate electronic device.

To maintain updated information in the customer profile database, such that subsequent remote shopping experiences provide an updated amalgamated proposed shopping list, the method also includes updating 2520 the customer profile in the customer profile database after any purchase by the particular user.

The user interface may include a number of features to improve customer experience. For example, in some configurations, the method may include displaying 2512 one or more recipe kits on the user interface, where the recipe kits have suggested or required ingredients associated therewith. In this manner, a user may scroll through the recipe kits and then add the entire required contents for that recipe with a simple selection or click. By way of another example, the method also may include displaying 2514 on the user interface virtual store shelves. For example, if a shopper knows they typically purchase the pasta noodles found on the top shelf of a grocery store, but doesn't remember the brand or the type of noodle, the user may select the virtual shelf button that permits the user to navigate to the pasta aisle and view the items on the store shelves.

As suggested above, the method also may determine and present items for inclusion in the electronic shopping cart if the control circuit 2416, in some configurations, determines that the particular user is highly likely to purchase or order these items. In some configurations, the control circuit 2416 and the user interface 2414 may present some items that are highly likely to be purchased in a proposed shopping cart and another set of items that are somewhat likely to be purchased in an amalgamated proposed shopping list, which may include predictive items that haven't previously been purchased.

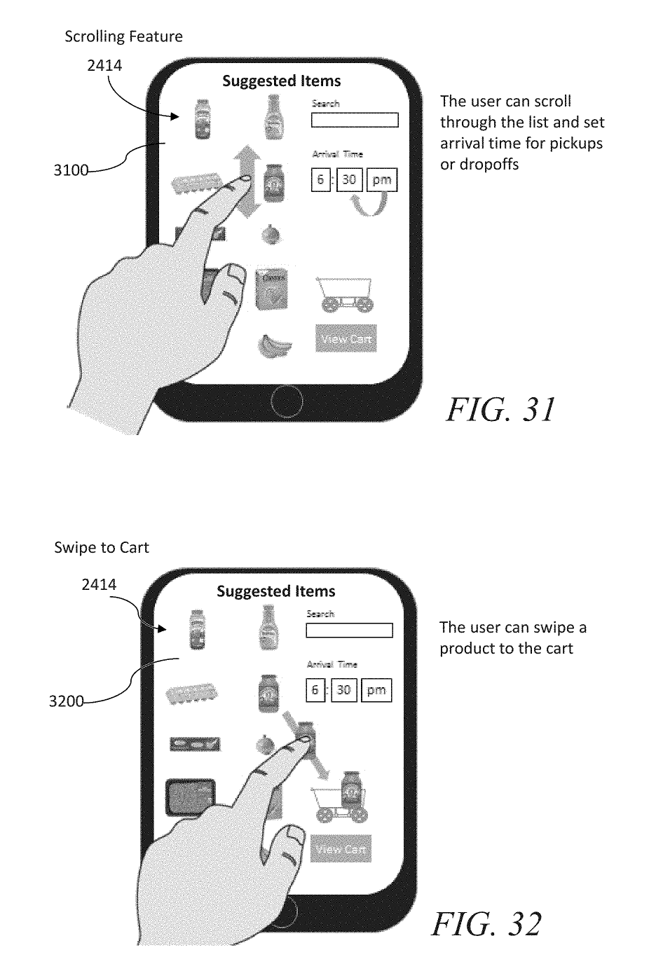

Referring to FIG. 34, there is illustrated a system 3400 that may be used for a variety of implementations, in accordance with some embodiments. One or more components of the system 3400 may be used to implement any system, apparatus or device mentioned above, or parts of such systems, apparatuses or devices, such as for example any of the above or below mentioned control circuits, electronic user devices, sensor(s), databases, platforms, parts thereof, and the like. However, the use of the system 3400, or any portion thereof is, certainly not required.

By way of example, the system 3400 may include one or more control circuits 3402, memory 3404, input/output (I/O) interface 3406, and/or user interface 3408. The control circuit 3402 typically comprises one or more processors and/or microprocessors. The memory 3404 stores the operational code or set of instructions that is executed by the control circuit 3402 and/or processor to implement the functionality of the systems and devices described herein, parts thereof, and the like. In some embodiments, the memory 3404 may also store some or all of particular data that may be needed to auto-generate an amalgamated proposed shopping list and have the items retrieved and prepared for customer pick up or delivery.

It is understood that the control circuit 3402 and/or processor may be implemented as one or more processor devices as are well known in the art. Similarly, the memory 3404 may be implemented as one or more memory devices as are well known in the art, such as one or more processor readable, and/or computer readable media and can include volatile and/or nonvolatile media, such as RAM, ROM, EEPROM, flash memory and/or other memory technology. Further, the memory 3404 is shown as internal to the system 3400; however, the memory 3404 can be internal, external or a combination of internal and external memory. The system 3400 also may include a database (not shown in FIG. 34) as internal, external, or a combination of internal and external to the system 3400. Additionally, the system typically includes a power supply (not shown), which may be rechargeable, and/or it may receive power from an external source. While FIG. 34 illustrates the various components being coupled together via a bus, it is understood that the various components may actually be coupled to the control circuit 3402 and/or one or more other components directly.

Generally, the control circuit 3402 and/or electronic components of the system 3400 can comprise fixed-purpose hard-wired platforms or can comprise a partially or wholly programmable platform. These architectural options are well known and understood in the art and require no further description here. The system and/or control circuit 3402 can be configured (for example, by using corresponding programming as will be well understood by those skilled in the art) to carry out one or more of the steps, actions, and/or functions described herein. In some implementations, the control circuit 3402 and the memory 3404 may be integrated together, such as in a microcontroller, application specification integrated circuit, field programmable gate array or other such device, or may be separate devices coupled together.

The I/O interface 3406 allows wired and/or wireless communication coupling of the system 3400 to external components and/or systems. Typically, the I/O interface 3406 provides wired and/or wireless communication (e.g., Wi-Fi, Bluetooth, cellular, RF, and/or other such wireless communication), and may include any known wired and/or wireless interfacing device, circuit and/or connecting device, such as, but not limited to, one or more transmitter, receiver, transceiver, etc.

The user interface 3408 may be used for user input and/or output display. For example, the user interface 3408 may include any known input devices, such one or more buttons, knobs, selectors, switches, keys, touch input surfaces, audio input, and/or displays, etc. Additionally, the user interface 3408 includes one or more output display devices, such as lights, visual indicators, display screens, etc. to convey information to a user, such as but not limited to the amalgamated proposed shopping list, other shopping information, instructions regarding product retrieval, status information, order information, delivery information, notifications, errors, conditions, and/or other such information. Similarly, the user interface 3408 in some embodiments may include audio systems that can receive audio commands or requests verbally issued by a user, and/or output audio content, alerts and the like.

Some embodiments provide shopping systems comprising: a selection user interface configured to be displayed on an electronic user device, the selection user interface configured to receive at least one suggested item selection from an amalgamated proposed shopping list for a particular user; a database of shopping profiles, a shopping profile including shopping history with items purchased, dates of purchase, and purchase time of day; a control circuit in communication with the database and the electronic user devices, the control circuit configured to: determine suggested items for inclusion in the amalgamated proposed shopping list for the particular user, wherein the suggested items include previously purchased items that were purchased within a previous predetermined number of purchases or within a previous predetermined period of time and predictive suggestions; present, via the shopper electronic user device, the amalgamated proposed shopping list to the particular user based on a set of priorities, the set of priorities assigned based on a frequency of purchase of the previously purchased items and at least one of a time of day or time of year; receive, from the electronic user device, the suggested item selections for inclusion in an electronic shopping cart; and send instructions to an associate electronic device at a retail facility to retrieve the suggested item selections in the electronic shopping cart prior to arrival of the particular user at the retail facility for pickup thereof. In some implementations, the control circuit is further configured to update the shopping history of the particular user with the suggested item selections subsequently purchased by the particular user. The shopping profile may further include at least one of a location of item purchase, a location of item delivery, or a manner of delivery and the control circuit further analyzes the location of item purchase, the location of item delivery, or the manner of delivery to update the assigned set of priorities and any amalgamated proposed shopping lists associated therewith.

The predictive suggestions, in some embodiments, include at least one of a seasonal item, one or more items purchased by shoppers having a similar shopping profile to the particular user, items purchased by a certain percentage of other mobile shoppers, items frequently purchased by other mobile shoppers, or alternative suggested items. Additionally or alternatively, the alternative suggested items may include an item similar to a previously purchased item that corresponds to a value vector of one or more items in the shopping history or has a product profile similar to other items in the shopping history or the suggested items selected. In some implementations, the selection user interface displays recipe kits with recipe ingredients included as the suggested items for addition to the electronic shopping cart of the particular user. Further, the recipe kit may be selected on the selection user interface to add the recipe ingredients into the electronic shopping cart. The associate electronic device may further comprises an item retriever user interface configured to display multiple orders stored by the database. In some embodiments, the item retriever user interface is further configured to display order details including purchased items and provide instructions to the associate regarding efficient retrieval of the purchased items. Further, in some applications, at least one of the selection user interface or the item retriever user interface is provided to the electronic user devices by the control circuit. Additionally or alternatively, at least one of the selection user interface or the item retriever user interface may be configured to be executed by the electronic user devices when in communication with the central computer.

In some embodiment, the selection user interface is further configured to provide at least one of: an expander feature that permits the particular user to open up a virtual shelf or a tap and hold feature that permits the particular user to select a suggested item and view related items or additional information regarding the selected suggested item. Further, in some implementations, the selection user interface is further configured to receive transaction information including payment information, retrieval location, and retrieval time. The selection user interface may further be configured to display virtual store shelves with retail products that the particular user may select for addition to the electronic shopping cart. In some embodiments, the selection user interface is further configured to display a store map to provide information on product location in a physical retail store. In some embodiments, the selection user interface is configured to present the electronic shopping cart and the selected items therein prior to submission of the electronic shopping cart to the control circuit.

Some embodiments provide shopping systems comprising: a selection user interface configured to be displayed on an electronic user device, the selection user interface configured to receive a selection of at least one requested item from an amalgamated proposed shopping list for a particular user; a database of shopping profiles, a shopping profile including shopping history with items purchased, dates of purchase, and purchase time of day; a control circuit in communication with the database and the electronic user devices, the control circuit configured to: obtain a first set of rules that identify a suggested product for inclusion in the amalgamated proposed shopping list for the particular user as a function of prior purchase; obtain a second set of rules that identify another suggested product for inclusion in the amalgamated proposed shopping list for the particular user as a function of predictive correlation that identifies predictive suggestions, the predictive correlation based, in part, on the shopping profile of the particular user having value vector characteristics similar to particular product profiles; determine items to include in the amalgamated proposed shopping list for a particular user based on the first and second set of rules; obtain a third set of rules that identify a presentation ordering of the suggested products in the amalgamated proposed shopping list for the particular user as a function of a frequency of items purchased by the particular user, frequency of items purchased by other shoppers and at least one of a time of day or time of year, and receive at least one of the requested selected items for inclusion in an electronic shopping cart. The control circuit, in some implementations, is further configured to send instructions to an associate electronic device at a retail facility regarding gathering the requested selected items prior to the particular customer's arrival at the retail facility for pickup thereof.

Some embodiments provide shopping systems comprising: a selection user interface configured to be displayed on an electronic user device, the selection user interface configured to receive at least one suggested item selection from an amalgamated proposed shopping list for a particular user; a database of shopping profiles, a shopping profile including shopping history with items purchased, dates of purchase, and purchase time of day; a control circuit in communication with the database and the electronic user devices, the control circuit configured to: determine suggested items for inclusion in the amalgamated proposed shopping list for a particular user, wherein the suggested items include previously purchased items that were purchased within a previous predetermined number of purchases or within a previous predetermined period of time and predictive suggestions; present, via the shopper electronic user device, the amalgamated proposed shopping list to the particular user based on a set of priorities, the set of priorities being assigned based on a frequency of purchase of the previously purchased items, a selected delivery location, and at least one of a time of day or time of year; receive, from the electronic user device, the suggested item selections for inclusion in an electronic shopping cart; and send instructions to an associate electronic device at a retail facility regarding gathering the suggested item selections in the electronic shopping cart for delivery to the particular user.

Some embodiments provide methods comprising: maintaining a customer profile database with shopping histories stored therein, including purchased items, date of purchase, and time of purchase; providing a shopping user interface configured to be displayed on an electronic user device; determining suggested items for inclusion in an amalgamated proposed shopping list for a particular user based upon an associated customer profile from the customer profile database including the shopping history and at least one present shopping aspect including: a time and day during which the particular user is shopping on the shopping user interface, a delivery method selected by the particular user, items presently in a shopping cart, a delivery method, or a present location of the particular user; presenting, via the shopping user interface, the amalgamated shopping list in a prioritized manner based on at least one of: the associated customer profile, one of the present shopping aspects, or frequency of purchase of items from the shopping history; and receiving an order from the particular user with items from the amalgamated shopping list.

Various partialities (including but not limited to partialities based on values, aspirations, preferences, and/or affinities) for individual persons are represented as corresponding vectors. The length and/or the angle of the vector represents the magnitude of the strength of the individual's belief in the good that comes from that imposed order. Vectors can also be specified to characterize corresponding products and/or services. These vectors for persons and products/services can be leveraged in any of a wide variety of ways. Further, the vectors and other information in a customer profile, stored in a database, may help facilitate systems, apparatuses, and methods useful for remote shopping or ordering of products, such as, for example, via a mobile application or app that presents an auto-generated amalgamated proposed shopping list or proposed shopping cart. In this manner, a customer may use the shopping system to accept items for purchase quickly and easily.

Preferences-based approaches are particularly susceptible to frailty when the consumer engages in unexpected behaviors (including but not limited to unexpected shopping behaviors). A traditional approach, whether executed by machine or human, is to simply update the preferences-based characterization of the person by adding the unexpected behavior (directly or indirectly) to the list of preferences for that person. While sometimes appropriate, such an approach can lead to serious future miscalculations. In particular, when the unexpected behavior constitutes irrational behavior, prior approaches can lead to actions that are not only incorrect but diametrically opposed to what should be done for the person in question.

Some embodiments provide rule-based irrational behavior identification and accommodation systems, apparatuses and methods.

Generally speaking, these teachings provide for a control circuit that is operably coupled to a memory having stored therein information regarding partialities for a customer. By one approach this information includes a plurality of partiality vectors for the customer. The memory also includes a first set of rules to identify a customer behavior has an irrational behavior as a function of a comparison of the behavior to the information regarding partialities for the customer. The memory further includes a second set of rules to determine whether to cater to an irrational behavior or to encourage rational behavior when selecting a product to present to the customer as a function of the information regarding partialities for the customer.

The control circuit accesses information regarding a particular behavior of the customer and evaluates that information to determine whether the particular behavior is contrary to at least one of the partialities for the customer. When true, the control circuit evaluates that information against the first set of to determine whether the particular behavior is irrational behavior for the customer. When true, the control circuit then evaluates the information against the second set of rules to determine whether to cater to the irrational behavior or to encourage rational behavior when selecting a product to present to the customer.

By one approach, the first set of rules identify a behavior as an irrational behavior as a function of a comparison of the behavior to the information regarding partialities for the customer by, at least in part, making a statistical analysis of the behavior with respect to the information regarding partialities for the customer. This statistical analysis can serve, for example, to determine whether the behavior represents a statistical outlier in view of the information regarding partialities for the customer.

When the aforementioned activity results in a determination to encourage rational behavior when selecting a product to present to the customer, these teachings will accommodate selecting a product to redress a disorder that corresponds to the irrational behavior of the customer.

By one approach the control circuit can access a third set of rules to facilitate reclassifying an irrational behavior for the customer has at least one of a new partiality for the customer and a modified existing partiality for the customer as a function of previously observed irrational behavior for the customer.

So configured, a partiality-based approach to serving a customer's needs can take into account vocational irrational behavior by that customer. Although the rules that control this activity are different than prior art approaches to preference-based customer service, the applicant has determined that such rules nevertheless can ultimately better help and/or accommodate the needs of customers. The aforementioned statistics-based approach, while again not an ordinary facet of customer service, can the particularly helpful when making a determination regarding when a particular behavior is rational or irrational in a contextually relevant and potentially highly personalized manner.

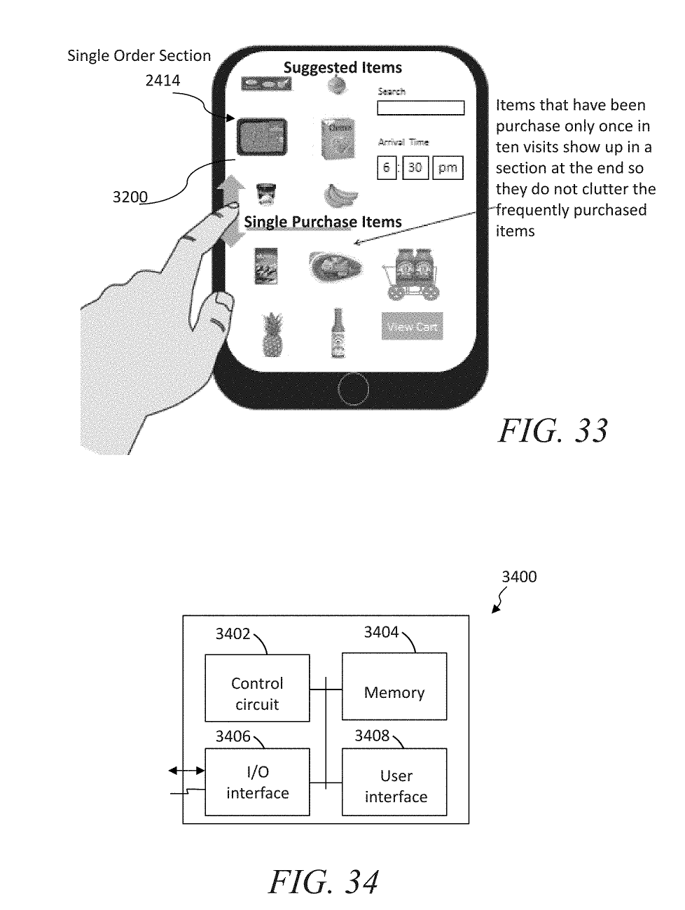

Referring now to FIG. 35, an approach to dealing with unusual customer behavior will be described. This process 3500 can be carried out by, for example, the aforementioned control circuit 1301. By one approach this process 3500 can be carried out in conjunction with any one or more of the above-described processes for selecting a product/service to present to a particular customer.

At block 3501 this process 3500 provides for accessing information regarding a particular behavior of a particular customer. This information can be provided/sourced as described above if desired and may therefore comprise any of a variety of non-commercial behaviors. These teachings will also accommodate, however, having the information constitute the particulars of a particular product purchase. By one approach the control circuit accesses this information in real time or near real time (for example, within a point in time when the customer evinces the behavior and, say, five seconds, fifteen seconds, one minute, five minutes, or some other relatively short duration of time of choice). By another approach the information may be more dated and hence may reflect behavior that occurred within, say, one hour, three hours, twelve hours, one day, two days, one week, or some other relatively longer duration of time of choice.

By one approach the control circuit itself relies upon its own network of sensors and sources to gain the aforementioned information. By another approach, in lieu of the foregoing or in combination therewith, the control circuit receives the information from other sources via, for example, a subscription service or other data aggregator. And by yet another approach, and as described above, the accessed information can be initially sourced, in whole or in part, via the Internet of Things and/or the customer's own personal computational platform(s) (such as, but not limited to, so-called smartphones).

These teachings are relatively flexible and will accommodate both push and pull-based informational access methodologies as desired.

At block 3502 the control circuit 1301 evaluates the accessed information regarding the customer's particular behavior to determine whether the particular behavior is contrary to at least one partiality 3503 for the customer. By one approach, and as described above, this partiality information can be expressed as partiality vectors 1307 for the customer. Because such partiality vectors have a magnitude that corresponds to the strength of the customer's belief in the corresponding partiality, a behavior that can be expressed as being consistent with or otherwise evidencing a negative magnitude for a particular partiality/vector can be readily identified as being “contrary” to that particular partiality.

Furthermore, the greater the magnitude of the customer's partiality (and hence the greater their corresponding understood belief), the greater the possible amount of contrariness that may be evinced by a particular accessed behavior. For example, a particular behavior that can be characterized as a magnitude of −4 for a particular partiality has a smaller net contrariness factor when compared to a partiality vector having a magnitude of +2 than for a partiality vector having a magnitude of +8.

When the particular behavior is not contrary (or at least is not sufficiently contrary in view of some applicable threshold or other standard or measure) this process 3500 can continue as described above for any number of other processes. When the control circuit 1301 determines that the particular behavior in fact represents a behavior that is contrary to a given partiality for this particular customer, however, at block 3504 the control circuit 1301 determines whether the customer's behavior can be characterized as irrational. Pursuant to this process 3500 the control circuit evaluates the information regarding the particular behavior of the customer against a first set of rules 3505 to make this determination regarding irrational behavior.

Generally speaking, as used herein this reference to irrational behavior need not refer to behavior that is objectively considered irrational for a large population. Instead, this reference to irrational behavior refers to a measure of correspondence to some already-established baseline understanding of a particular person's partialities. Accordingly, a particular behavior that might be viewed in the abstract as irrational behavior can be fairly and properly considered irrational behavior in the context of a particular person's partiality system.

The first set of rules can identify a behavior as an irrational behavior as a function of a comparison of the behavior to the information regarding partialities for the customer by, at least in part, making a statistical analysis of the behavior with respect to the information regarding partialities for the customer. This statistical analysis can serve, at least in part, to determine whether the behavior represents a statistical outlier in view of the information regarding partialities for the customer. In statistics, an outlier is an observation point that is distant from other observations. Outliers can be due to variability in the measurement or can indicate experimental error and, as a result, are often excluded from the data set being considered. Here, however, an observed customer behavior that also constitutes a statistical outlier in the context of the customer's own partiality data set is not excluded and instead becomes the appropriate focus for assessing a behavior so contrary to the customer's established partialities as to characterize the behavior as being irrational.

Upon determining that the particular customer behavior is irrational, at block 3506 the control circuit 1301 evaluates the information regarding the particular behavior against a second set of rules 3507 to determine whether to cater to the irrational behavior or to encourage rational behavior when selecting a product to present to the customer. By one approach this second set of rules 3507 can employ thresholds to assess, for example, whether the behavior is sufficiently contrary as well as sufficiently irrational to make this determination.

By another approach, in lieu of the foregoing or in combination therewith, this second set of rules 3507 can take other factors into account into account. As one example, when the customer has a recorded history of occasionally making irrational purchases and has then responded positively to more rational product offerings, the second set of rules 3507 can be weighted to favor again encouraging rational behavior as versus catering to the irrational behavior. When, however, the customer has a recorded history of sometimes making irrational purchases and then responding negatively to more rational product offerings, the second set of rules 3507 can be weighted to favor catering to the irrational behavior with product selections that aligned with the irrational behavior rather than the partiality record.

Generally speaking, the customer's behavior can be reasonably modeled or represented by both objective and subjective elements. Accordingly:

$${}_{Customer Personality} = \int ( {}_{Objective} , {}_{Subjective} )$$

where the objective variable(s) can include information regarding, for example, spending habits, financial actions, credit reports, and so forth and the subjective variable(s) can include information regarding, for example, a statistical correlation between retirement planning and present (or recent) actions by the consumer. This functional view can, in turn, yield a solution set such as the surface-based solution described above. So configured, the aforementioned determination that a particular customer behavior is irrational can be based first upon detecting a disconnect between the customer's calculated solution (for a given scenario) and the customer's actual behavior and secondly upon a determination that the magnitude of the disconnect is sufficiently statistically significant.

Having determined whether to cater to the irrational behavior or to instead encourage rational behavior as described above, at optional block 3508 this process 3500 can provide for selecting a product to present to the customer. In these regards, when this process 3500 results in looking to encourage rational behavior, this activity can comprise selecting a product to redress a disorder that corresponds to the irrational behavior of the customer. Such an approach can be useful when the control circuit 1301 has sufficient information available to not only determine that the customer's behavior in some specific regard is irrational but to also identify one or more causes behind that behavior. Such a cause can be viewed as a disorder and the product selection can be one that specifically (or indirectly) redresses that disorder.

As described above, the product selection activity can rely in other ways upon one or more partiality vectors for this consumer and/or product characterization vectors. Such information can serve, for example, to identify candidate products that are commensurate with the customer's partialities that are not otherwise at issue with respect to the irrational behavior.

As explained above, the development of a fully representative set of partiality vectors for a given person will likely occur over a period of time and when and as information regarding the person's behaviors become available to form corresponding conclusions about their partialities. Similarly, a person's partialities can and will themselves change over time, sometimes gradually and sometimes rapidly. Accordingly, it is possible that what appears to be irrational behavior for a particular person is, in fact, simply new (albeit surprising in context) information about that person's partialities and/or an expression of a new (albeit contrary) partiality.

With the foregoing in mind, optional block 3509 provides a mechanism for evaluating the information regarding the particular behavior of the customer that has been characterized as irrational against a third set of rules 3510 to determine whether to reclassify the irrational behavior for the customer as a new partiality for the customer and/or as a modified existing partiality for the customer. This third set of rules 3510 can include rules that point towards reclassifying a particular behavior in favor of new/modified partialities as a function, for example, of the customer's history of evincing other rapid changes in their partialities in the past, of a generalized history of other persons who share similar partialities with this customer that empirically demonstrate that this peer group is inclined towards making and acting upon rapid changes in their partialities, age-based statistics that empirically demonstrate that persons of a particular age group are more likely to make and act upon rapid changes in their partialities, event-based changes (regarding events such as academic achievements, marital-status changes, parenthood changes, and so forth) that are empirically vetted as often closely preceding rapid changes in partialities, and so forth.

Upon determining that reclassification is appropriate, this process 3500 can optionally provide for effecting such reclassification at block 3511 and a corresponding updating of the partiality information for this particular person.

So configured, information regarding a person's partialities can be made considerably more flexible in use. As a result, previous information is not necessarily immediately modified when a person acts dramatically out of character. Furthermore, product/service suggestions and opportunities can be based upon a decision regarding whether to follow the person with respect to their current unusual behavior (and hence encourage that direction) or to instead encourage that person to revert back to their more ordinary behavior through suggestions/offerings that are helpful and/or at least palliative in those regards.

The following simple example may help to illustrate this capability in practice. A particular consumer's purchasing history may indicate that the consumer first purchased compact fluorescent light bulbs when they first became available and then later purchased light-emitting diode (LED) light bulbs in quantity and likely prior to when the consumer's existing light bulbs had burned out, all of which has helped to characterize this consumer as having a partiality towards energy efficiency. If this person then purchases a number of incandescent light bulbs (which are considerably less efficient than either florescent or LED light bulbs), these rule-based teachings will support first determining that such a purchase is contrary to the aforementioned partiality and then also determining that the purchase constitutes an irrational behavior in context because a person cannot reasonably value both energy efficiency and the wasting of energy at the same time.

Some embodiments provide apparatuses comprising: a memory having stored therein information regarding partialities for a customer, a first set of rules to identify a behavior as an irrational behavior as a function of a comparison of the behavior to the information regarding partialities for the customer, and a second set of rules to determine whether to cater to an irrational behavior or to encourage rational behavior when selecting a product to present to the customer as a function of the information regarding partialities for the customer; a control circuit operably coupled to the memory and configured to: access information regarding a particular behavior of the customer; evaluating the information regarding the particular behavior of the customer to determine whether the particular behavior is contrary to at least one of the partialities for the customer; when the particular behavior is contrary to at least one of the partialities for the customer, evaluating the information regarding the particular behavior of the customer against the first set of rules to determine whether the particular behavior is irrational behavior for the customer; when the particular behavior is irrational behavior for the customer, evaluating the information regarding the particular behavior of the customer against the second set of rules to determine whether to cater to the irrational behavior or to encourage rational behavior when selecting a product to present to the customer. In some implementations, the first set of rules identify a behavior as an irrational behavior as a function of a comparison of the behavior to the information regarding partialities for the customer by, at least in part, making a statistical analysis of the behavior with respect to the information regarding partialities for the customer. In some embodiments, the statistical analysis serves, at least in part, to determine whether the behavior represents a statistical outlier in view of the information regarding partialities for the customer.

The memory can further include a third set of rules to reclassify an irrational behavior for the customer as at least one of a new partiality for the customer and a modified existing partiality for the customer as a function of previously observed irrational behavior for the customer and wherein the control circuit is further configured to: when the particular behavior is irrational behavior for the customer, evaluating the information regarding the particular behavior of the customer against the third set of rules to determine whether to reclassify the irrational behavior for the customer as at least one of a new partiality for the customer and a modified existing partiality for the customer. In some embodiments, the particular behavior of the customer constitutes a product purchase. The control circuit, in some implementations, is further configured to: upon determining to encourage rational behavior when selecting a product to present to the customer, selecting a product to redress a disorder that corresponds to the irrational behavior of the customer. In some embodiments, the information regarding partialities for the customer includes information including a plurality of partiality vectors for the customer. The memory, in some implementations, further has stored therein vectorized characterizations for each of a plurality of products, wherein each of the vectorized characterizations indicates a measure regarding an extent to which a corresponding one of the products accords with a corresponding one of the plurality of partiality vectors. In some embodiments, the control circuit is further configured to evaluate the information regarding the particular behavior of the customer to determine whether the particular behavior is contrary to at least one of the partialities for the customer by, at least in part, also using the vectorized characterizations to determine whether the particular behavior is contrary to at least one of the partialities for the customer.

Some embodiments provide methods comprising: by a control circuit that is operably coupled to a memory having stored therein information regarding partialities for a customer, a first set of rules to identify a behavior as an irrational behavior as a function of a comparison of the behavior to the information regarding partialities for the customer, and a second set of rules to determine whether to cater to an irrational behavior or to encourage rational behavior when selecting a product to present to the customer as a function of the information regarding partialities for the customer: accessing information regarding a particular behavior of the customer; evaluating the information regarding the particular behavior of the customer to determine whether the particular behavior is contrary to at least one of the partialities for the customer; when the particular behavior is contrary to at least one of the partialities for the customer, evaluating the information regarding the particular behavior of the customer against the first set of rules to determine whether the particular behavior is irrational behavior for the customer; when the particular behavior is irrational behavior for the customer, evaluating the information regarding the particular behavior of the customer against the second set of rules to determine whether to cater to the irrational behavior or to encourage rational behavior when selecting a product to present to the customer. In some implementations the first set of rules identify a behavior as an irrational behavior as a function of a comparison of the behavior to the information regarding partialities for the customer by, at least in part, making a statistical analysis of the behavior with respect to the information regarding partialities for the customer.

In some applications, the statistical analysis serves, at least in part, to determine whether the behavior represents a statistical outlier in view of the information regarding partialities for the customer. The memory may further include a third set of rules to reclassify an irrational behavior for the customer as at least one of a new partiality for the customer and a modified existing partiality for the customer as a function of previously observed irrational behavior for the customer and wherein method further comprises: when the particular behavior is irrational behavior for the customer, evaluating the information regarding the particular behavior of the customer against the third set of rules to determine whether to reclassify the irrational behavior for the customer as at least one of a new partiality for the customer and a modified existing partiality for the customer. In some implementations, the particular behavior of the customer constitutes a product purchase. In some embodiments, the method further comprises: upon determining to encourage rational behavior when selecting a product to present to the customer, selecting a product to redress a disorder that corresponds to the irrational behavior of the customer. The information regarding partialities for the customer, in some applications, includes information including a plurality of partiality vectors for the customer.

In some embodiments, the memory further has stored therein vectorized characterizations for each of a plurality of products, wherein each of the vectorized characterizations indicates a measure regarding an extent to which a corresponding one of the products accords with a corresponding one of the plurality of partiality vectors. Some embodiments evaluate the information regarding the particular behavior of the customer to determine whether the particular behavior is contrary to at least one of the partialities for the customer comprises, at least in part, also using the vectorized characterizations to determine whether the particular behavior is contrary to at least one of the partialities for the customer.

Various partialities (including but not limited to partialities based on values, aspirations, preferences, and/or affinities) for individual persons can be represented as corresponding vectors. The length and/or the angle of the vector represents the magnitude of the strength of the individual's belief in the good that comes from that imposed order. Vectors can also be specified to characterize corresponding products and/or services. These vectors for persons and products/services can be leveraged in any of a wide variety of ways. By one approach, information regarding such partialities can be employed to help determine whether a particular example of a person's behavior is, in their own personal context, irrational behavior.

Another challenge in the retail setting is the movement of merchandise that may be accumulating at shopping facilities or distribution centers. In other words, it is desirable to be able to facilitate the sale of merchandise that is accumulating in inventory for any of various reasons, including, for example, merchandise that may not be selling well and merchandise that may be returned, damaged, overstocked, or specialty items. It would be desirable to promote these merchandise items to customers or solicit bids from customers for this merchandise. Further, it would be desirable to direct such promotions and bid solicitations to customers whose values indicate they may have a preference for such merchandise.

Generally speaking, pursuant to various embodiments, systems, apparatuses and methods are provided herein useful to promotion and customer bidding on merchandise at shopping facilities. In some embodiments, there is provided a system comprising: an electronic interface configured to transmit information regarding merchandise for bidding to a customer's mobile device at a shopping facility and to receive information regarding characteristics of the customer; and a control circuit operatively coupled to the electronic interface, the control circuit configured to: identify a first subset of merchandise at the shopping facility from a merchandise database with sales below a first predetermined threshold of target sales but above a second predetermined threshold of target sales; identify a second subset of merchandise at the shopping facility from the merchandise database with sales below the second predetermined threshold of target sales; identify a third subset of merchandise at the shopping facility from the merchandise database of returned or damaged merchandise; add the second and third subsets of merchandise to a bidding database; identify characteristics relating to the customer; identify a fourth subset of merchandise for promotion and bidding corresponding to the characteristics relating to the customer; transmit a first communication to the mobile device of the customer offering a merchandise item for sale that is in both the first and fourth subsets; transmit a second communication to the mobile device of the customer requesting a bid on a merchandise item for bidding by the customer that is in one of the second and third subsets and in the fourth subset; receive responses to the first and second communications from the customer; and determine whether to accept a bid from the customer if the customer submits a bid in response to the second communication.

Further implementations of these embodiments are provided. For example, in some implementations, the electronic interface comprises a server at the shopping facility or a retailer website. In some implementations, the system may further comprise a sensor configured to determine a location of the customer in the shopping facility; wherein the characteristics relating to the customer are the location of the customer in the shopping facility. In some implementations, the sensor may comprise an imaging sensor configured to capture images of the customer in the shopping facility and a GPS sensor configured to determine a location of the mobile device of the customer. In some implementations, the system may further comprise: a customer database containing at least one of demographic information of the customer and shopping history of the customer; wherein the characteristics relating to the customer are at least one of demographic information of the customer and shopping history of the customer. In some implementations, the control circuit may be configured to: access partiality information for customers and to use that partiality information to form corresponding partiality vectors for customers wherein the partiality vector has a magnitude that corresponds to a magnitude of the customer's belief in an amount of good that comes from an order associated with that partiality. In some implementations, the control circuit may be further configured to: form counterpart merchandise vectors wherein the counterpart vectors have a magnitude that represents to the degree which each of the merchandise pursues a corresponding partiality. In some implementations, the control circuit may be further configured to: receive identification information regarding the customer and access the customer's partiality vectors, the customer's partiality vectors constituting the characteristics relating to the customer; and determine merchandise vectors corresponding to the customer's partiality vectors to determine the fourth subset of the merchandise for promotion and bidding. In some implementations, the control circuit may be configured to: determine whether to accept the bid from the customer by determining whether it equals or exceeds a predetermined minimum price threshold. In some implementations, the control circuit may be configured to: transmit a promotional offer to the mobile device of the customer if the customer does not respond to the communication requesting a bid or if a bid submitted by the customer does not equal or exceed a predetermined minimum price threshold. In some implementations, the control circuit may be configured to: receive a purchase request from the customer's mobile device; relay messages between the customer's mobile device and the electronic interface comprising updates to a blockchain; and facilitate an electronic peer-to-peer payment transfer of a digital currency from the customer's mobile device to the electronic interface.

In another form, there is provided a method for customer bidding on merchandise at shopping facilities, the method comprising: by an electronic interface, transmitting information regarding merchandise for bidding to a customer's mobile device at a shopping facility and receiving information regarding characteristics of the customer; and by a control circuit: identifying a first subset of merchandise at the shopping facility from a merchandise database with sales below a first predetermined threshold of target sales but above a second predetermined threshold of target sales; identifying a second subset of merchandise at the shopping facility from the merchandise database with sales below the second predetermined threshold of target sales; identifying a third subset of merchandise at the shopping facility from the merchandise database of returned or damaged merchandise; adding the second and third subsets of merchandise to a bidding database; identifying characteristics relating to the customer; identifying a fourth subset of merchandise for promotion and bidding corresponding to the characteristics relating to the customer; transmitting a first communication to the mobile device of the customer offering a merchandise item for sale that is in both the first and fourth subsets; transmitting a second communication to the mobile device of the customer requesting a bid on a merchandise item for bidding by the customer that is in one of the second and third subsets and in the fourth subset; receiving responses to the first and second communications from the customer; and determining whether to accept a bid from the customer if the customer submits a bid in response to the second communication.

In another form, there is provided a system for customer bidding on merchandise comprising: a retailer website configured to receive identification information regarding a customer from a customer computing device and to transmit information regarding merchandise for bidding to the customer's computing device; a customer database containing characteristics relating to the customer comprising at least one of demographic information of the customer, shopping history of the customer, and the customer's preferences; a control circuit operatively coupled to the retailer website and the customer database, the control circuit configured to: identify a first subset of merchandise from a merchandise database with sales below a first predetermined threshold of target sales but above a second predetermined threshold of target sales; identify a second subset of merchandise from the merchandise database with sales below the second predetermined threshold of target sales; identify a third subset of merchandise from the merchandise database of returned or damaged merchandise; add the second and third subsets of merchandise to a bidding database; identify characteristics relating to the customer from the customer database; identify a fourth subset of the merchandise for promotion and bidding corresponding to the characteristics relating to the customer; transmit a first communication to the customer computing device offering a merchandise item for sale that is in both the first and fourth subsets; transmit a second communication to the customer computing device requesting a bid on a merchandise item for bidding by the customer that is in one of the second and third subsets and in the fourth subset; receive responses to the first and second communication from the customer; and determine whether to accept a bid from the customer if the customer submits a bid in response to the second communication.

These “value vectors” may be used in the context of an in-store customer promotion and bidding system and method. In other words, promotions may be directed towards the computing devices of in-store customers who may have values and preferences corresponding to the merchandise that is the subject matter of the promotions. Further, for certain types of merchandise, these “value vectors” may also be used to direct requests to in-store customers asking them to make bids on merchandise that corresponds to the customers' values and preferences. Thus, in one form, these “value vectors” may be used to direct more useful and meaningful promotions and requests for solicitation to customers regarding merchandise for which there is likely to be more interest than more randomly selected merchandise.

As addressed further below, the in-store customer promotion and bidding approach is directed generally to allowing customers at a store to bid on selected items within the store to promote sales of slow moving items, deleted items, manufacturer discontinued items, or local special/feature buys. The approach may leverage in-store inventory and a customer's mobile device. Customers may, for example, use their mobile device to log onto a software application (“app”) supported by the retailer that would allow them to bid/buy items at the store. The software application might also transmit product alerts to the mobile device based on: customer value vectors suggesting possible product preferences based on the customer's values, customer proximity to a product in the store, a product that has been scanned during the current shopping trip, or customer purchase history. The award of a bid could be through an algorithm or through interaction with a store associate who might approve the customer's bid. The items could be made available at a store pick up location, held for subsequent pick up/delivery, or held in other digital inventory storage areas, and transactions could be processed through points of sale systems.

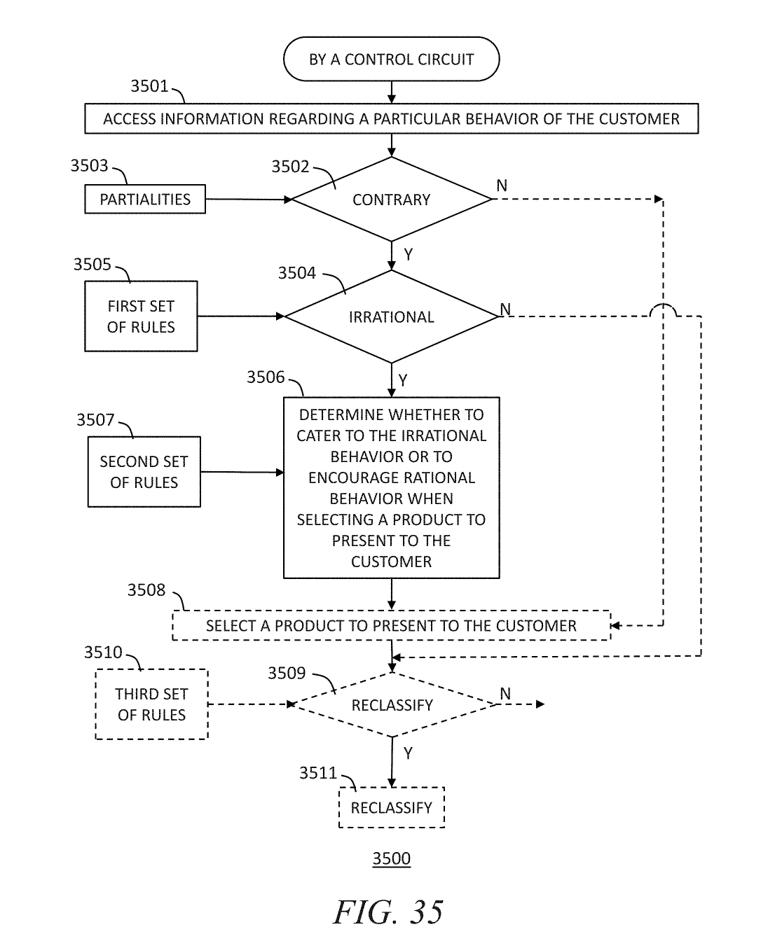

FIG. 36 shows a block diagram of a system 3600 for promotion and customer bidding on merchandise being sold at stores. It is generally contemplated that certain types of merchandise from a merchandise database are identified that are suitable for promotion and/or bidding by customers. In this context, bidding by customer generally refers to asking the customer to make an offer on merchandise below a typical sales price. The types of merchandise that may be the subject of promotion or bidding may include low selling merchandise, returned merchandise, slightly damaged merchandise, seasonal merchandise (that may be out of season), etc. Also, as addressed further below, an effort is preferably made to match up the merchandise that may be the subject of promotion or bidding and directed to the customer with likely merchandise preferences of the customer.

The system 3600 includes an electronic interface 3602 that generally is in communication with the computing device 3604 of a customer. It is generally contemplated that the system 3600 may involve a customer at a physical store equipped with a mobile device, as well as a customer remotely accessing an online store with a computing device. When remotely accessing an online store, the customer may use a variety of computing devices, including mobile devices (like smartphones) and non-mobile devices (like desktop computers).

Initially, the system 3600 will be described in the context of a customer present at a physical store and equipped with a mobile device 3604. For example, the customer may use the mobile device 3604 to log onto the system 3600, or the system 3600 may initiate a communication (such as a product alert) to the customer's mobile device 3604 if detected in the store. In this context, the electronic interface 3602 is configured to transmit information regarding merchandise to the customer's mobile device 3604 at the store and to receive information regarding characteristics of the customer. The electronic interface 3602 may be a server at the store or may be a retailer website accessible to the mobile device 3604 by a software application. The mobile device 3604 may be any of various types of portable computing devices, including, for example, smartphones, tablet computers, fobs, and other handheld devices.

The system 3600 also includes a control circuit 3606 that is operatively coupled to the electronic interface 3602 and that controls the general operation of the system 3600. The control circuit 3606 that is communicatively coupled to one or more databases, as addressed further below. The control circuit 3606 comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the control circuit 3606 to effect the control aspect of these teachings.

Such a control circuit 3606 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 3606 is configured (for example, by using corresponding programming as will be well understood by those skilled in the art) to carry out one or more of the steps, actions, and/or functions described herein.

By one optional approach, the control circuit 3606 operably couples to a memory 3608. This memory 3608 may be integral to the control circuit 3606 or can be physically discrete (in whole or in part) from the control circuit 3606, as desired. This memory 3608 can also be local with respect to the control circuit 3606 (where, for example, both share a common circuit board, chassis, power supply, and/or housing) or can be partially or wholly remote with respect to the control circuit 3606 (where, for example, the memory 3608 is physically located in another facility, metropolitan area, or even country as compared to the control circuit 3606).

This memory 3608 can serve, for example, to non-transitorily store the computer instructions that, when executed by the control circuit 3606, cause the control circuit 3606 to behave as described herein. As used herein, this reference to “non-transitorily” will be understood to refer to a non-ephemeral state for the stored contents (and hence excludes when the stored contents merely constitute signals or waves), rather than volatility of the storage media itself, and hence includes both non-volatile memory (such as read-only memory (ROM)) as well as volatile memory (such as an erasable programmable read-only memory (EPROM))).)

In this example, the control circuit 3606 also operably couples to a network interface 3610. So configured, the control circuit 3606 can communicate with other elements (both within the system 3600 and external thereto) via the network interface 3610. Network interfaces, including both wireless and non-wireless platforms, are well understood in the art and require no particular elaboration here. This network interface 3610 can compatibly communicate via whatever network or networks 3612 may be appropriate to suit the particular needs of a given application setting. Both communication networks and network interfaces are well understood areas of prior art endeavor and therefore no further elaboration will be provided here in those regards for the sake of brevity.

As shown in FIG. 36, the control circuit 3606 may be communicatively coupled (such as via server 3613) to various databases, such as a customer database 3614, a sales database 3616, and a merchandise database 3618. These databases may be used to create and determine a promotion database 3620 and a bidding database 3622 (which may be sub-databases of the merchandise database 3618). The customer database 3614 may include information such as customer value vectors indicating the customer's values and preferences (and generated in the manner described above) or such as customer purchase history. The sales database 3616 may include information regarding the sales of various merchandise and may (in conjunction with the merchandise database 3618) be used to determine low selling merchandise that may be the subject of promotions to customers and requests for bidding from customers. The merchandise database 3618 may also include product value vectors that may be useful in matching certain products to customer value vectors. As should be evident, these types of databases are just one example of an arrangement of databases, and other types and arrangements of databases and sub-databases are also possible.

In one form, the control circuit 3606 is configured to identify a first subset of merchandise at the store from the merchandise database 3618 with sales that are below a first threshold of target sales but that are above a second threshold of target sales. In other words, the control circuit 3606 may identify merchandise with sales that may be “below average” but that are still providing some sales. As addressed further below, it is generally contemplated that this first subset of merchandise with “below average” sales may be included in the promotion database 3620. This merchandise may be initially advertised or promoted to the mobile devices 3604 of in-store customers (and optionally may then be later offered for bid to the customer if the customer does not respond to the promotion).

In this form, the control circuit 3606 is further configured to identify a second subset of merchandise at the store from the merchandise database 3618 with sales below the second threshold of target sales. In other words, the control circuit 3606 may identify merchandise with sales that are selling very poorly and that are providing an insufficient amount of sales. As addressed further below, it is generally contemplated that this second subset of merchandise with “insufficient” sales may be included in the bidding database 3622. Bid solicitations for this merchandise may be directed to the mobile devices 3604 of in-store customers.

The control circuit 3606 is further configured to identify a third subset of merchandise at the store from the merchandise database 3618 of returned or damaged merchandise. In other words, the control circuit 3606 may identify certain specific categories of merchandise, such as returned merchandise, damaged merchandise, seasonal items, etc. As addressed further below, it is generally contemplated that this third subset of merchandise may be added to the bidding database 3622 (in addition to the second subset). Bid solicitations for this merchandise may be directed to the mobile devices 3604 of in-store customers.

In addition, the control circuit 3606 is configured to identify characteristics relating to the customer and to identify a fourth subset of merchandise for promotion and bidding corresponding to the characteristics relating to the customer. It is contemplated that this identification of the fourth subset of merchandise (merchandise that is likely to be of interest to the customer) may be accomplished in several ways. In one way, as described above, the control circuit 3606 may use customer value vectors to determine the merchandise for promotion and bidding. For example, the control circuit 3606 may access partiality information for customers and use that partiality information to form corresponding partiality vectors for customers wherein each partiality vector has a magnitude that corresponds to a magnitude of the customer's belief in an amount of good that comes from an order associated with that partiality (and store them in customer database 3614). The control circuit 3606 may be further configured to form counterpart merchandise vectors wherein the counterpart vectors have a magnitude that represents to the degree which each of the merchandise pursues a corresponding partiality (and store them in merchandise database 3618). It may also be configured to receive identification information regarding the customer and access the customer's partiality vectors, the customer's partiality vectors constituting the characteristics relating to the customer; and determine merchandise vectors corresponding to the customer's partiality vectors to determine the fourth subset of the merchandise for promotion and bidding. The identification information of the customer may take any of various forms, such as, for example, a customer logging into a software application or store server via the customer's mobile device 3604.

However, it is also contemplated that the identification of the fourth subset of merchandise may occur in other ways (without the use of value vectors). For instance, the system 3600 may include sensor(s) 3624 to track in-store customer location to determine the fourth subset of merchandise for promotion and bidding. The sensor(s) may be used to determine a location of the customer in the store such that the characteristics relating to the customer (for identifying the fourth subset of merchandise) are the location of the customer in the store. The sensor(s) 3624 may comprise an array of imaging sensors 3626 arranged about the store so as to capture images of the customer in the store. The imaging sensors 3626 may be used to determine the location of the customer in the store, and the fourth subset of merchandise for promotion and bidding may be merchandise located near the customer or merchandise the customer is examining. Alternatively, the sensor(s) 3624 may comprise one or more GPS sensor(s) 3628 to determine the location of the mobile device 3604 of the customer. Again, this GPS information may be used to determine the fourth subset of merchandise for promotion and bidding, such as merchandise near the customer or being examined in the store. As an example, if the customer is in the sporting goods department, the customer may receive product alerts about damaged or returned sporting goods.

As another example, the control circuit 3606 may use customer demographic information or shopping history to determine merchandise for promotion and bidding. The customer may provide customer identification information to the control circuit 3606 when logging onto a software application on the customer's mobile device 3604. This customer identification information may then be used when accessing customer database 3614, which may contain demographic information and/or shopping history of the customer. The demographic information may be used to determine merchandise that is of interest generally to the customer population based on demographic groups (age, residence, hobbies, interests, etc.). Alternatively, the shopping history of the customer may be accessed to determine merchandise that has been of interest to and purchased by the customer in the past. This demographic information and/or shopping history may be used to generate a fourth subset of merchandise for promotion and bidding that is likely to be of interest to the customer.

Next, in this form, the control circuit 3606 may be configured to transmit a communication to the mobile device 3604 of the customer offering a merchandise item for sale that is in both the first and fourth subsets. In other words, the merchandise item will be both a “below average” selling item and an item that is likely to be of interest to the customer. This item will be advertised and promoted to the customer (it will not be offered for bidding at this stage but may be offered for bidding by the customer if no response is received).

In addition, the control circuit 3606 may transmit another communication to the mobile device 3604 of the customer requesting a bid on a merchandise item for bidding by the customer that is in one of the second and third subsets and in the fourth subset. In other words, the merchandise item will be an “insufficient” selling item, returned item, or damaged item, and it will also be an item that is likely to be of interest to the customer. The communication will request a bid from the customer for this item. It may include a suggested low price and may include a request for a bid by the customer of an even lower price.

After the control circuit 3606 transmits the communication(s) for promotion and/or bidding, it receives responses to the communication(s) from the mobile device 3604 of the customer. For example, in response to the promotion, the customer may purchase the promoted merchandise item, and in response to the request for bid, the customer may submit a bid for a certain merchandise item. In response to a request for a bid, the control circuit 3606 determines whether to accept a bid in any of various ways. For instance, the control circuit 3606 may compare the customer bid with a predetermined minimum price for that particular merchandise item. In other words, the control circuit 3606 may be configured to determine whether to accept the bid from the customer by determining whether it equals or exceeds a predetermined minimum price threshold. Further, in response to the customer bid, the control circuit 3606 may transmit an offer or counter-offer to the customer's mobile device 3604. For example, the control circuit 3606 may transmit a promotional offer if the customer does not respond to the communication requesting a bid or if a bid submitted by the customer does not equal or exceed the minimum price threshold.

As addressed above, it is generally contemplated that the system 3600 may also involve a customer shopping remotely online (rather than shopping in a physical store). In this regard, it is generally contemplated that the customer computing device 3604 is not limited to a mobile device but may include other computing devices that are suitable for remote online shopping (such as desktop computers). Also, in this regard, the electronic interface 3602 may be in the form of a retailer website that the customer may access for remote online shopping. In addition, as should be evident, the sensor(s) 3624 that may be used to determine a customer's location in a physical store to determine potential merchandise of interest to the customer would not be applicable. Otherwise, the discussion above for a customer shopping at a physical store generally applies and is incorporated herein.

In summary, in one particular form, it is contemplated that there will be two categories of merchandise: merchandise for advertisement/promotion to the customer and merchandise for the solicitation of customer bids. The merchandise for advertisement/promotion are included in the promotion database 3620, and the merchandise for the solicitation of customer bids are included in the bidding database 3622. Each category of merchandise is correlated to merchandise that is likely to be of interest to the customer (such as determined by value vectors, customer location in a physical store, customer demographic information, or customer purchase history). Promotional communications and/or communications for the solicitation of customer bids are then sent to the customer's computing device.

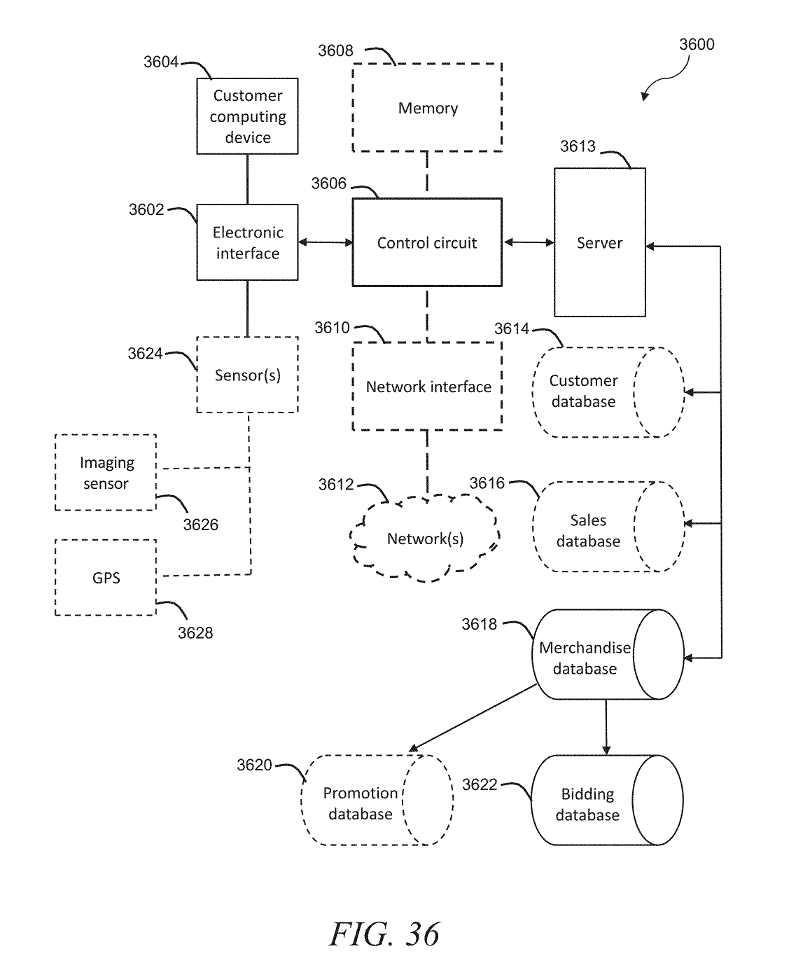

Referring to FIG. 37, there is shown a process 3700 for facilitating the promotion of merchandise and customer bidding on merchandise in stores. The process 3700 generally involves identifying merchandise suitable for promotion and merchandise suitable for solicitation of bids from customers. These categories are compared to customer characteristics to determine merchandise likely to be of interest to a customer. Communications are then transmitted in-store to the customer's mobile device. This process 3700 may use some or all of the components from system 3600 described above.

At block 3702, information is received regarding a customer. In one form, it is contemplated that a customer may use a mobile device to log onto a software application, retailer website, or store server. This log in activity may identify the customer and facilitate access to a customer database that may include information regarding the customer's value vectors, demographics, and purchase history. In addition, information regarding the customer may also include the customer's location in the store, which may be ascertained by various types of sensors (imaging sensors, GPS, etc.). All of this information may be useful in determining the promotional merchandise and merchandise for bid to be directed to the customer.

At block 3704, a first subset of merchandise is identified regarding merchandise that is to be the subject of in-store promotion/advertisement to customers. It is generally contemplated that this first subset may be determined using merchandise and sales databases to determine merchandise having an intermediate or “below average” amount of sales. This first subset of merchandise may be added to a promotion database. It is generally contemplated that sales of this first subset of merchandise need to be promoted but that sales are not so low that the merchandise needs to be offered out for bid by the customer.

At block 3706, a second subset of merchandise is identified regarding merchandise that is to be the subject of in-store bidding by customers. It is generally contemplated that that the second subset may be determined using merchandise and sales database to determine merchandise having a low or “insufficient” amount of sales. This second subset of merchandise may be added to a bidding database. It is generally contemplated that sales of this second subset of merchandise are so low that additional effort may be needed to reduce inventory, including soliciting customers to make bids on the merchandise.

At block 3708, a third subset of merchandise is identified regarding merchandise that is to be the subject of in-store bidding by customers (in addition to the second subset). It is generally contemplated that that the third subset includes special categories of merchandise that it may be desirable to sell at reduce prices, such as returned merchandise, damaged merchandise, seasonal items, etc. At block 3710, this third subset of merchandise may be added to the bidding database (in addition to the second subset).

At block 3712, a fourth subset of merchandise is identified for promotion and bidding based on characteristics of the customer. It is generally contemplated that non-specific and non-targeted promotions and solicitations for bid are less likely to be effective than more customer-specific and customer targeted promotions and solicitations. In this regard, it is desirable to determine merchandise that may be of interest to the customer based on any of various customer characteristics. For example, these characteristics (such as customer value vectors, demographic information, and purchase history) may be accessible if the customer provides identification information when using his mobile phone to log into a software application, retailer website, or store server. Also, such characteristics may be based on the customer's location in the store and proximity to certain types of merchandise.

At block 3714, a communication is transmitted to the customer offering a merchandise item for sale that is in both the first and fourth subsets. Such merchandise items have and intermediate amount of sales and are determined to possibly be of interest to the targeted customer (based on customer value vectors, demographics, purchase history, or location in the store). It is desirable to advertise/promote such merchandise to the customer.

At block 3716, a communication is transmitted to the customer requesting a bid on an item in the second or third subsets that is also in the fourth subset. The retailer may be most desirous of selling such merchandise (low sales, damaged, returned, seasonal, etc.). Such items have also been determined as being of possible interest to the customer. So, communications containing requests for bidding by the customer are targeted to the customer.

At block 3718, customer response(s) may be received to the communication(s). For example, the customer may decide to purchase an advertised/promoted offer at the suggested retail price. Alternatively, in response to a solicitation for bid, the customer may make an offer to purchase at some arbitrary price determined by the customer. At block 3720, in the event of a customer bid, a determination is made whether to accept the bid from the customer. One approach, for example, would be to accept the bid as long as it is above a certain minimum price threshold, which may be determined on a product-by-product basis, or possibly as a percentage of the suggested retail price of the product. Further, a counter-offer may be transmitted to the customer if a determination is made not to accept the customer's bid.

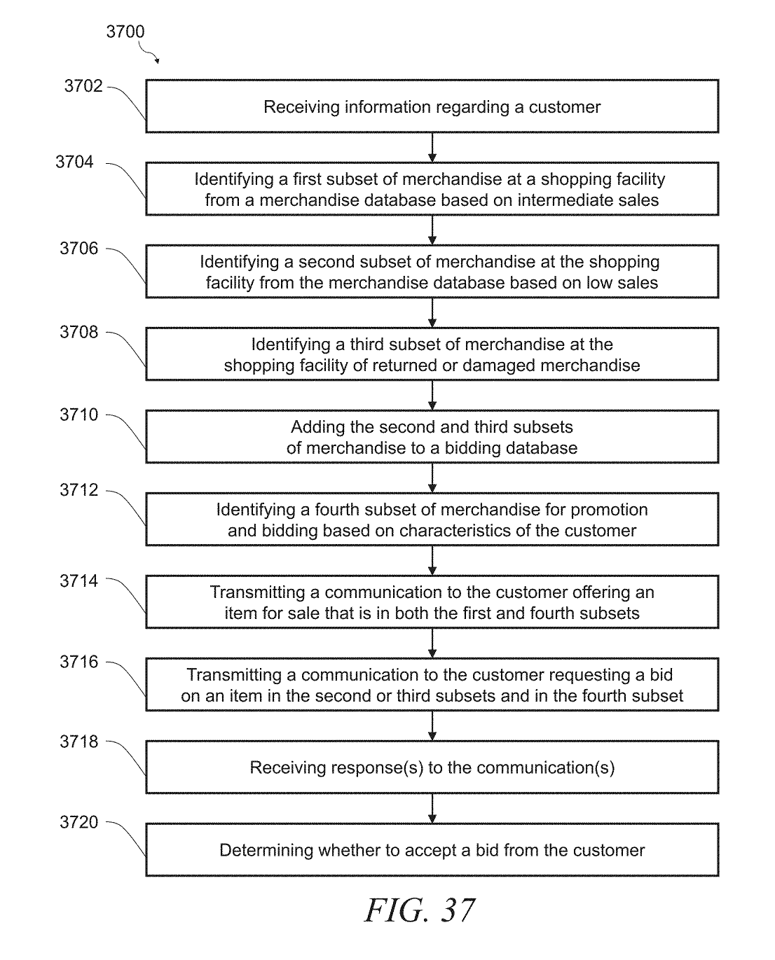

Referring to FIG. 38, there is shown a process 3800 for a customer to access an in-store bidding system and to bid on a merchandise item. The process 3800 generally involves identifying merchandise suitable for solicitation of bids from customers. These solicitations for bid are made accessible to or transmitted in-store to a customer's mobile device. This process 3800 may use some or all of the components from system 3600 described above.

At block 3802, access is provided to an existing in-store bidding system. It is generally contemplated that an in-store bidding system has been established at certain retailer stores. This in-store bidding system is controlled and operated via a system network 3804 at the store that governs the operation of the bidding system. This system network 3804 is generally similar to the control circuit 3606 describe above.

As shown in FIG. 38, the system network 3804 is operatively coupled to an inventory database 3806, a bidding database 3808, and a point-of-sale (POS) system 3810. In one form, it is generally contemplated that the merchandise suitable for the solicitation of bids may be determined by the quantities of merchandise in the inventory database 3806. For example, if quantities of certain types of merchandise are above a certain maximum threshold, it may be desirable to add this merchandise to the bidding database 3808 for solicitation of bids from customers.

At block 3812, a customer logs in to a software application while in a store using his smartphone. As shown at block 3814, this software application allows access to the in-store bidding system. This log in provides customer identification information, which may be used by the system network 3804 to solicit customer bids based on characteristics of the customer. These characteristics (value vectors, demographics, purchase history, etc.) may be useful to identify merchandise that is likely to be of interest to specific customers. The customer may use the software application to access a bidding webpage listing this merchandise that is available for bidding by the customer. Alternatively, this merchandise may be the subject of requests for solicitation that are transmitted to customers' smartphones.

At block 3816, the customer bids or buys at a fixed price merchandise available in the store. In one form, merchandise may be made available at a suggested purchase price either on the bidding webpage accessible by the software application or in a communication to the customer's smartphone. However, the bidding webpage or communication may also provide an alternative option for the customer to make an offer if the customer does not want to pay the suggested purchase price.

As indicated in blocks 3818 and 3820, certain types of merchandise that the store is especially desirous of selling are targeted to customers based on likely customer interest in this merchandise. Block 3818 indicates that the merchandise may include, for example, slow moving merchandise, deleted merchandise, manufacturer discontinued merchandise, local specials, and feature buys. The store is interested in reducing inventory in these categories and is therefore willing to entertain customer bids on this merchandise. Block 3820 indicates that the customer may be prompted, for example, based on customer value vectors, the customer's buying history, recent customer in-store scans of merchandise, and/or customer proximity to merchandise. Merchandise corresponding to one or more of these customer characteristics/categories are more likely to be of interest to the customer than randomly generated types of merchandise. The customer is more likely to bid on this merchandise.

At block 3822, after the customer has made a bid, the customer bid is accepted, and the customer picks up the merchandise in the store or places it on hold for subsequent pick up/delivery. As addressed above, the decision to accept the customer may be made based on various criteria, such as, for example, predetermined absolute minimum thresholds determined on a product-by-product basis, predetermined minimum percentages of the suggested retail price, or approval by an in-store employee. Payment may coordinated through the POS system 3810 and may involve the use of blockchain for authentication, as described further below.

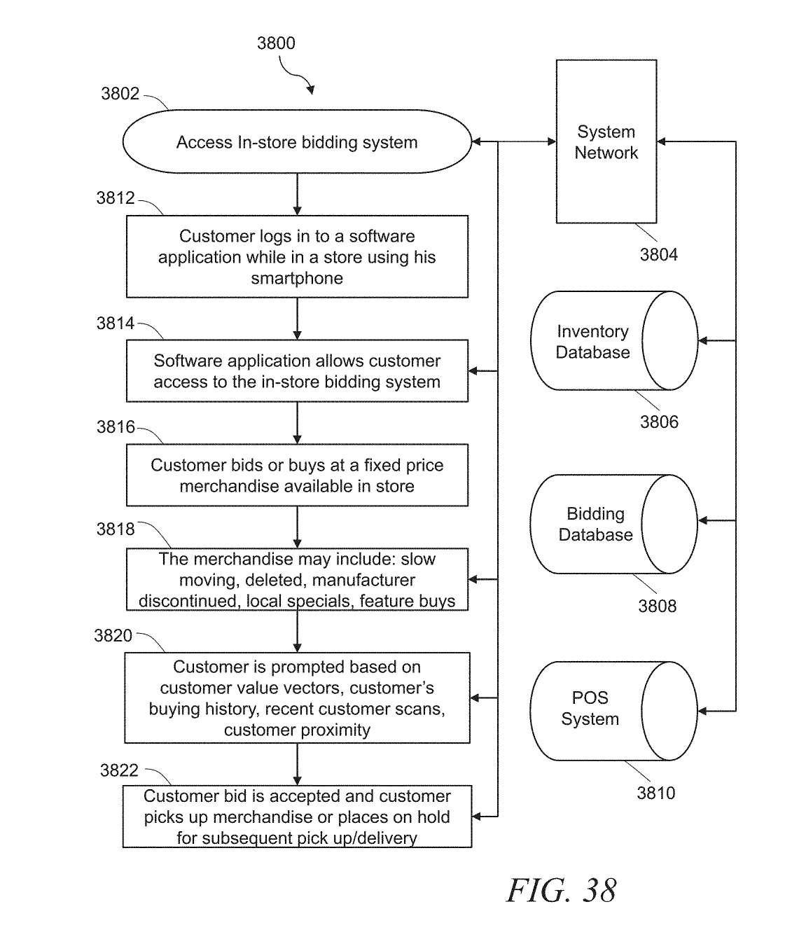

Referring to FIG. 39, there is shown an algorithm or decision tree of a process 3900 for the promotion and or solicitation for bid of merchandise. It is generally contemplated that this approach may be used in the context of in-store customers, but it may also be applied to online customers (i.e., customers not making purchases in physical stores). The flow diagram shows decisions as to when merchandise should be promoted and when it should be offered for bid. This process 3900 may incorporate some or all of the components from system 3600 described above.

Along the leftmost column of FIG. 39, there is shown the general approach of considering the individual characteristics of customers for the promotion and bidding process 3900. At block 3902, inventory is to be moved by aiming highly targeted promotions tailored to individual customers. At block 3904, a customer goes to a store (either physically or by remote online access). It is generally contemplated that the customer will log onto a software application or retailer website (either at the store or remotely) and will provide identification information that may be used to access data about the customer. At block 3906, the customer's shopping history is assessed and associated products are ranked. In addition to shopping history, it is also contemplated that value vectors and demographics may be used to provide additional products that may be ranked. At block 3908, ranked items are sorted by category, and the categories are arranged based on where the customer shops (either in the physical store or in the online store). In the case of a physical store, the location where the customer shops may be determined by sensor(s), such as GPS or imaging sensors (as described above with regard to system 3600).

Along the second column from the left, there is shown the general approach of considering the merchandise/inventory that needs to be moved for promotion and bidding. At block 3910, store inventory that has moved too slowly, been returned, or will expire has collected and accumulated. It is contemplated that the store inventory for promotion and bidding may be of various types: merchandise that has moved too slowly (low sales), has been returned, will expire in the near future, has been damaged, includes seasonal items, includes discontinued items, etc. At block 3912, the inventory that is to be promoted and/or offered for bid is electronically segregated in the inventory database or added to a new promotion/bidding database. At block 3914, the inventory to be promoted and/or offered for bid is sorted by priority. For example, perishable merchandise that is expiring in the near future may be given the highest priority, slow moving inventory may get intermediate priority, and returned merchandise may get the lowest priority.

At block 3916, the customer's ranked items (from block 3908) are parsed in priority order to include only items that are also ranked on the store promotion list (from block 3914). In other words, the merchandise of interest to the customer (block 3908) is compared against the inventory that needs to be sold (block 3914) to determine matches and to determine the priority of the matching items. For example, the matches in both the customer and inventory lists may initially be determined, the two priority rankings for each matched item may be added together, and a new priority order may be determined from the lowest sum to the highest sum.

At block 3918, the customer receives prioritized offers based on 1) shopping history, 2) where they are/have been in the store, and 3) store promotable-inventory. As indicated above, in addition to shopping history, it is also contemplated that value vectors and demographics may be used to determine the prioritize offers. Blocks 3920 to 3932 shows the decision making behind sending out specific types of prioritized offers to the customer.

At block 3920, a decision is made as whether a specific product should be put out to bid. As an example of one approach, perhaps the first ten ranked merchandise items are to be put out for bid to the customer (and the remaining ranked items may be the subject of promotions). Alternatively, as a second example, it may be decided that only certain merchandise types (such as sporting goods and apparel) will be put out for bid, while other merchandise types (such as grocery) will be put out for promotion.

At block 3922, if the decision is made to put out the specific product for bid, the customer is offered the opportunity to bid on the product. In one form, the solicitation for bid may be transmitted to the customer's mobile device, especially if the customer is shopping in a physical store. Alternatively, the solicitation for bid may be transmitted to some other computing device of the customer, especially if the customer is shopping remotely online. At block 3924, if the decision is that the product should be not be put out to bid, a promotion is offered for the product instead (and communicated to the customer).

At block 3926, it is determined whether the product sold. If the product was put out to bid, did the customer respond with a bid in acceptable parameters? The determination of acceptable parameters may be based, for example, on minimum acceptable prices established for various types of products. If a promotion was offered for the product instead, did the customer respond favorably to the promotion? If the product has sold, the sales transaction can be completed at block 3932. This sales transaction may involve authentication with blockchain, as addressed further below.

At block 3928, if the product did not sell, a counter-offer or other promotion may be communicated to the customer. For example, if the customer submitted a bid that was too low, a counter-offer may be transmitted to the customer that provides the minimum acceptable price for that product. The customer may decide to purchase the item at the minimum acceptable price. As another example, if the customer did not respond favorably to a first promotion provided at block 3924, a second (perhaps more favorable) promotion may be transmitted to the customer. The customer may then decide to respond more favorably to the second promotion.

At block 3930, it is determined whether the customer has accepted the counter-offer or responded favorably to the second promotion. If so, the sales transaction is completed at block 3932. If not, there may optionally be provided another counter-offer or a third promotion at block 3928. The submission of counter-offer and promotions to the customer may be repeated, as may be deemed appropriate.

In each of the embodiments, it is also contemplated that the customer bidding may be in the form of a multi-customer auction. For example, in one form, after merchandise of likely interest to one or more customers is identified, a product alert may be transmitted to the computing devices of customers. Alternatively, in another form, merchandise for auction may not be correlated to any specific customer interest but may instead be selected entirely from a prioritized list of merchandise that needs to be moved (i.e., low selling, returned, damaged, seasonal, manufacturer discontinued, local specials, feature buys, etc.). The product alert may indicate a certain product is available for purchase below the ordinary retail price and may solicit bids from a certain group of customers (such as all of the customers in the store). The auction may be conducted in a transparent manner such that all bids are shown to the participating customers (and optionally all auction items), and the customer with the highest bid when the auction expires may purchase the product. Further, the retailer may set a minimum sales price in advance (a “reserve” price), and if none of the bids reaches that amount, the product may remain unpurchased.

As mentioned above, the completion of the sales transaction may make use of blockchain technology. This approach may make use of a crypto-currency/blockchain system to facilitate the purchase and track the rights of the purchaser. This blockchain system is generally a peer-to-peer authentication system for valuable digitized items that allows online interactions directly between two or more parties without going through one or more trusted intermediaries. A peer-to-peer network timestamps actions, hashing them into an ongoing chain of hash-based proof-of-work code to form a record that cannot be changed without redoing the proof-of-work. The system allows digitized item use as intended based on cryptographic proof instead of trust, allowing any two or more willing parties to employ the content without the need to trust each other and without the need for a trusted third party.

In this context, one approach involving blockchain is described in connection with system 3600 and FIG. 36. In this system 3600, the control circuit 3606 may be configured to: receive a purchase request from the customer's mobile device 3604; relay messages between the customer's mobile device 3604 and the electronic interface 3602 comprising updates to a blockchain; and facilitate an electronic peer-to-peer payment transfer of a digital currency from the customer's mobile device 3604 to the electronic interface 3602. It is generally contemplated that this sales transaction occurs following promotion and bidding when the customer has decided to make a purchase. It is also contemplated that blockchain may also be used when there is to be a delivery of purchased merchandise to the customer's residence or other location or in connection with an auction.

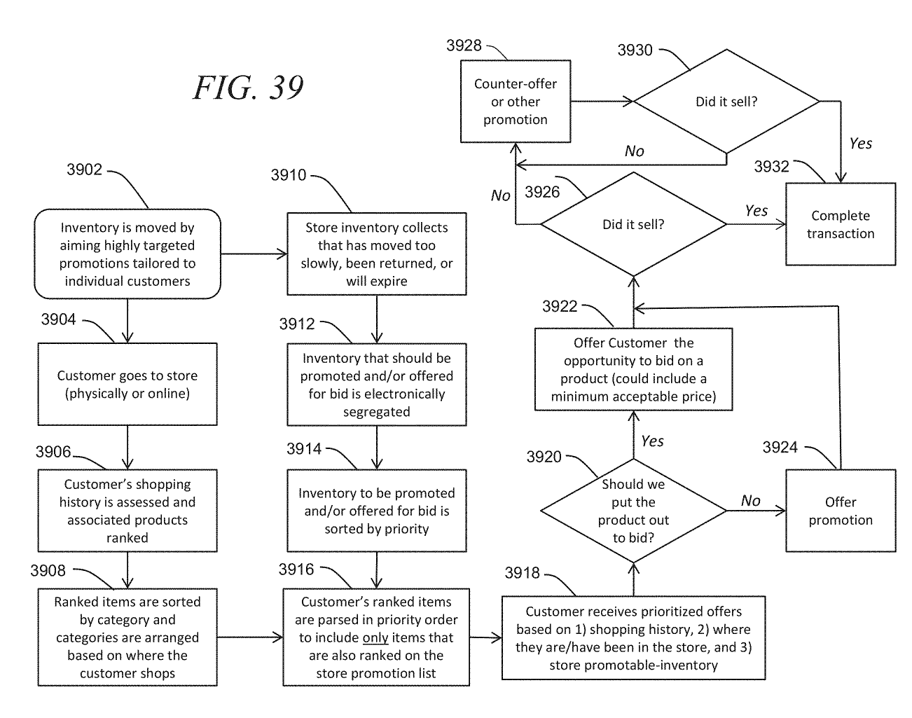

Descriptions of some embodiments of blockchain technology are provided with reference to FIGS. 40-45 herein. In some embodiments of the invention described above, blockchain technology may be utilized to record sales, deliveries, and auction details. One or more of the customer computing device and store systems described herein may comprise a node in a distributed blockchain system storing a copy of the blockchain record. Updates to the blockchain may comprise new data and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin. pdf), the entirety of which is incorporated herein by reference.

Now referring to FIG. 40, an illustration of a blockchain according to some embodiments is shown. In some embodiments, a blockchain comprises a hash chain or a hash tree in which each block added in the chain contains a hash of the previous block. In FIG. 40, block 0 4000 represents a genesis block of the chain. Block 1 4010 contains a hash of block 0 400, block 2 4020 contains a hash of block 1 4010, block 3 4030 contains a hash of block 2 4020, and so forth. Continuing down the chain, block N contains a hash of block N−1.

In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners’ are nodes that compete to provide proof-of-work to form a new block, and the first successful miner of a new block earns Bitcoin currency in return.

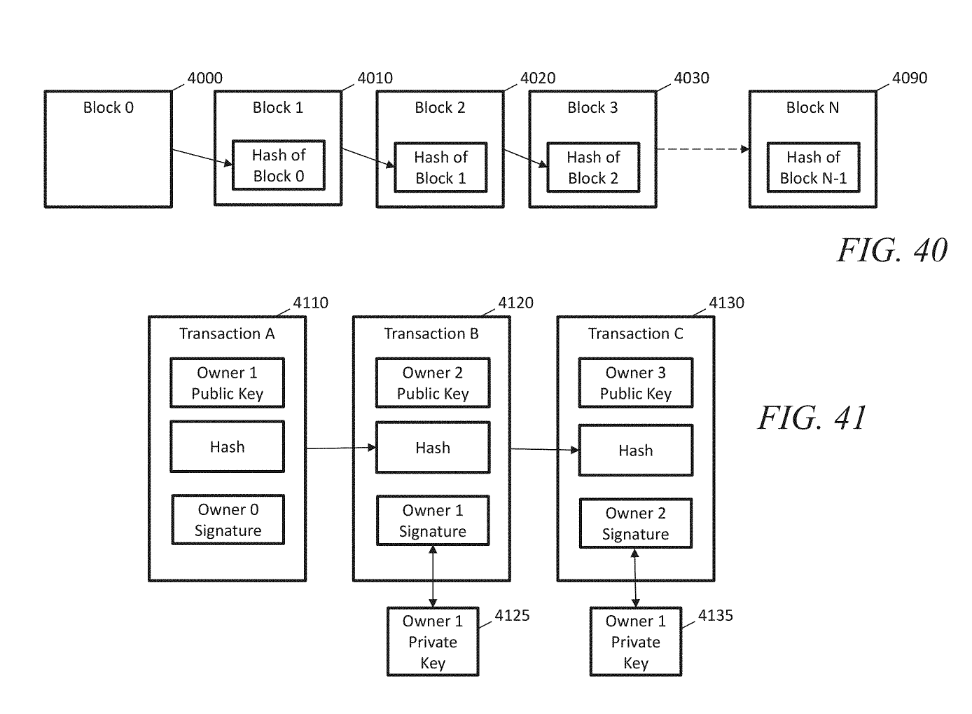

Now referring to FIG. 41, an illustration of blockchain based transactions according to some embodiments is shown. In some embodiments, the blockchain illustrated in FIG. 41 comprises a hash chain protected by private/public key encryption. Transaction A 4110 represents a transaction recorded in a block of a blockchain showing that owner 1 (recipient) obtained an asset from owner 0 (sender). Transaction A 4110 contains owner's 1 public key and owner 0's signature for the transaction and a hash of a previous block. When owner 1 transfers the asset to owner 2, a block containing transaction B 4120 is formed. The record of transaction B 4120 comprises the public key of owner 2 (recipient), a hash of the previous block, and owner 1's signature for the transaction that is signed with the owner 1's private key 4125 and verified using owner 1's public key in transaction A 510. When owner 2 transfers the asset to owner 3, a block containing transaction C 4130 is formed. The record of transaction C 4130 comprises the public key of owner 3 (recipient), a hash of the previous block, and owner 2's signature for the transaction that is signed by owner 2's private key 4135 and verified using owner 2's public key from transaction B 4120. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 41 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

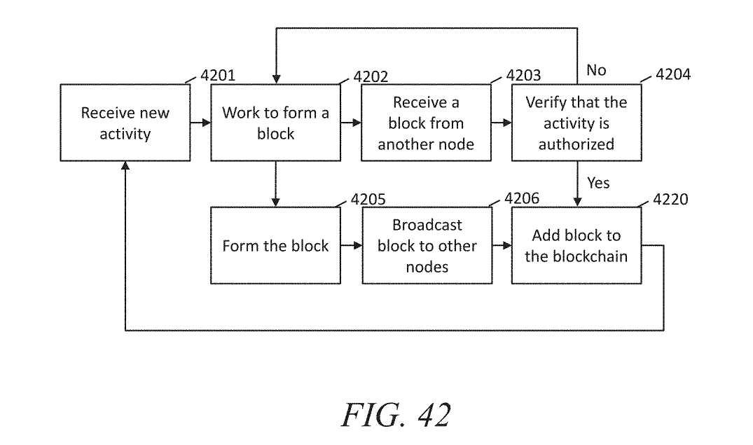

Now referring to FIG. 42, a flow diagram according to some embodiments is shown. In some embodiments, the steps shown in FIG. 42 may be performed by a processor-based device, such as a computer system, a server, a distributed server, a timestamp server, a blockchain node, and the like. In some embodiments, the steps in FIG. 42 may be performed by one or more of the nodes in a system using blockchain for record keeping.

In step 4201, a node receives a new activity. The new activity may comprise an update to the record being kept in the form of a blockchain. In some embodiments, for blockchain supported digital or physical asset record keeping, the new activity may comprise a asset transaction. In some embodiments, the new activity may be broadcasted to a plurality of nodes on the network prior to step 4201. In step 4202, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 4202, if the node successfully forms a block in step 4205 prior to receiving a block from another node, the node broadcasts the block to other nodes over the network in step 4206. In some embodiments, in a system with incentive features, the first node to form a block may be permitted to add incentive payment to itself in the newly formed block. In step 4220, the node then adds the block to its copy of the blockchain. In the event that the node receives a block formed by another node in step 4203 prior to being able to form the block, the node works to verify that the activity recorded in the received block is authorized in step 4204. In some embodiments, the node may further check the new block against system consensus rules for blocks and activities to verify whether the block is properly formed. If the new block is not authorized, the node may reject the block update and return to step 4202 to continue to work to form the block. If the new block is verified by the node, the node may express its approval by adding the received block to its copy of the blockchain in step 4220. After a block is added, the node then returns to step 4201 to form the next block using the newly extended blockchain for the hash in the new block.

In some embodiments, in the event one or more blocks having the same block number is received after step 4220, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 4201.

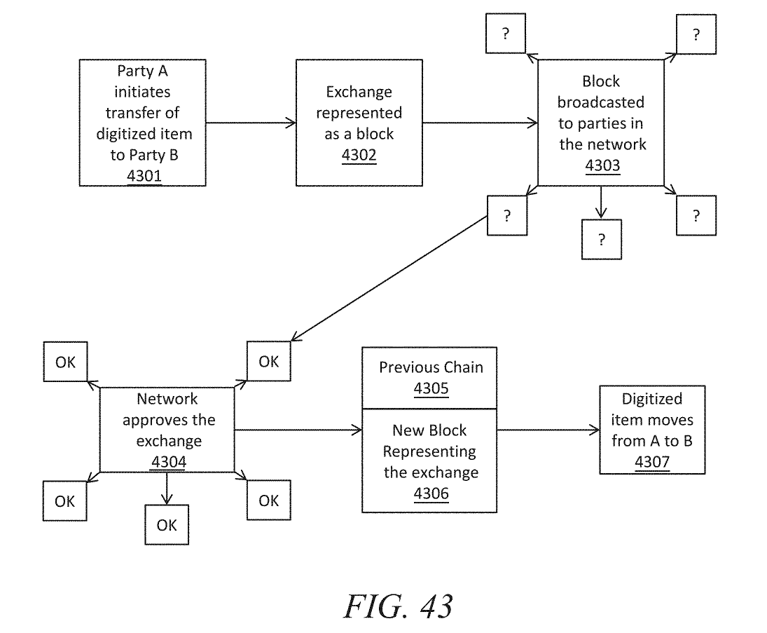

Now referring to FIG. 43, a process diagram a blockchain update according to some implementations in shown. In step 4301, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 4302, the exchange initiated in step 4301 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 4303, the block is broadcasted to parties in the network. In step 4304, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 4306 representing the exchange is added to the existing chain 4305 comprising blocks that chronologically precede the new block 4306. The new block 4306 may contain the transaction(s) and a hash of one or more blocks in the existing chain 4305. In some embodiments, each node may then update their copy of the blockchain with the new block and continue to work on extending the chain with additional transactions. In step 4307, when the chain is updated with the new block, the digitized item is moved from party A to party B.

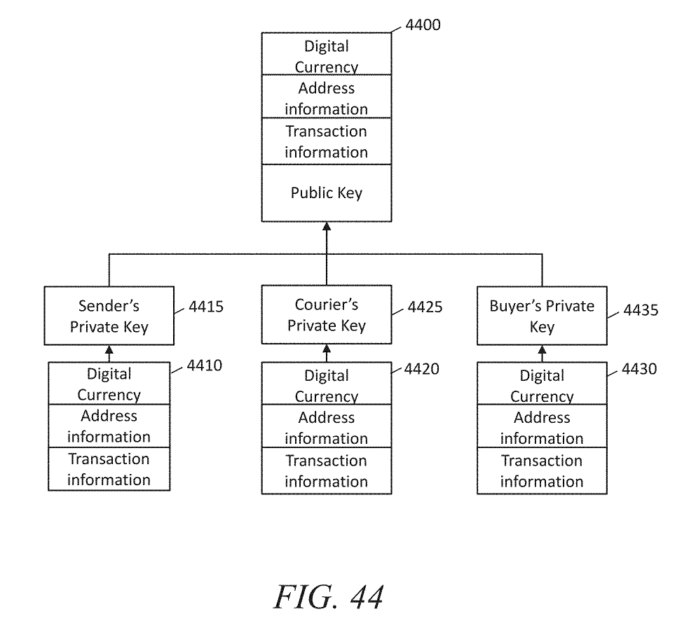

Now referring to FIG. 44, a diagram of a blockchain according to some embodiments in shown. FIG. 44 comprises an example of an implementation of a blockchain system for delivery service record keeping. The delivery record 4400 comprises digital currency information, address information, transaction information, and a public key associated with one or more of a sender, a courier, and a buyer. In some embodiments, nodes associated the sender, the courier, and the buyer may each store a copy of the delivery record 4410, 4420, and 4430 respectively. In some embodiments, the delivery record 4400 comprises a public key that allows the sender, the courier, and/or the buyer to view and/or update the delivery record 4400 using their private keys 4415, 4425, and the 4435 respectively. For example, when a package is transferred from a sender to the courier, the sender may use the sender's private key 4415 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 4425 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 44, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

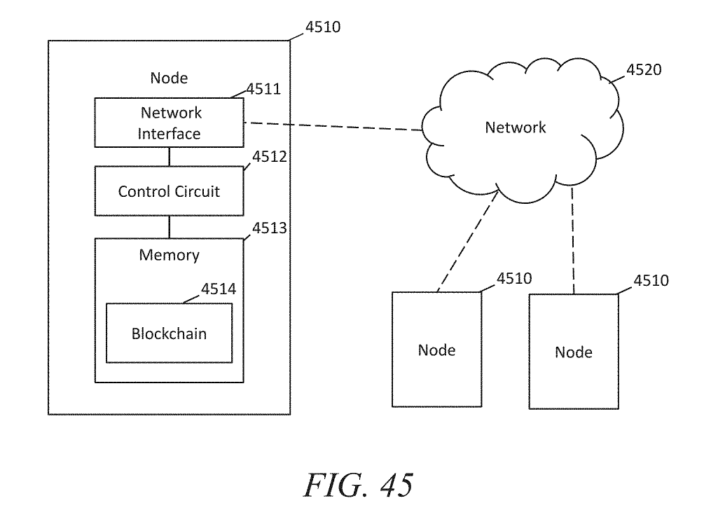

Now referring to FIG. 45, a system according to some embodiments is shown. A distributed blockchain system comprises a plurality of nodes 4510 communicating over a network 4520. In some embodiments, the nodes 4510 may be comprise a distributed blockchain server and/or a distributed timestamp server. In some embodiments, one or more nodes 4510 may comprise or be similar to a “miner” device on the Bitcoin network. Each node 4510 in the system comprises a network interface 4511, a control circuit 4512, and a memory 4513.

The control circuit 4512 may comprise a processor, a microprocessor, and the like and may be configured to execute computer readable instructions stored on a computer readable storage memory 4513. The computer readable storage memory may comprise volatile and/or non-volatile memory and have stored upon it a set of computer readable instructions which, when executed by the control circuit 4512, causes the node 4510 update the blockchain 4514 stored in the memory 4513 based on communications with other nodes 4510 over the network 4520. In some embodiments, the control circuit 4512 may further be configured to extend the blockchain 4514 by processing updates to form new blocks for the blockchain 4514. Generally, each node may store a version of the blockchain 4514, and together, may form a distributed database. In some embodiments, each node 4510 may be configured to perform one or more steps described with reference to FIGS. 42 and 43 herein.

The network interface 4511 may comprise one or more network devices configured to allow the control circuit to receive and transmit information via the network 4520. In some embodiments, the network interface 4511 may comprise one or more of a network adapter, a modem, a router, a data port, a transceiver, and the like. The network 4520 may comprise a communication network configured to allow one or more nodes 4510 to exchange data. In some embodiments, the network 4520 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

Some embodiment provide systems for promotion and customer bidding on merchandise at shopping facilities. At least some of such systems comprises: an electronic interface configured to transmit information regarding merchandise for bidding to a customer's mobile device at a shopping facility and to receive information regarding characteristics of the customer; and a control circuit operatively coupled to the electronic interface, the control circuit configured to: identify a first subset of merchandise at the shopping facility from a merchandise database with sales below a first predetermined threshold of target sales but above a second predetermined threshold of target sales; identify a second subset of merchandise at the shopping facility from the merchandise database with sales below the second predetermined threshold of target sales; identify a third subset of merchandise at the shopping facility from the merchandise database of returned or damaged merchandise; add the second and third subsets of merchandise to a bidding database; identify characteristics relating to the customer; identify a fourth subset of merchandise for promotion and bidding corresponding to the characteristics relating to the customer; transmit a first communication to the mobile device of the customer offering a merchandise item for sale that is in both the first and fourth subsets; transmit a second communication to the mobile device of the customer requesting a bid on a merchandise item for bidding by the customer that is in one of the second and third subsets and in the fourth subset; receive responses to the first and second communications from the customer; and determine whether to accept a bid from the customer if the customer submits a bid in response to the second communication.

In some implementations, the electronic interface comprises a server at the shopping facility or a retailer website. Some systems may further comprise: a sensor configured to determine a location of the customer in the shopping facility; wherein the characteristics relating to the customer are the location of the customer in the shopping facility. One or more sensors may comprise an imaging sensor configured to capture images of the customer in the shopping facility and a GPS sensor configured to determine a location of the mobile device of the customer. In some embodiments, systems may comprise: a customer database containing at least one of demographic information of the customer and shopping history of the customer; wherein the characteristics relating to the customer are at least one of demographic information of the customer and shopping history of the customer. The control circuit can, in some embodiments, be configured to: access partiality information for customers and to use that partiality information to form corresponding partiality vectors for customers wherein the partiality vector has a magnitude that corresponds to a magnitude of the customer's belief in an amount of good that comes from an order associated with that partiality. In some instances, the control circuit is further configured to: form counterpart merchandise vectors wherein the counterpart vectors have a magnitude that represents to the degree which each of the merchandise pursues a corresponding partiality. The control circuit may further be configured to: receive identification information regarding the customer and access the customer's partiality vectors, the customer's partiality vectors constituting the characteristics relating to the customer; and determine merchandise vectors corresponding to the customer's partiality vectors to determine the fourth subset of the merchandise for promotion and bidding.

In some embodiments, the control circuit is configured to: determine whether to accept the bid from the customer by determining whether it equals or exceeds a predetermined minimum price threshold. The control circuit, in some implementations, is configured to: transmit a promotional offer to the mobile device of the customer if the customer does not respond to the communication requesting a bid or if a bid submitted by the customer does not equal or exceed a predetermined minimum price threshold. The control circuit may be configured to: receive a purchase request from the customer's mobile device; relay messages between the customer's mobile device and the electronic interface comprising updates to a blockchain; and facilitate an electronic peer-to-peer payment transfer of a digital currency from the customer's mobile device to the electronic interface.

Some embodiments provide methods for customer bidding on merchandise at shopping facilities, comprising: by an electronic interface, transmitting information regarding merchandise for bidding to a customer's mobile device at a shopping facility and receiving information regarding characteristics of the customer; and by a control circuit: identifying a first subset of merchandise at the shopping facility from a merchandise database with sales below a first predetermined threshold of target sales but above a second predetermined threshold of target sales; identifying a second subset of merchandise at the shopping facility from the merchandise database with sales below the second predetermined threshold of target sales; identifying a third subset of merchandise at the shopping facility from the merchandise database of returned or damaged merchandise; adding the second and third subsets of merchandise to a bidding database; identifying characteristics relating to the customer; identifying a fourth subset of merchandise for promotion and bidding corresponding to the characteristics relating to the customer; transmitting a first communication to the mobile device of the customer offering a merchandise item for sale that is in both the first and fourth subsets; transmitting a second communication to the mobile device of the customer requesting a bid on a merchandise item for bidding by the customer that is in one of the second and third subsets and in the fourth subset; receiving responses to the first and second communications from the customer; and determining whether to accept a bid from the customer if the customer submits a bid in response to the second communication. In some implementations, one or more methods may comprise, by the control circuit: accessing partiality information for customers and to use that partiality information to form corresponding partiality vectors for customers wherein the partiality vector has a magnitude that corresponds to a magnitude of the customer's belief in an amount of good that comes from an order associated with that partiality. Some embodiments form counterpart merchandise vectors wherein the counterpart vectors have a magnitude that represents to the degree which each of the merchandise pursues a corresponding partiality.

In some embodiments, one or more methods comprise, by the control circuit: receiving identification information regarding the customer and access the customer's partiality vectors, the customer's partiality vectors constituting the characteristics relating to the customer; and determining merchandise vectors corresponding to the customer's partiality vectors to determine the fourth subset of the merchandise for promotion and bidding. Some embodiments determine whether to accept the bid from the customer by determining whether it equals or exceeds a predetermined minimum price threshold. Further, one or more methods may comprise, by the control circuit: transmitting a promotional offer to the mobile device of the customer if the customer does not respond to the communication requesting a bid or if a bid submitted by the customer does not equal or exceed a predetermined minimum price threshold. In some implementations, one or more methods of comprise, by the control circuit: receiving a purchase request from the customer's mobile device; relaying messages between the customer's mobile device and the electronic interface comprising updates to a blockchain; and facilitating an electronic payment transfer of a digital currency from the customer's mobile device to the electronic interface.

Some embodiments provide systems for customer bidding on merchandise comprising: a retailer website configured to receive identification information regarding a customer from a customer computing device and to transmit information regarding merchandise for bidding to the customer's computing device; a customer database containing characteristics relating to the customer comprising at least one of demographic information of the customer, shopping history of the customer, and the customer's preferences; a control circuit operatively coupled to the retailer website and the customer database, the control circuit configured to: identify a first subset of merchandise from a merchandise database with sales below a first predetermined threshold of target sales but above a second predetermined threshold of target sales; identify a second subset of merchandise from the merchandise database with sales below the second predetermined threshold of target sales; identify a third subset of merchandise from the merchandise database of returned or damaged merchandise; add the second and third subsets of merchandise to a bidding database; identify characteristics relating to the customer from the customer database; identify a fourth subset of the merchandise for promotion and bidding corresponding to the characteristics relating to the customer; transmit a first communication to the customer computing device offering a merchandise item for sale that is in both the first and fourth subsets; transmit a second communication to the customer computing device requesting a bid on a merchandise item for bidding by the customer that is in one of the second and third subsets and in the fourth subset; receive responses to the first and second communication from the customer; and determine whether to accept a bid from the customer if the customer submits a bid in response to the second communication.

In some embodiments, apparatuses and methods are provided herein useful for promotion and customer bidding on merchandise at shopping facilities. In some embodiments, the system includes: an electronic interface for transmitting information regarding merchandise for promotion and bidding to a customer's mobile device at a shopping facility; and a control circuit that: identifies merchandise at the shopping facility for promotion and bidding based on sales and returned or damaged merchandise; adds certain merchandise to a bidding database; identifies characteristics relating to the customer; identifies merchandise corresponding to the characteristics relating to the customer; transmits a first communication to the customer's mobile device offering a merchandise item for sale; transmits a second communication to the customer's mobile device requesting a bid on a merchandise item; receives responses to the first and second communications; and determines whether to accept a bid from the customer if the customer submits a bid.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept. As one example in these regards, these teachings will accommodate the ability to revisit a prior decision that observed contrary behavior was, or was not, irrational and come to a different conclusion based on later-received/observed information regarding the person's behaviors.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801, filed Apr. 18, 2017; 62/510,322, filed May 24, 2017; 62/510,317, filed May 24, 2017; Ser. No. 15/606,602, filed May 26, 2017; 62/513,490, filed Jun. 1, 2017; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017; 62/542,896 filed Aug. 9, 2017; Ser. No. 15/678,608 filed Aug. 16, 2017; 62/548,503 filed Aug. 22, 2017; 62/549,484 filed Aug. 24, 2017; Ser. No. 15/685,981 filed Aug. 24, 2017; 62/558,420 filed Sep. 14, 2017; Ser. No. 15/704,878 filed Sep. 14, 2017; and 62/559,128 filed Sep. 15, 2017.

What is claimed is:

1. A system for customizing content of a billboard comprising:
a partiality vector database having stored therein:
information including partiality information for each of a plurality of travelers in a form of a plurality of partiality vectors for each of the plurality of travelers, wherein each of the partiality vectors has at least one of a magnitude and an angle that corresponds to a magnitude of the traveler's belief in an amount of good that comes from an order associated with that partiality;
a selector control circuit coupled to the partiality vector database, the selector control circuit configured to:
receive traveler data information of the plurality of travelers associated with a plurality of geo-fence locations;
identify a set of travelers of the plurality of travelers that passes, within a period of time, a particular geo-fence location of the plurality of geo-fence locations based on the traveler data information;
access the partiality vector database to determine a set of partiality vectors of the plurality of partiality vectors associated with the set of travelers;
determine a rank for each of the set of partiality vectors, wherein the rank is based on a frequency distribution of the set of partiality vectors; and
select one or more partiality vectors of the set of partiality vectors based on the rank; and
a billboard control circuit communicatively coupled to the selector control circuit, the billboard control circuit configured to:
receive a notification of the one or more selected partiality vectors;
access a billboard content database to determine a content of a plurality of available contents, wherein the content is associated with at least one product having a particular vectorized characterizations of a plurality of vectorized characterizations in accordance with a threshold alignment of the one or more selected partiality vectors; and
provide the content to a billboard interface associated with the particular geo-fence location.

2. The system of claim 1, further comprising the billboard content database having stored therein the plurality of vectorized characterizations for each product associated with each of the plurality of available contents, wherein each of the vectorized characterizations indicates a measure regarding an extent to which a corresponding product of one of the plurality of available contents accords with a corresponding one of the plurality of partiality vectors.

3. The system of claim 2, wherein the billboard control circuit is further configured to compare, at a first time, each of the one or more selected partiality vectors to each of the plurality of vectorized characterizations using vector dot product calculations to determine the content at the first time.

4. The system of claim 3, wherein the traveler data information comprises purchase histories of the plurality of travelers, wherein the selector control circuit is further configured to:
determine whether particular purchase histories of the purchase histories is associated with at least one of: a product or a service associated with the content determined at the first time; and
in response to the determination that the particular purchase histories are associated with the content determined at the first time, assign a weighting value to each of the one or more selected partiality vectors, and
wherein the billboard control circuit is further configured to:
compare, at a second time, each of the one or more selected partiality vectors having the assigned weighting value to each of the plurality of vectorized characterizations using the vector dot product calculations, wherein the weighting value correspond to effectiveness of advertising on a billboard associated with the billboard interface;
determine a second content based on the comparison at the second time; and
provide the second content to the billboard interface.

5. The system of claim 4, wherein each time the weighting value is assigned, the selector control circuit is further configured to increase a weighting value tracker corresponding to the billboard associated with the billboard interface, and wherein the weighting value tracker indicates overall effectiveness of advertising on the billboard.

6. The system of claim 1, wherein the selector control circuit is further configured to:
assign a weighting value to each of the one or more selected partiality vectors based on a determination that particular purchase histories of the plurality of travelers is associated with a previous content provided to a billboard associated with the billboard interface, wherein the traveler data information comprises the particular purchase histories; and
increase a weighting value tracker corresponding to the billboard, and wherein the weighting value tracker indicates overall effectiveness of advertising on the billboard.

7. The system of claim 1, wherein the selector control circuit and the billboard control circuit are part of a distributed computing environment.

8. The system of claim 1, wherein the selector control circuit in determining the set of partiality vectors is further configured to identify whether each partiality vector of the set of partiality vectors has a particular magnitude that is equal to or greater than a respective first threshold.

9. The system of claim 1, wherein the selector control circuit is further configured to:
determine the frequency distribution of each partiality vector of the set of partiality vectors based on a number of travelers that are associated with each partiality vector of the set of partiality vectors;
determine a percent distribution of each partiality vector of the set of partiality vectors based on the frequency distribution; and
determine at least one particular partiality vector of the set of partiality vectors that has a particular percent distribution of the determined percent distribution, wherein the particular percent distribution comprises a percent value that is equal to or greater than a second threshold, and wherein the determining of the rank is based on the particular percent distribution.

10. A method for customizing content of a billboard comprising:
receiving traveler data information of a plurality of travelers associated with a plurality of geo-fence locations;
identifying a set of travelers of the plurality of travelers that passes, within a period of time, a particular geo-fence location of the plurality of geo-fence locations based on the traveler data information;
accessing a partiality vector database to determine a set of partiality vectors of a plurality of partiality vectors associated with the set of travelers, wherein the partiality vector database having stored therein:
information including partiality information for each of the plurality of travelers in a form of the plurality of partiality vectors for each of the plurality of travelers, wherein the partiality vector has at least one of a magnitude and an angle that corresponds to a magnitude of the traveler's belief in an amount of good that comes from an order associated with that partiality;
determining a rank for each of the set of partiality vectors, wherein the rank is based on a frequency distribution of the set of partiality vectors; and
selecting one or more partiality vectors of the set of partiality vectors based on the rank.

11. The method of claim 10, further comprising:
receiving a notification of the one or more selected partiality vectors;
accessing a billboard content database to determine a content of a plurality of available contents, wherein the content is associated with at least one product having a particular vectorized characterizations in accordance with a threshold alignment of the one or more selected partiality vectors; and
providing the content to a billboard interface associated with the particular geo-fence location.

12. The method of claim 11, wherein the billboard content database having stored therein a plurality of vectorized characterizations of products associated with each of the plurality of available contents, wherein each of the vectorized characterizations indicates a measure regarding an extent to which a corresponding product of one of the plurality of available contents accords with a corresponding one of the plurality of partiality vectors.

13. The method of claim 12, further comprising comparing, at a first time, each of the one or more selected partiality vectors to each of the plurality of vectorized characterizations using vector dot product calculations to determine the content at the first time.

14. The method of claim 13, wherein the traveler data information comprises purchase histories of the plurality of travelers, and further comprising:
determining whether particular purchase histories of the purchase histories is associated with at least one of: a product or a service associated with the content determined at the first time;
in response to the determining that the particular purchase histories are associated with the content determined at the first time, assigning a weighting value to each of the one or more selected partiality vectors;
comparing, at a second time, each of the one or more selected partiality vectors having the assigned weighting value to each of the plurality of vectorized characterizations using the vector dot product calculations;
determining a second content based on the comparing at the second time; and
providing the second content to the billboard interface.

15. The method of claim 14, further comprising increasing, each time the weighting value is assigned, a weighting value tracker corresponding to a billboard associated with the billboard interface, wherein the weighting value tracker indicates effectiveness of advertising on the billboard.

16. The method of claim 10, further comprising:
assigning a weighting value to each of the one or more selected partiality vectors based on a determination that particular purchase histories of the plurality of travelers is associated with a previous content provided to a billboard associated with the billboard interface, wherein the traveler data information comprises the particular purchase histories; and
increasing a weighting value tracker corresponding to the billboard, wherein the weighting value tracker indicates effectiveness of advertising on the billboard.

17. The method of claim 10, wherein each partiality vector of the set of partiality vectors has a particular magnitude that is equal to or greater than a respective first threshold.

18. The method of claim 10, further comprising:
determining the frequency distribution of each partiality vector of the set of partiality vectors based on a number of travelers that are associated with each partiality vector of the set of partiality vectors;
determining a percent distribution of each partiality vector of the set of partiality vectors based on the frequency distribution; and
determining at least one particular partiality vector of the set of partiality vectors that has a particular percent distribution of the determined percent distribution, wherein the particular percent distribution comprises a percent value that is equal to or greater than a second threshold, and wherein the determining of the rank is based on the particular percent distribution.
